(19) United States
(12) Patent Application Publication
(10) Pub. No.: US 2006/0184382 A1
(43) Pub. Date: Aug. 17, 2006

(54) Structured real estate analysis

(76) Inventor: Steve C. Kreitzberg, West Linn, OR (US)

Correspondence Address: MARGER JOHNSON & MCCOLLOM, P.C., 210 SW MORRISON STREET, SUITE 400, PORTLAND, OR, 97204, US

(21) Appl. No.: 11/349,725

(22) Filed: Feb. 7, 2006

Related U.S. Application Data
(60) Provisional application No. 60/651,088, filed on Feb. 7, 2005.

(51) Int. Cl. G06Q 99/00

(52) U.S. Cl. 705/1

(57) ABSTRACT

A method of selecting a real estate option according to a structured analysis. The structured analysis may be used to determine a preferred real estate option for a user based on criteria such as the preferences and financial resources of the user. The structured analysis may be used to facilitate an ongoing advisor relationship between a homeowner and his real estate advisor.

### CROSS-REFERENCE TO RELATED APPLICATIONS

This application claims the benefit from U.S. Provisional Patent Application No. 60/651,088 filed Feb. 7, 2005, whose contents are incorporated herein for all purposes.

### BACKGROUND

Currently, homeowners live in a current home until some unplanned outside force or opportunity causes them to consider changing homes. Examples of these unplanned outside forces and opportunities include unemployment, family reasons, a new employment opportunity, going back to school, etc. Once the homeowner considers changing homes, he contacts a real estate agent.

The real estate agent may gather limited information about the homeowner's needs. The gathered information is frequently not recorded and ultimately may or may not factor into which houses are shown to the homeowner. Generally, at least from the point of view of the homeowner, decisions are made and houses are selected according to haphazard, non-standardized approach.

The relationship between the homeowner and the agent ends when the house is purchased. The business relationship may end explicitly when all contractual duties between the homeowner and the real estate agent are completed. Alternatively, the business relationship may end implicitly when communication stops. Generally, the real estate agent moves on to help other buyers and sellers with their transactions. The homeowner lives in the new home until another unplanned event causes him to consider changing homes. At that time, the homeowner may establish a new transactional relationship with the same or another real estate agent.

The traditional business relationship has many disadvantages. First, the relationship exists only in segments of time and thus the homeowner may not be informed of new homeownership opportunities occurring between the segments. Second, the traditional relationship uses haphazard decision-making that leads to poor housing fits. Third, while a home purchase is often one of the most important purchases in a purchaser's life, the real estate agent spends less time strategizing over the investment than does the purchaser's stockbroker over a stock portfolio. The disclosure that follows solves these and other prior art problems.

### SUMMARY

A method of selecting a real estate option according to a structured analysis. The structured analysis may be used to determine a preferred real estate option for a user based on criteria such as the preferences and financial resources of the user. The structured analysis may be used to facilitate an ongoing advisor relationship between a homeowner and his real estate advisor.

In one embodiment, a real estate analyzer compares received data inputs to a series of predefined real estate options. The real estate analyzer outputs a recommended real estate option based on the comparison. The real estate analyzer also configures automatic real estate notifications according to inputted auto-notification configuration parameters.

The foregoing and other objects, features and advantages of the invention will become more readily apparent from the following detailed description of a preferred example of the invention which proceeds with reference to the accompanying drawings.

### BRIEF DESCRIPTION OF THE DRAWINGS

FIG. 1 is a diagram showing a real estate analysis system having a real estate analyzer.

FIG. 2 is a detailed diagram of the real estate analyzer shown in FIG. 1.

FIG. 3 is a flowchart showing how the real estate analyzer shown in FIG. 1 determines current and future housing needs.

FIG. 4 is a flowchart showing how the real estate analyzer shown in FIG. 1 generates a description of a preferred dwelling.

FIG. 5 is a flowchart showing how the real estate analyzer shown in FIG. 1 values a current dwelling.

FIG. 6 is a flowchart showing how the real estate analyzer shown in FIG. 1 forecasts current dwelling valuation growth.

FIG. 7 is a flowchart showing how the real estate analyzer shown in FIG. 1 calculates total cash reserves available.

FIG. 8 is a flowchart showing how the real estate analyzer shown in FIG. 1 calculates a current mortgage capacity.

FIG. 9 is a flowchart showing how the real estate analyzer shown in FIG. 1 calculates a future mortgage capacity.

FIG. 10 is a flowchart showing how the real estate analyzer shown in FIG. 1 identifies neighborhood trends.

FIG. 11 is a flowchart showing how the real estate analyzer shown in FIG. 1 scores homeownership preferences.

FIG. 12 is a flowchart showing how the real estate analyzer shown in FIG. 1 parses realty options.

FIG. 13A is a flowchart showing how the real estate analyzer shown in FIG. 1 selects a realty option.

FIG. 13B is a diagram illustrating realty option selection according to the process of FIG. 13A.

FIG. 14 is a flowchart showing how the real estate analyzer shown in FIG. 1 determines current dwelling profits enhancements.

FIG. 15 is a flowchart showing how the real estate analyzer shown in FIG. 1 filters available dwellings.

FIG. 16 is a flowchart showing how the real estate analyzer shown in FIG. 1 determines new dwelling profit enhancements.

FIG. 17 is a flowchart showing how the real estate analyzer shown in FIG. 1 determines new dwelling lifestyle enhancements.

FIG. 18 is a flowchart showing how the real estate analyzer shown in FIG. 1 memorializes post-analysis communications.

FIG. 19 is a flowchart showing how the real estate analyzer shown in FIG. 1 customizes future real estates analyses.

FIG. 20 is a flowchart showing how the real estate analyzer shown in FIG. 1 continuously considers available housing.

FIG. 21 is a flowchart showing how the real estate analyzer shown in FIG. 1 continuously searches for the preferred dwelling description generated according to FIG. 4.

FIGS. 22A1-22A81 illustrate display images that may used by the real estate analyzer shown in FIG. 1.

### DETAILED DESCRIPTION

Several preferred examples of the present application will now be described with reference to the accompanying drawings. Various other examples of the invention are also possible and practical. This application may be exemplified in many different forms and should not be construed as being limited to the examples set forth herein.

The figures listed above illustrate preferred examples of the application and the operation of such examples. In the figures, the size of the boxes is not intended to represent the size of the various physical components. Where the same element appears in multiple figures, the same reference numeral is used to denote the element in all of the figures where it appears.

Only those parts of the various units are shown and described which are necessary to convey an understanding of the examples to those skilled in the art. Those parts and elements not shown are conventional and known in the art.

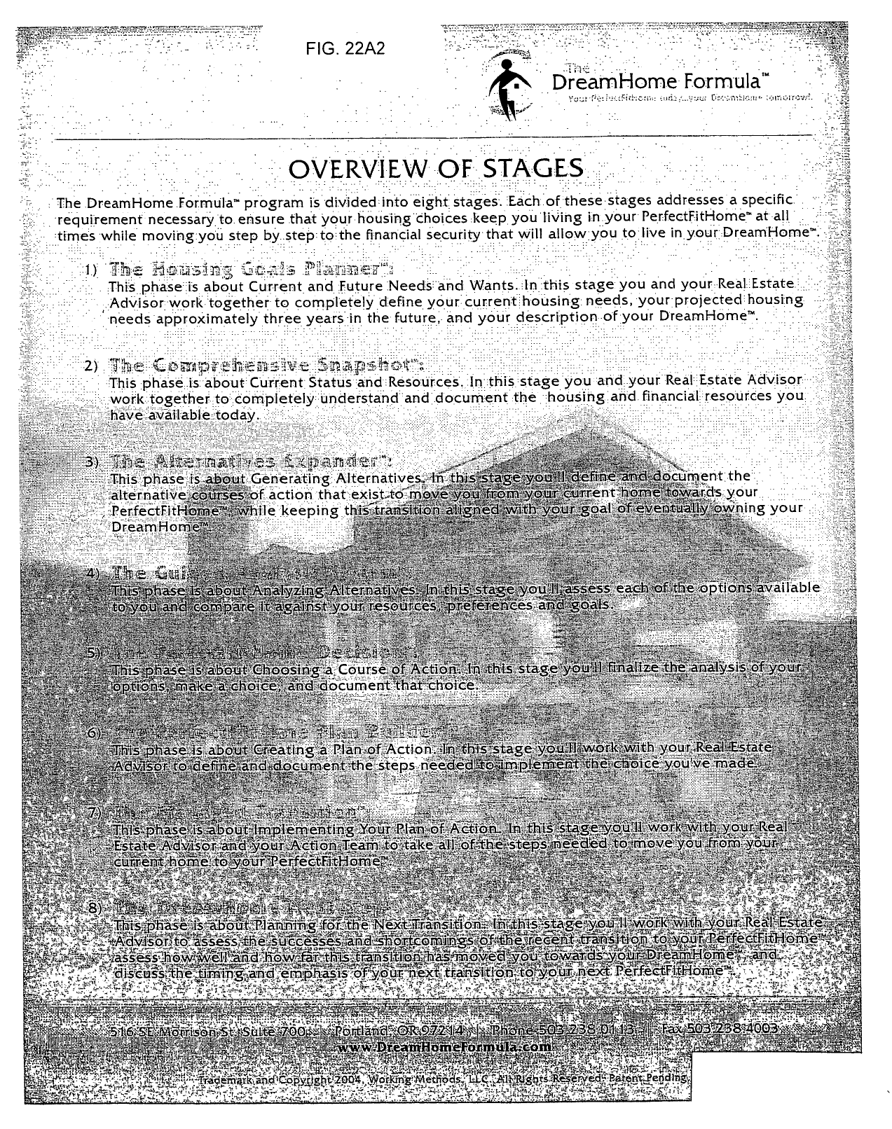

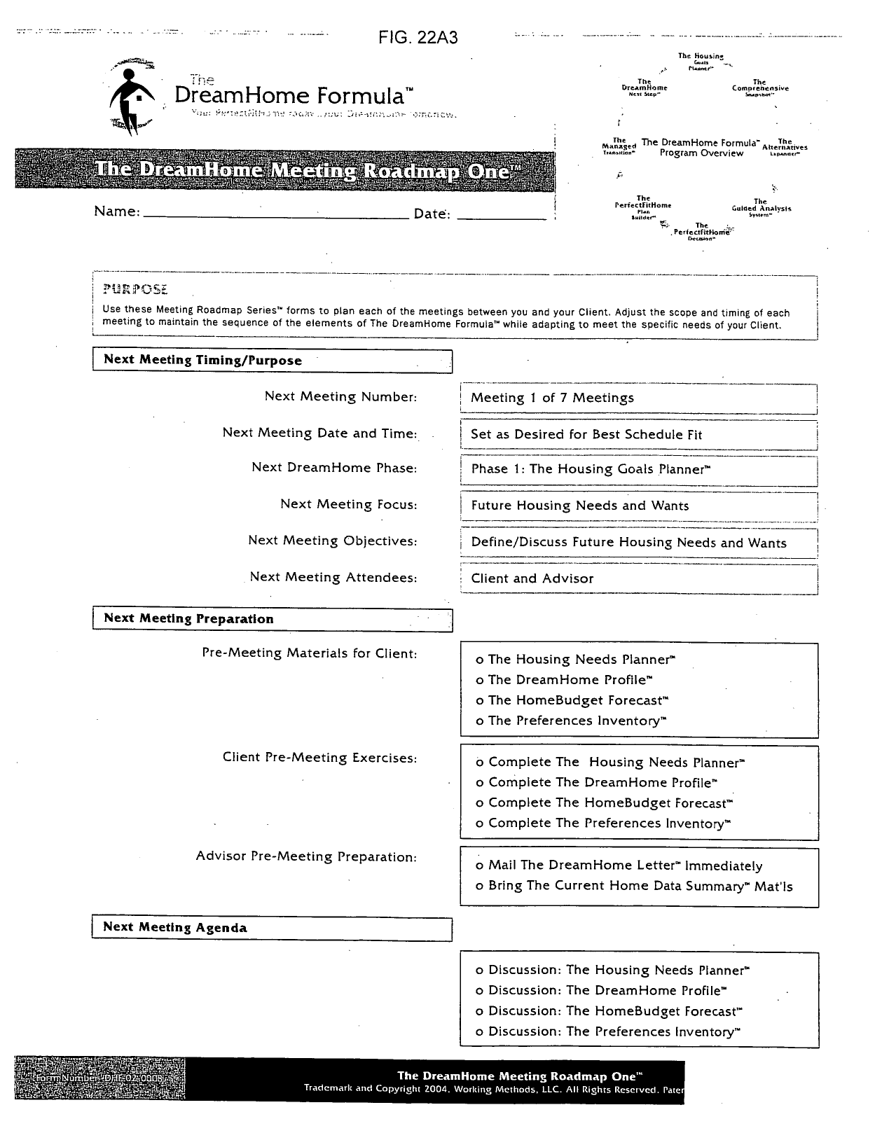

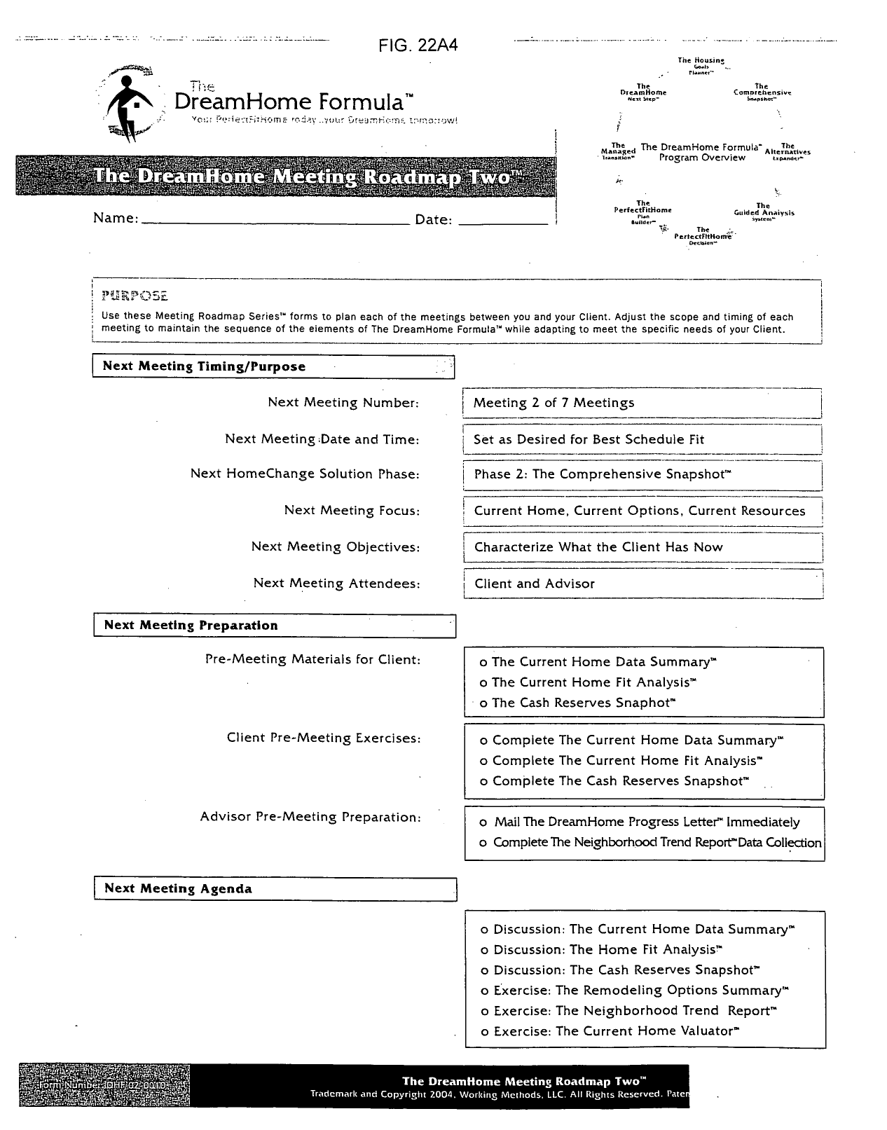

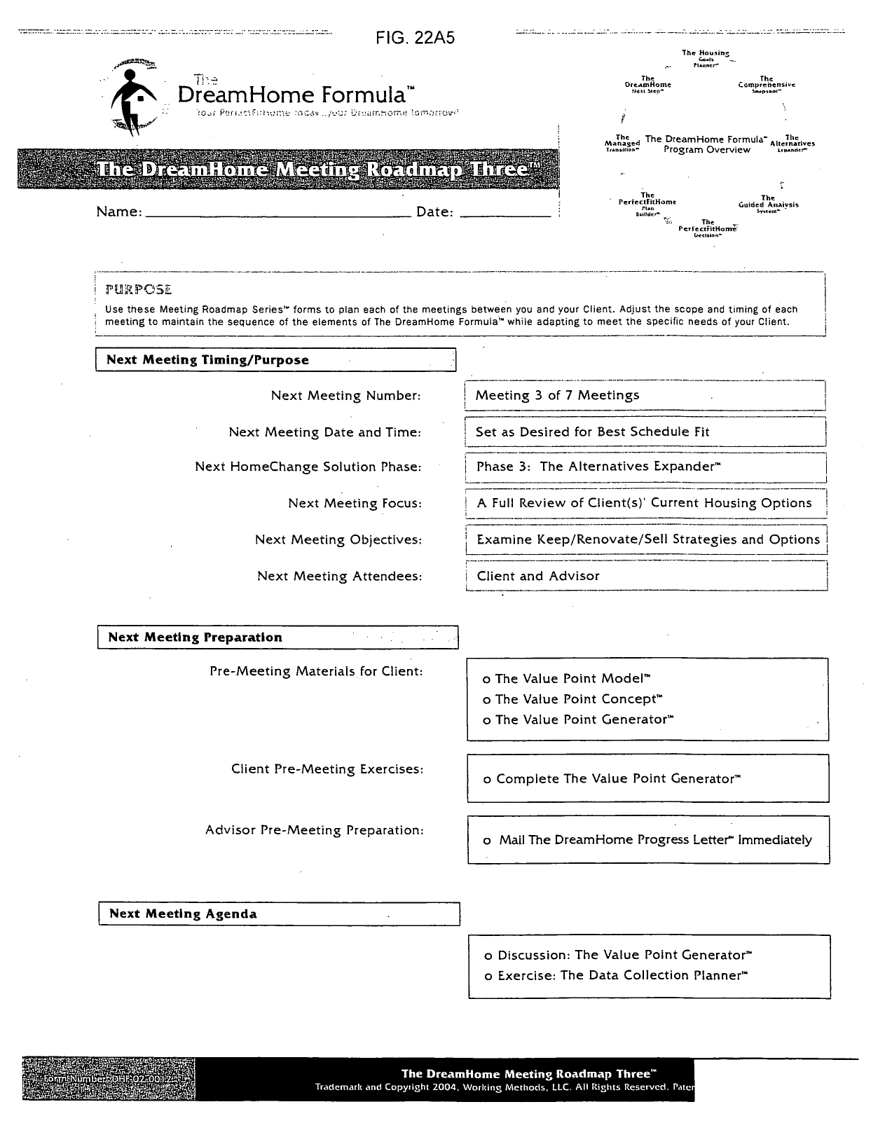

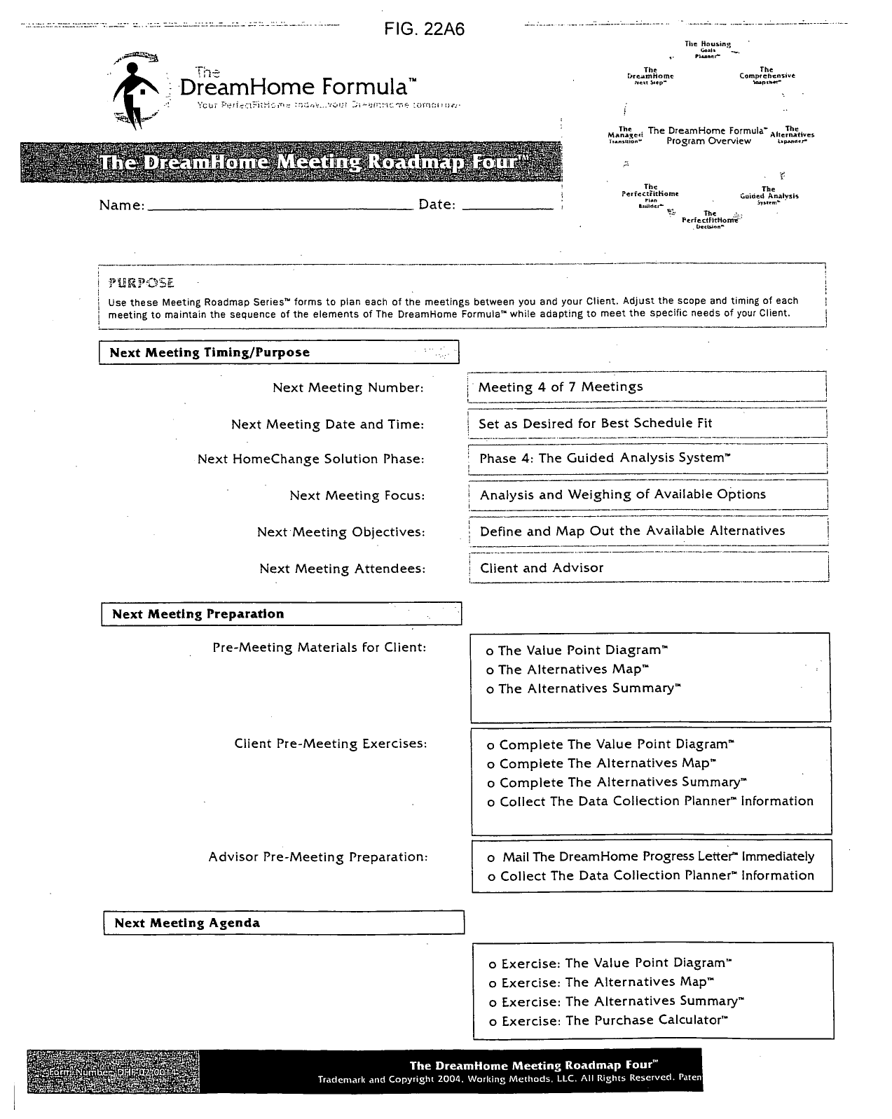

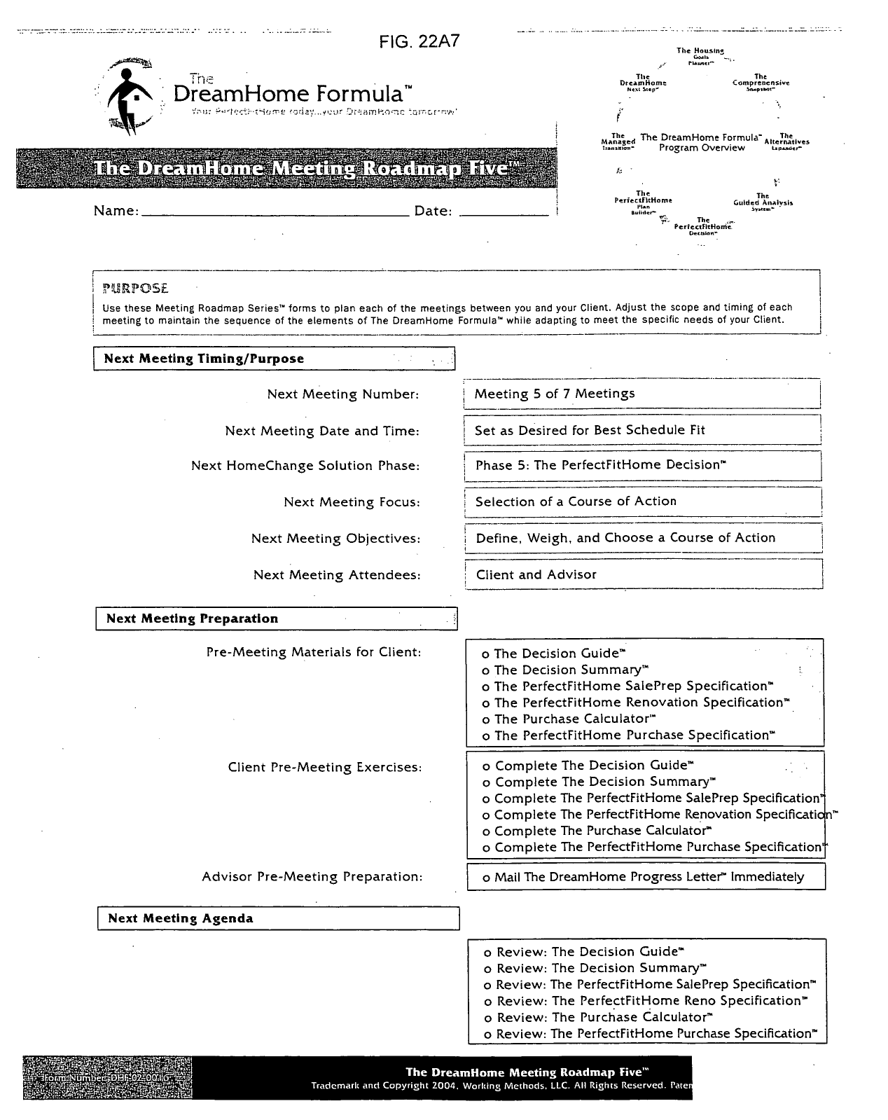

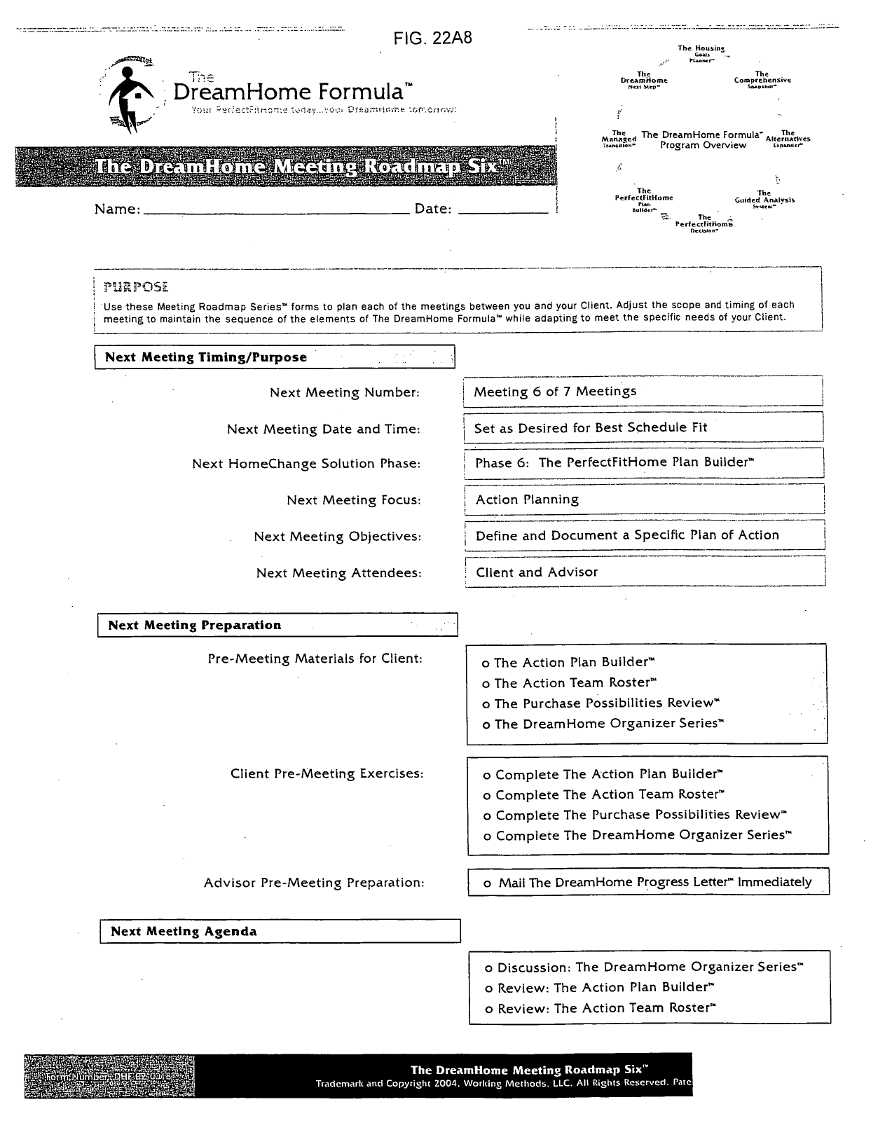

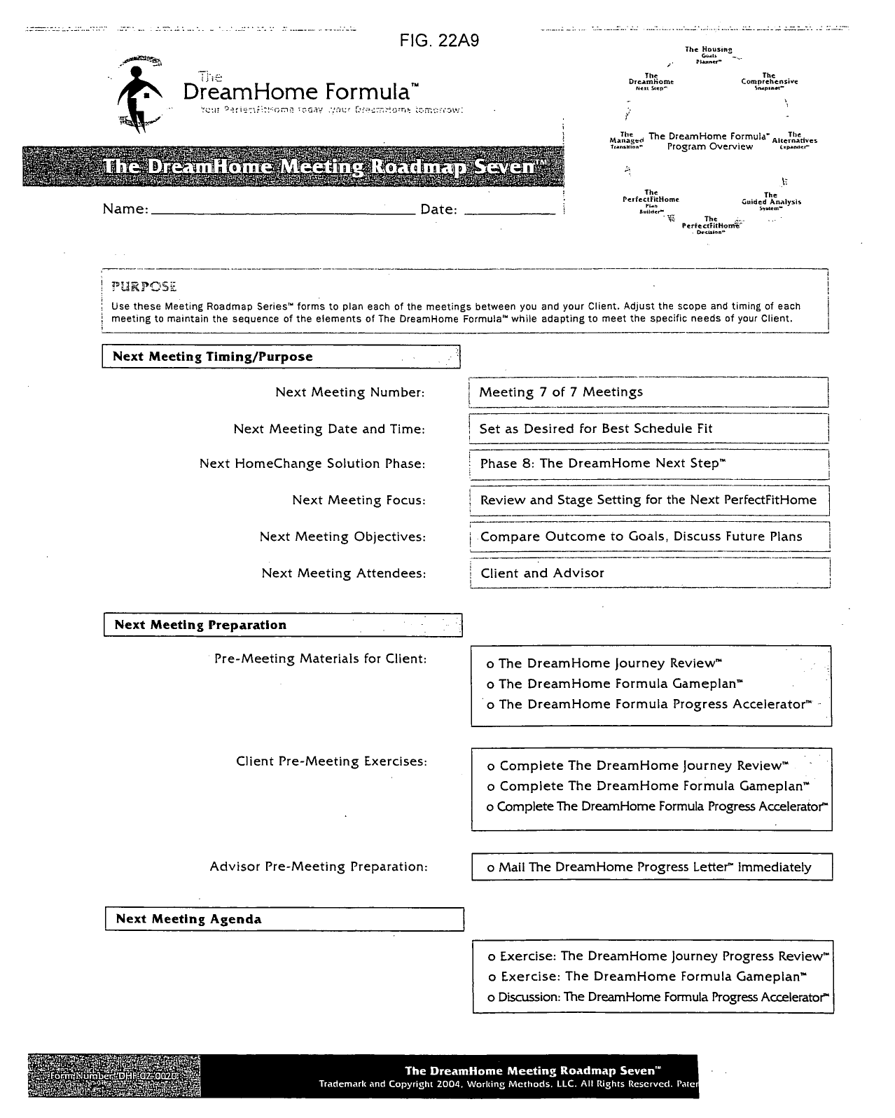

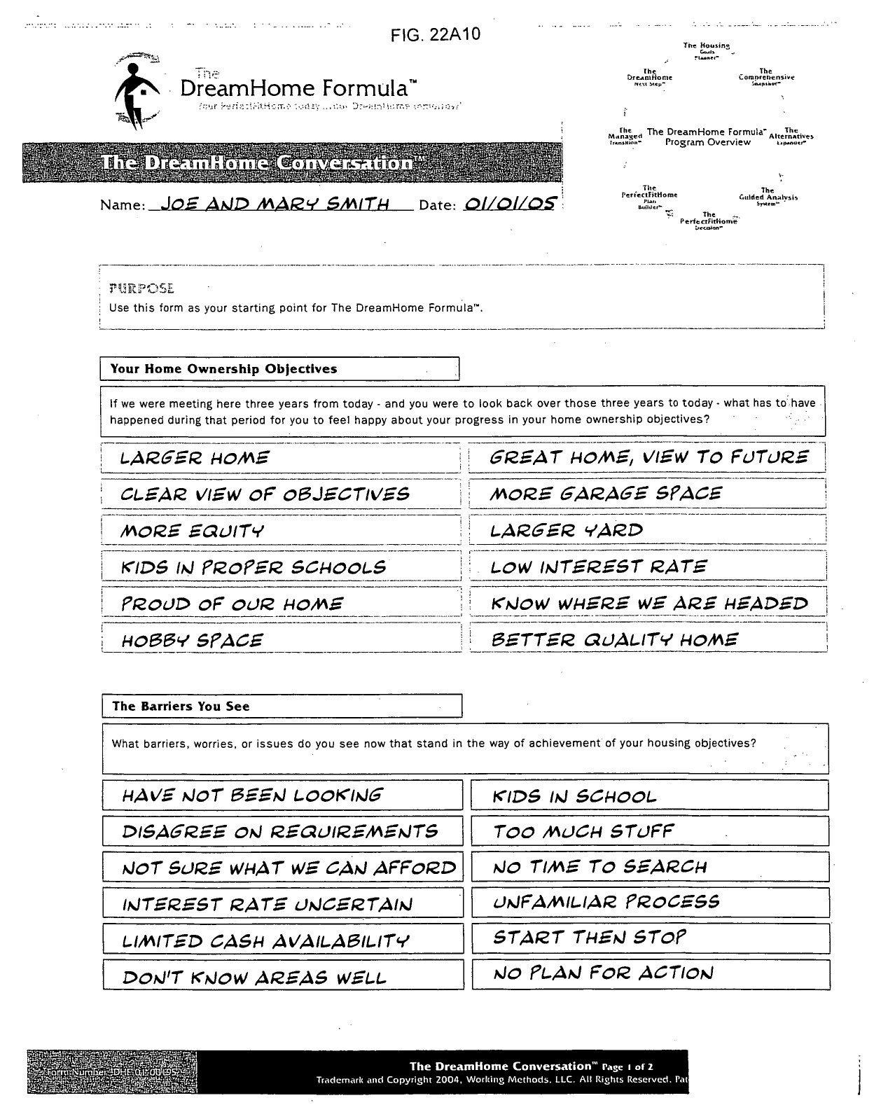

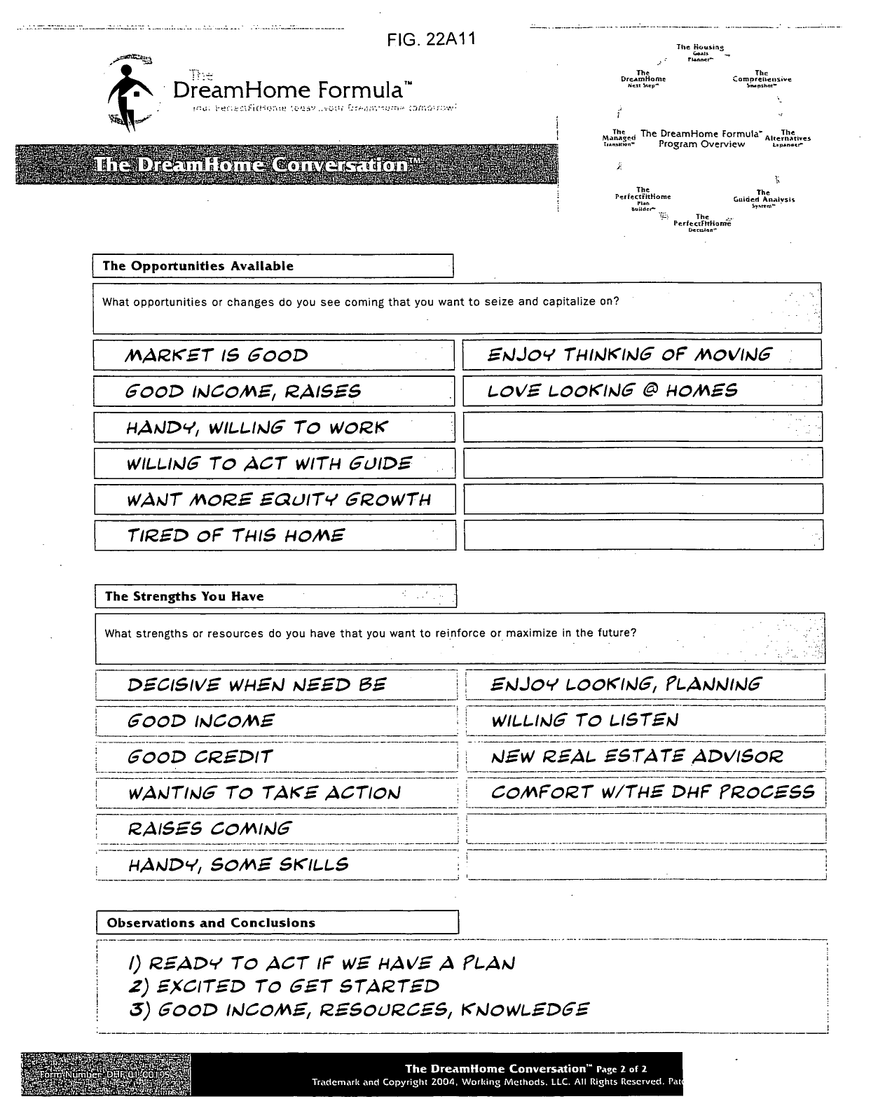

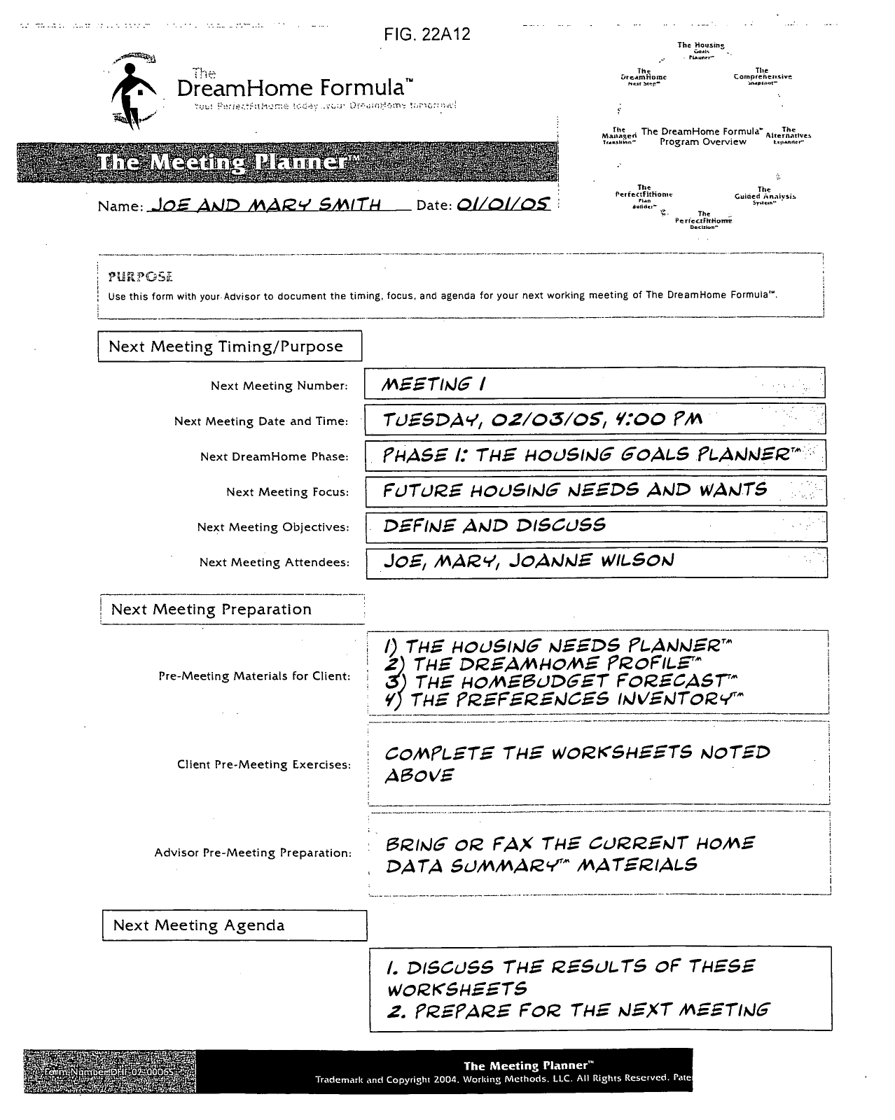

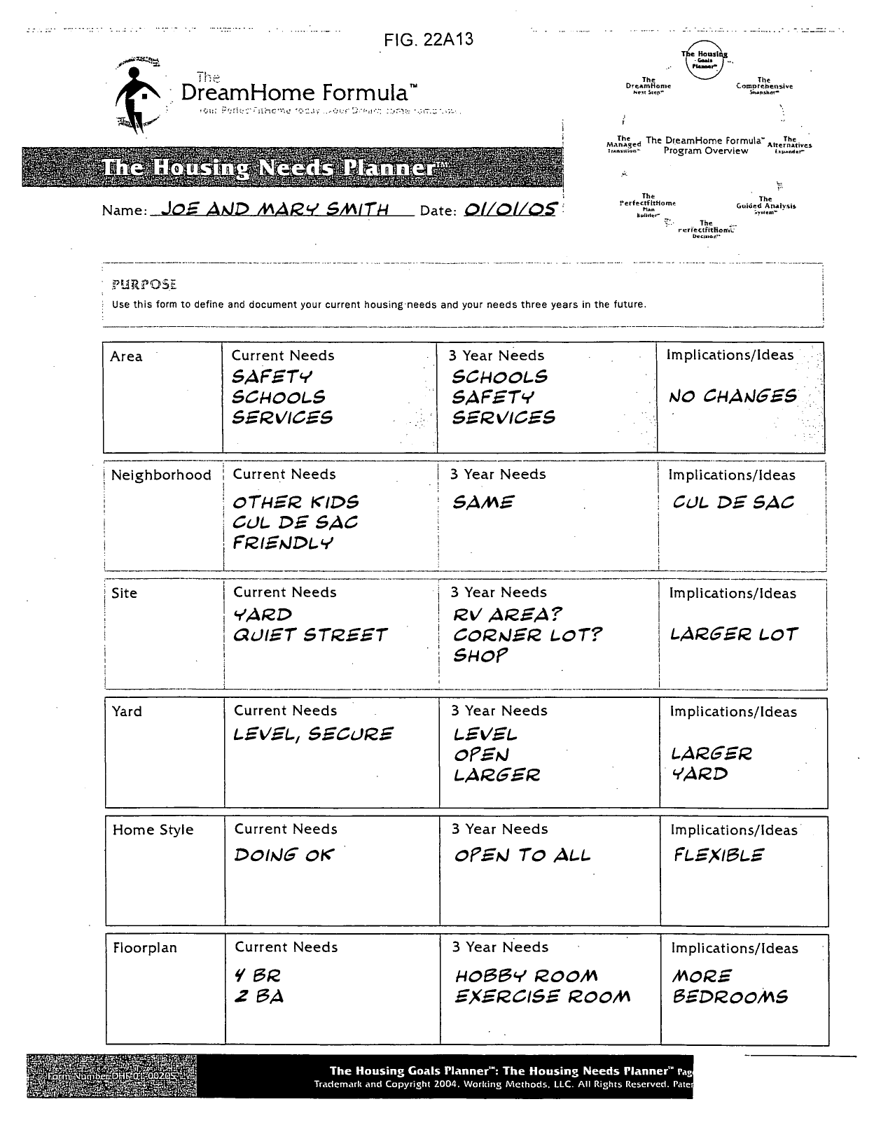

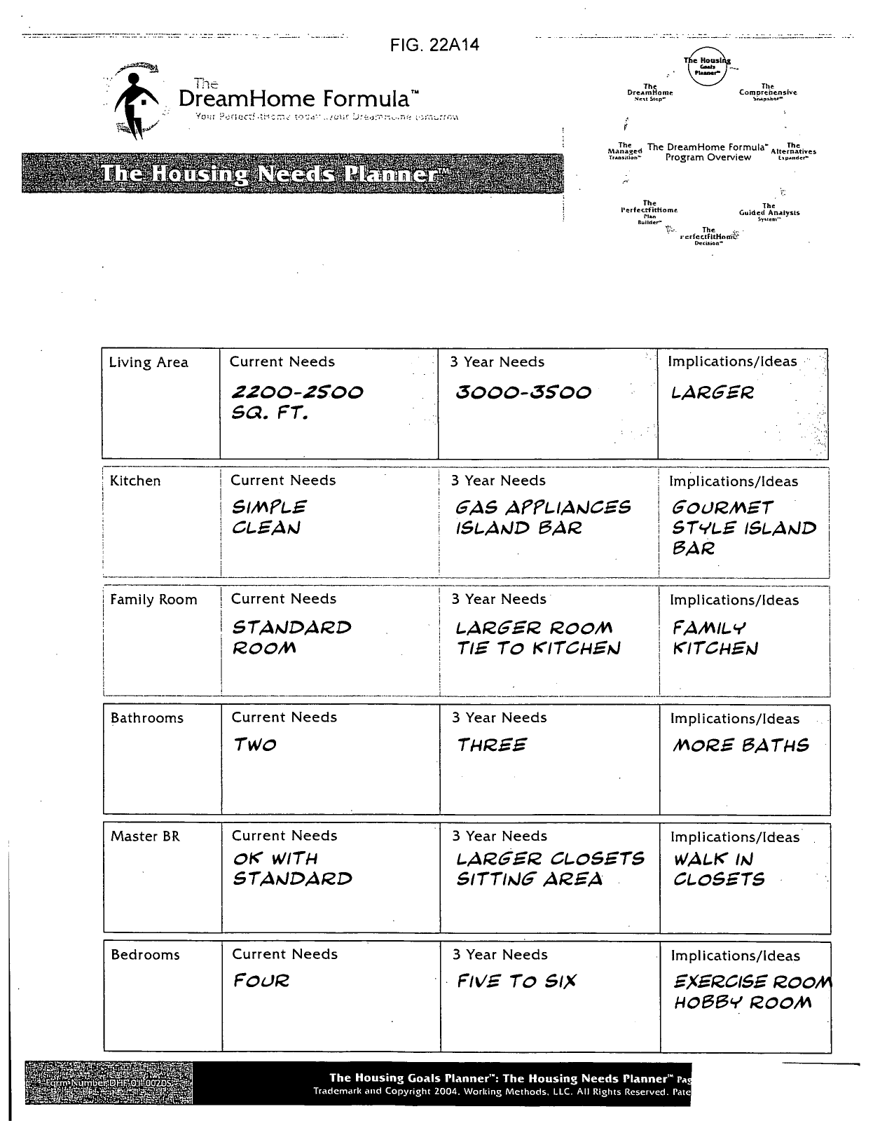

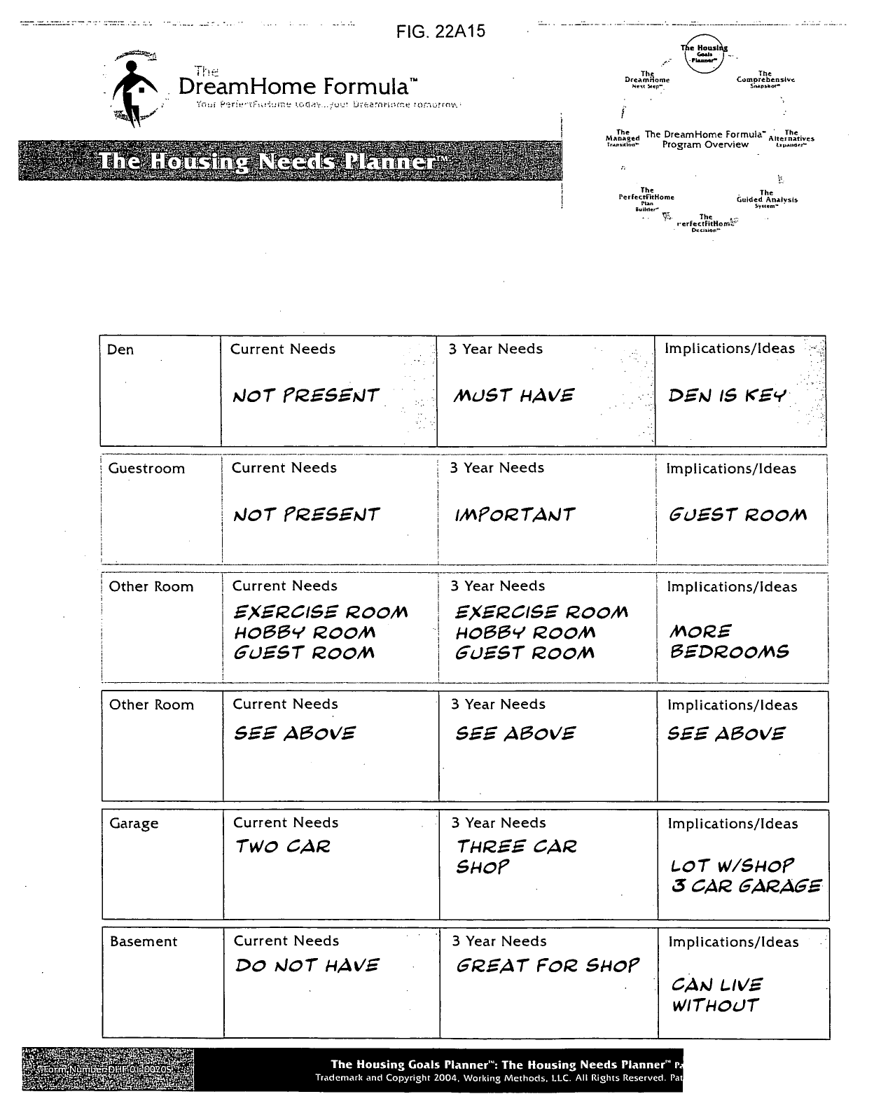

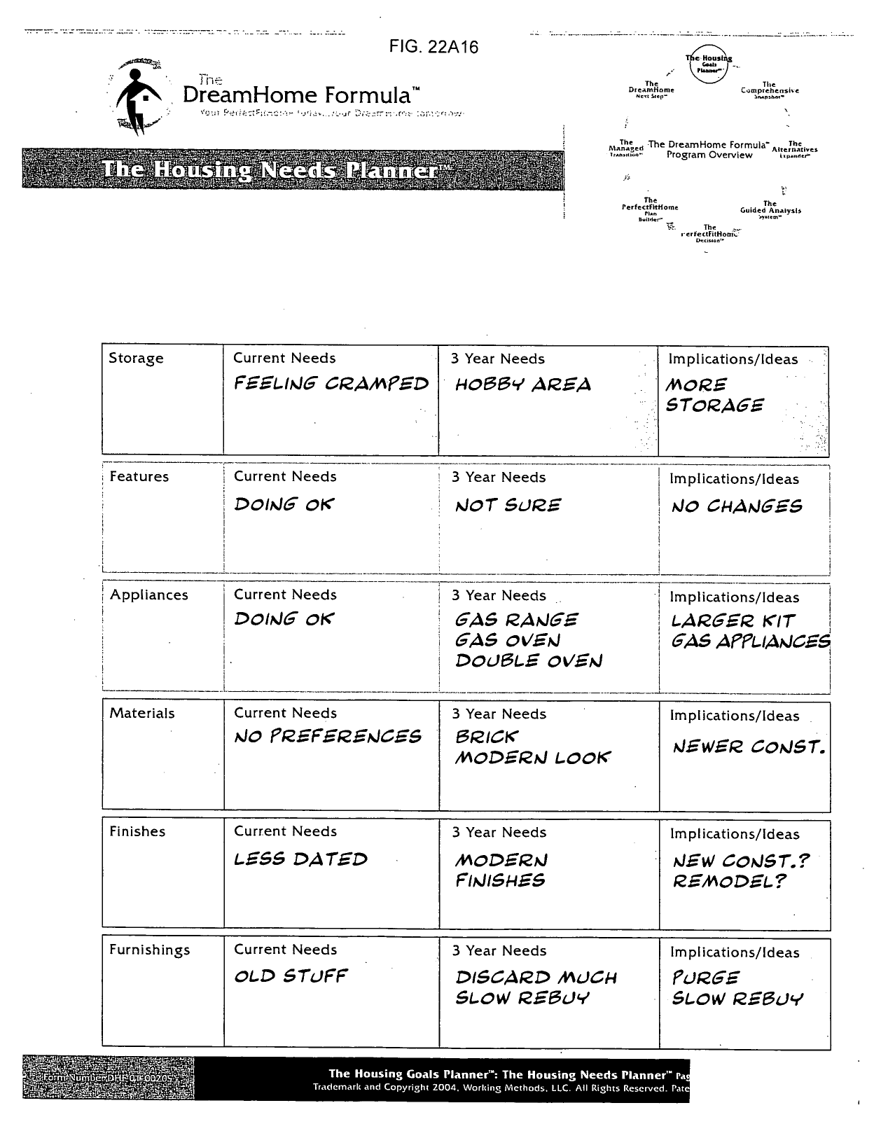

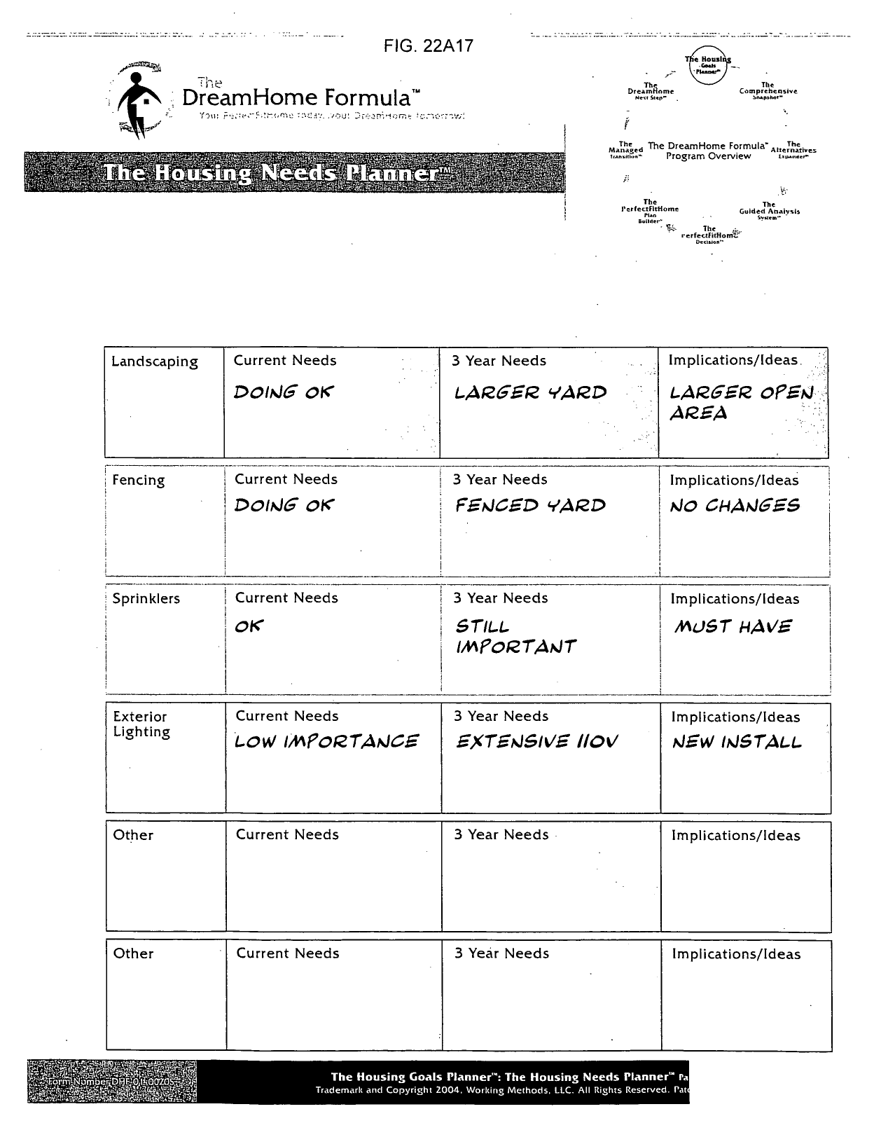

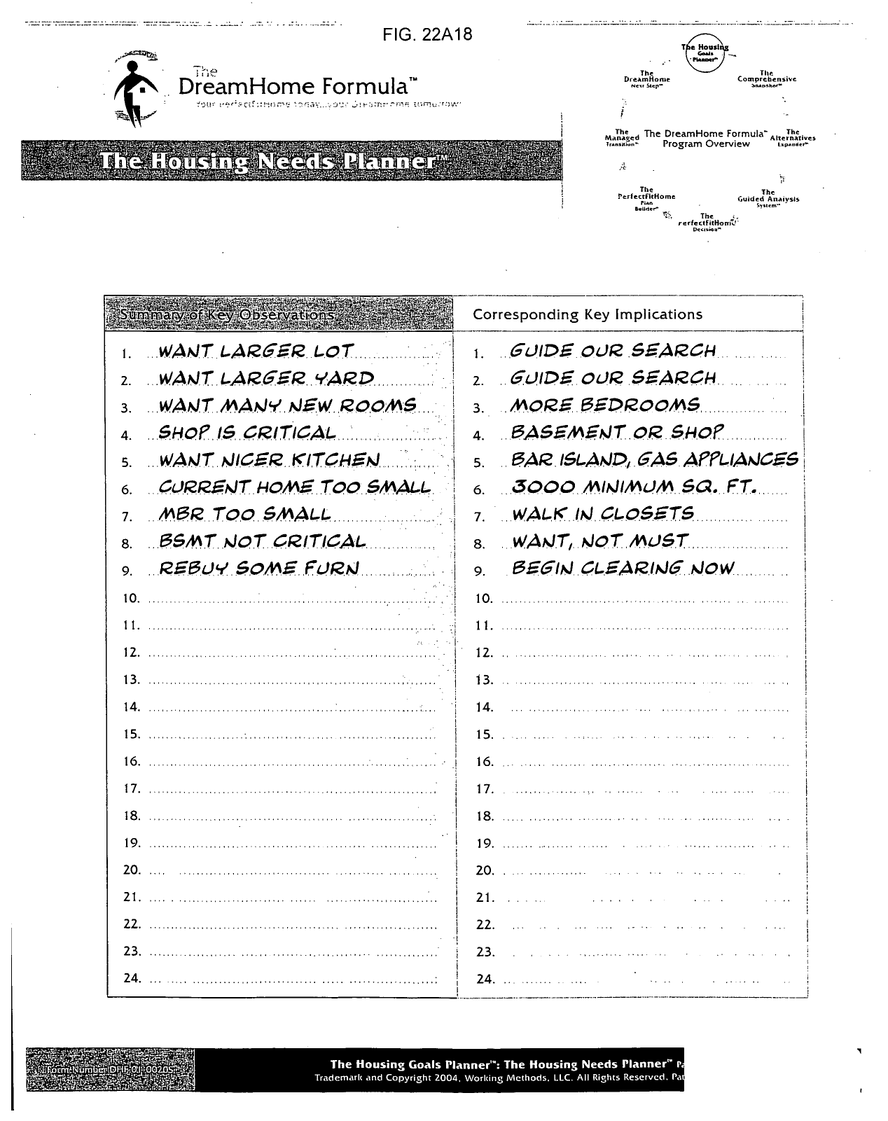

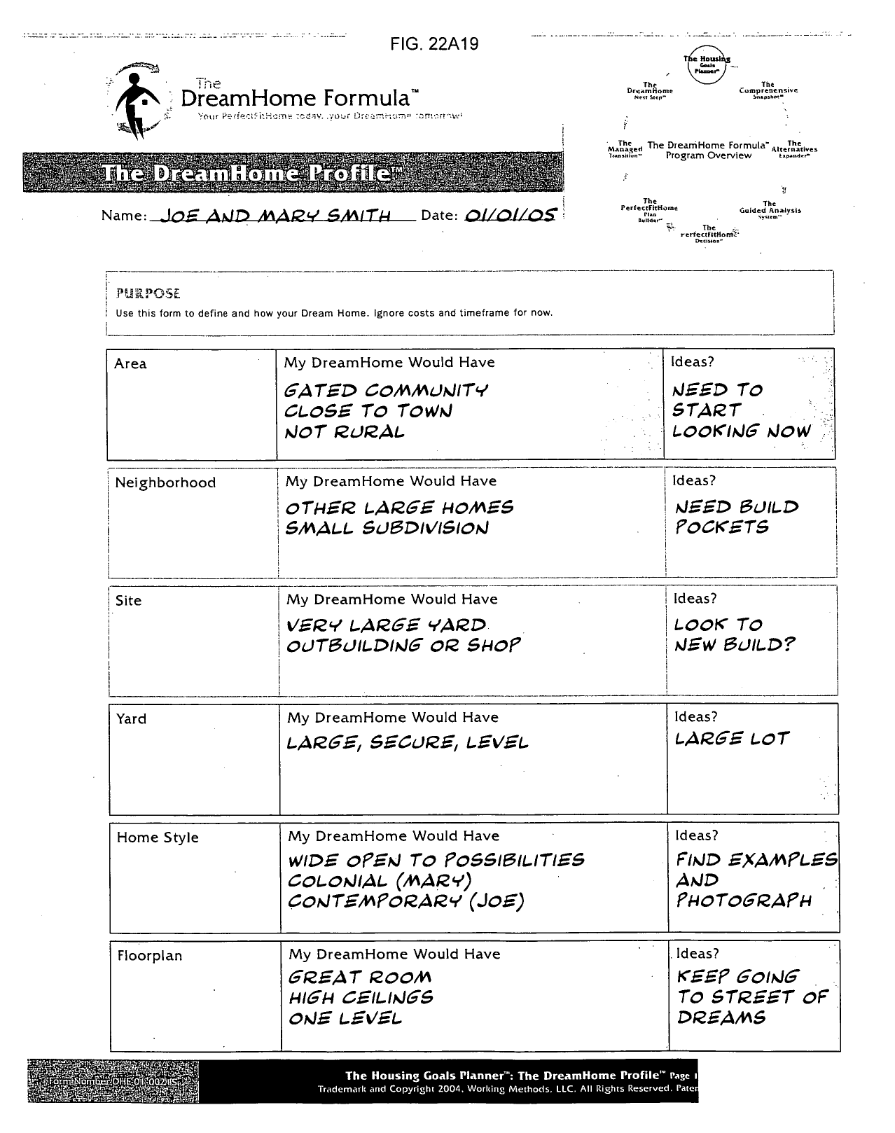

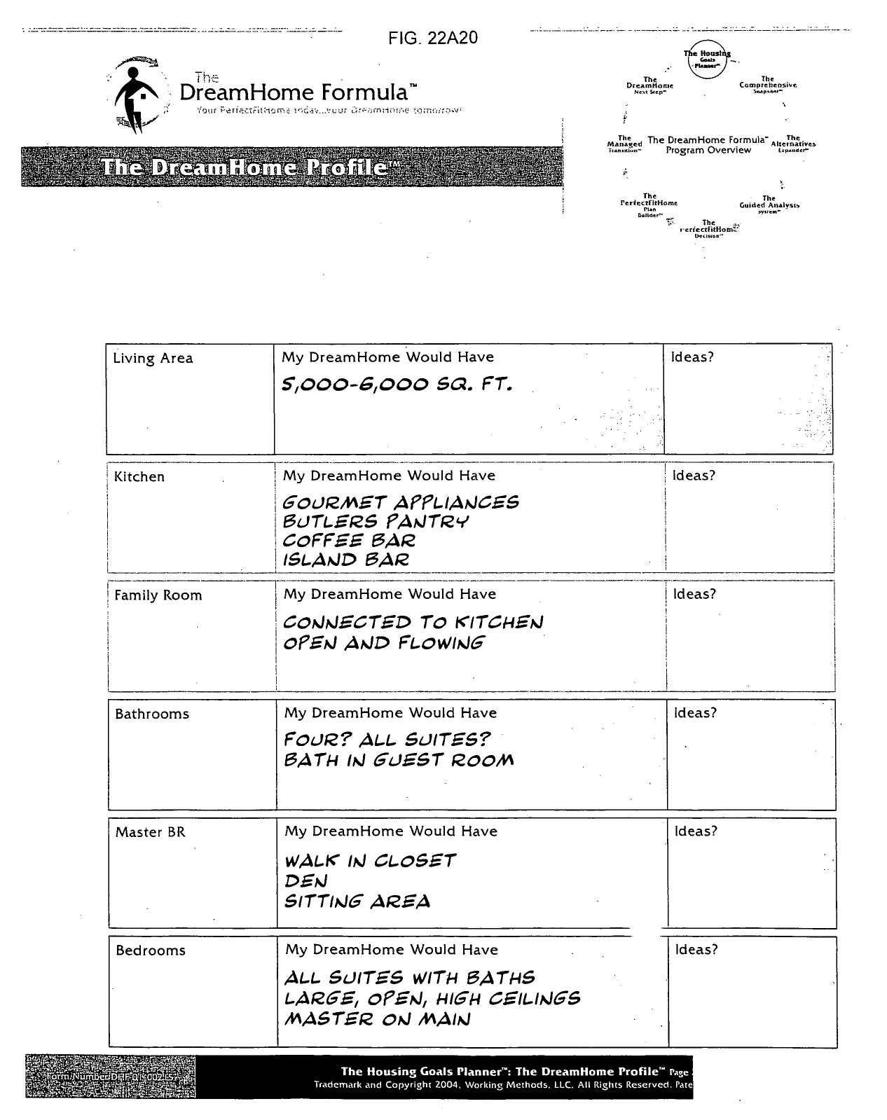

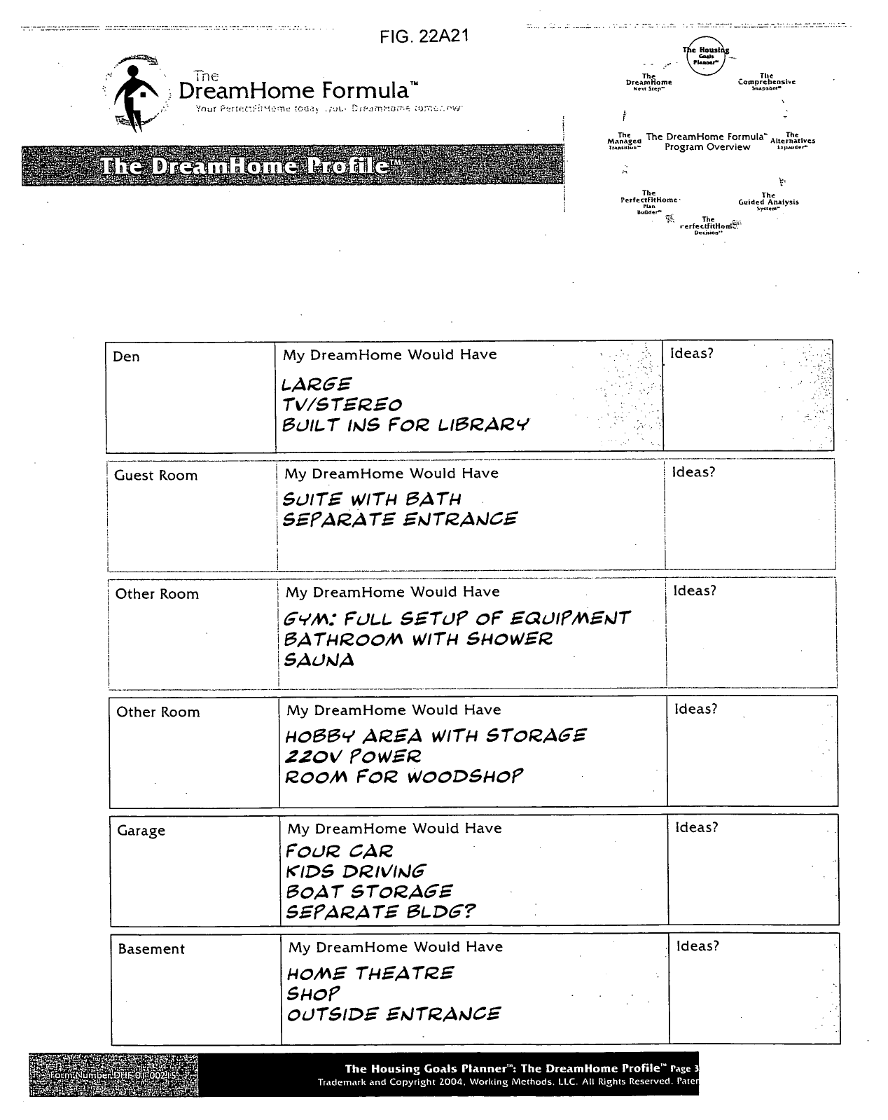

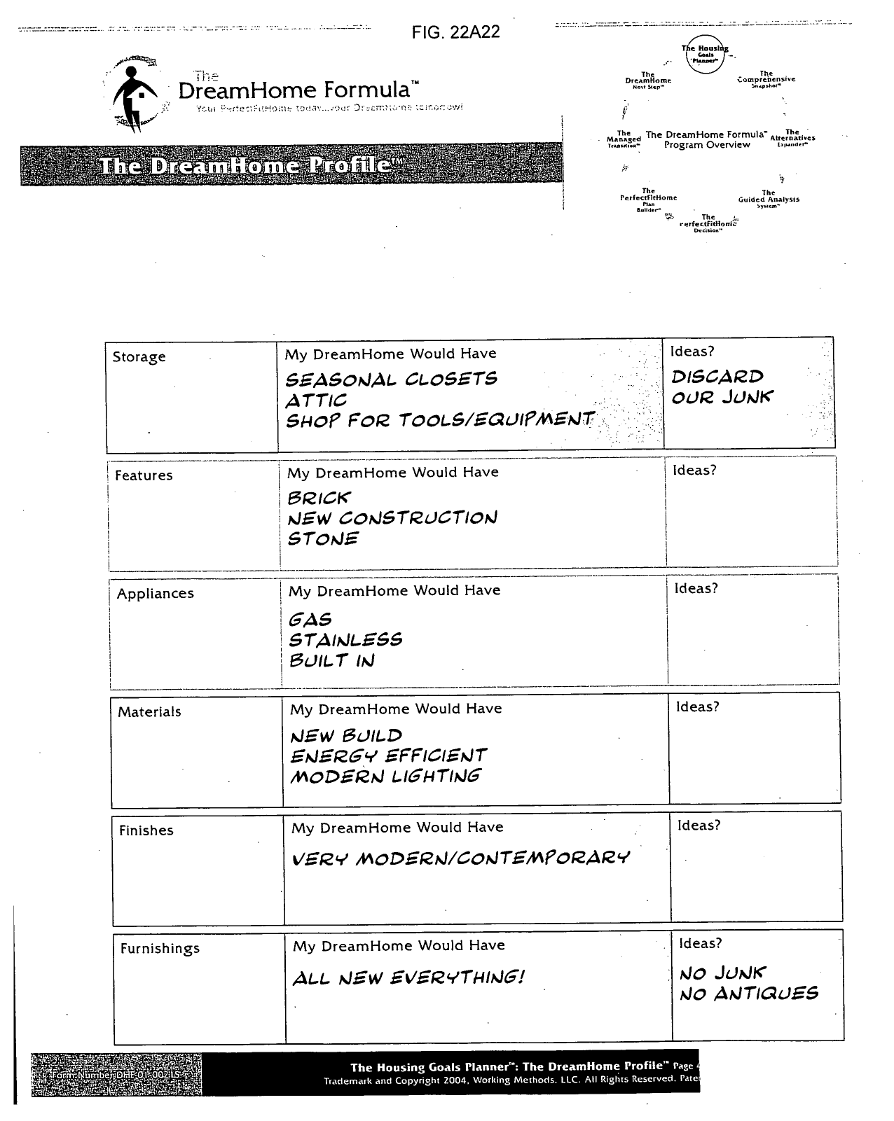

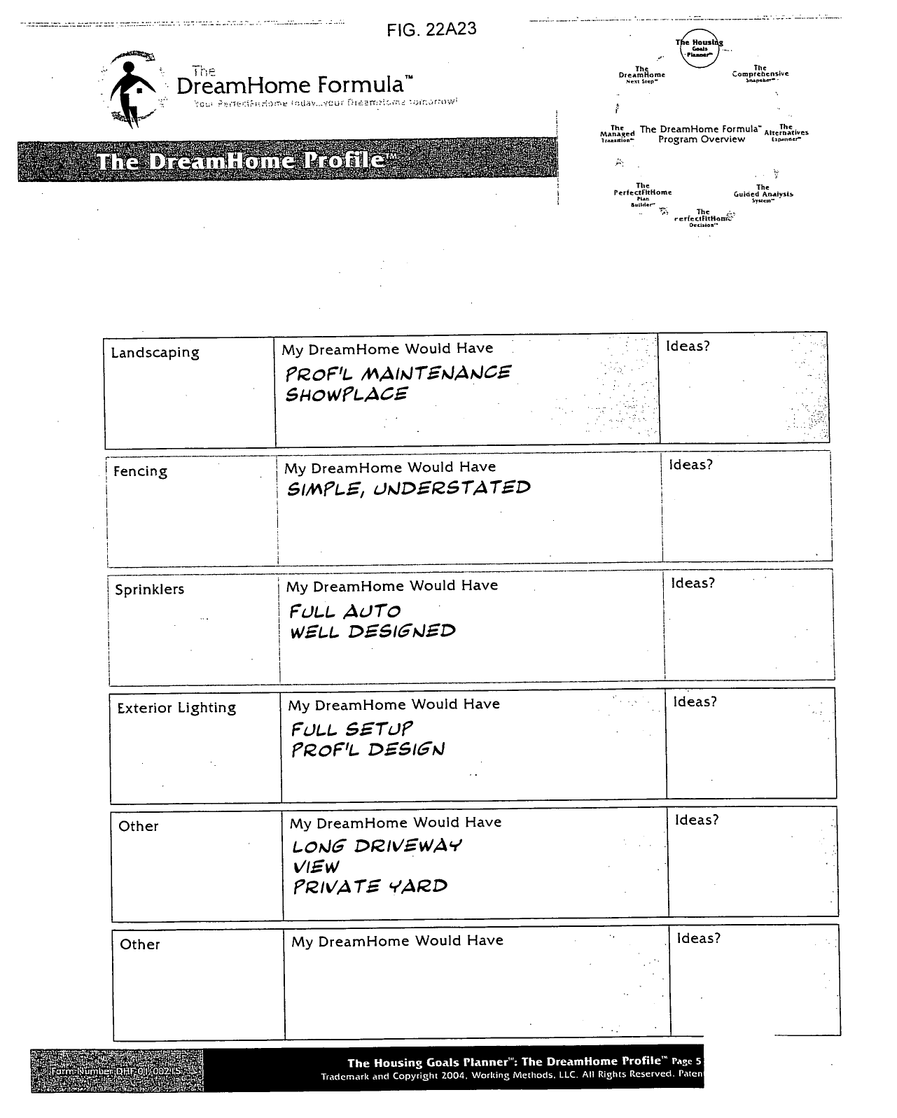

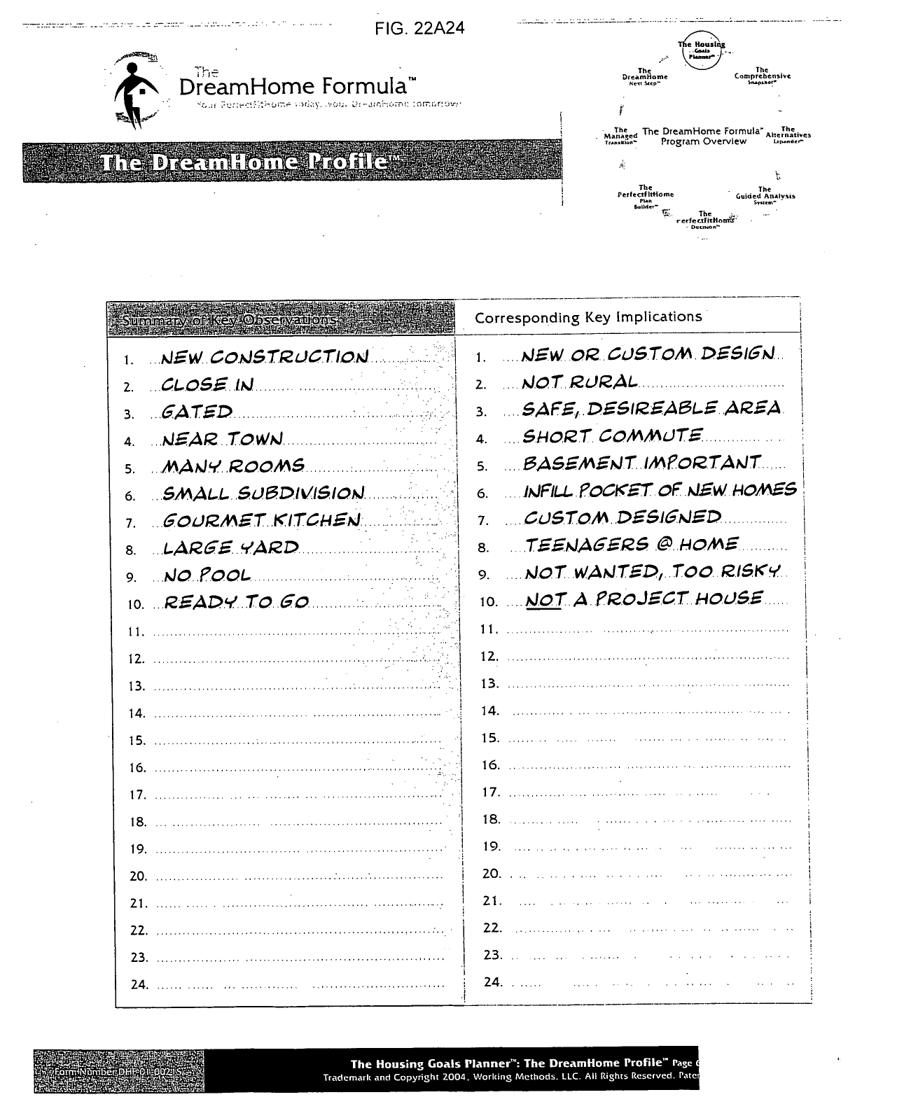

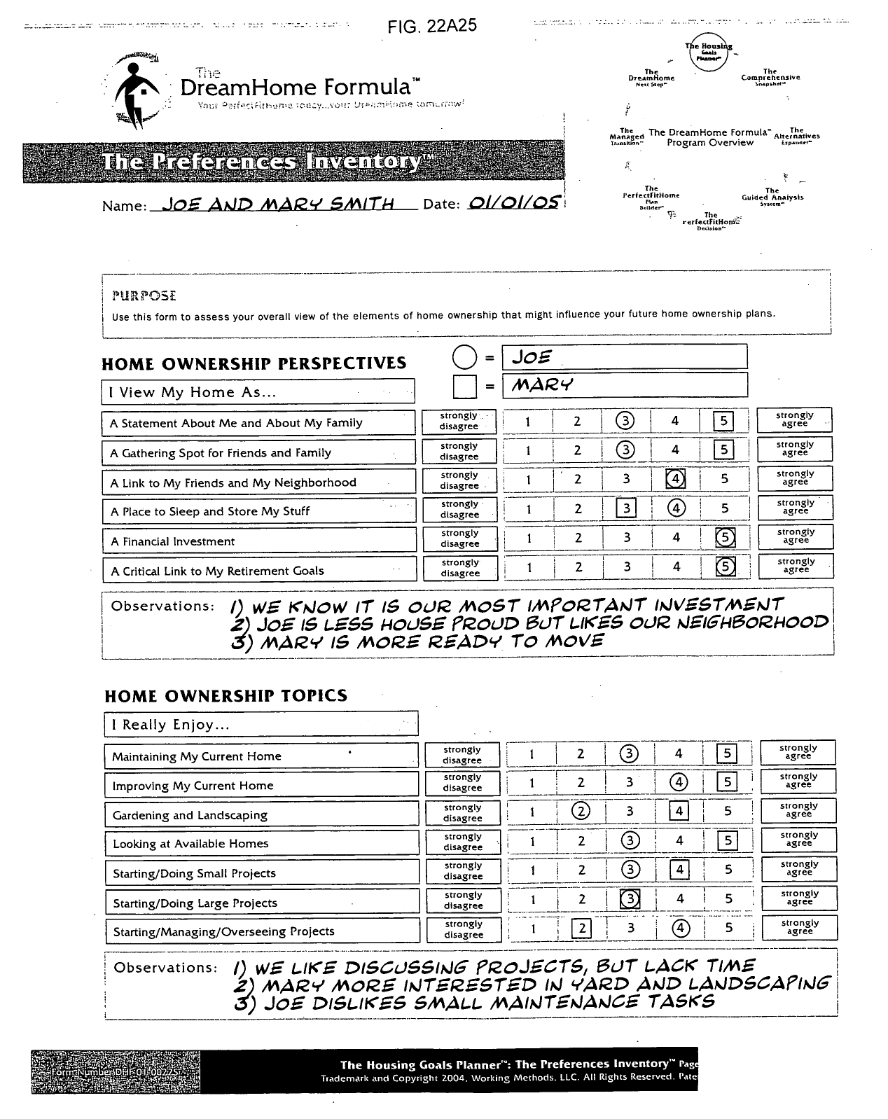

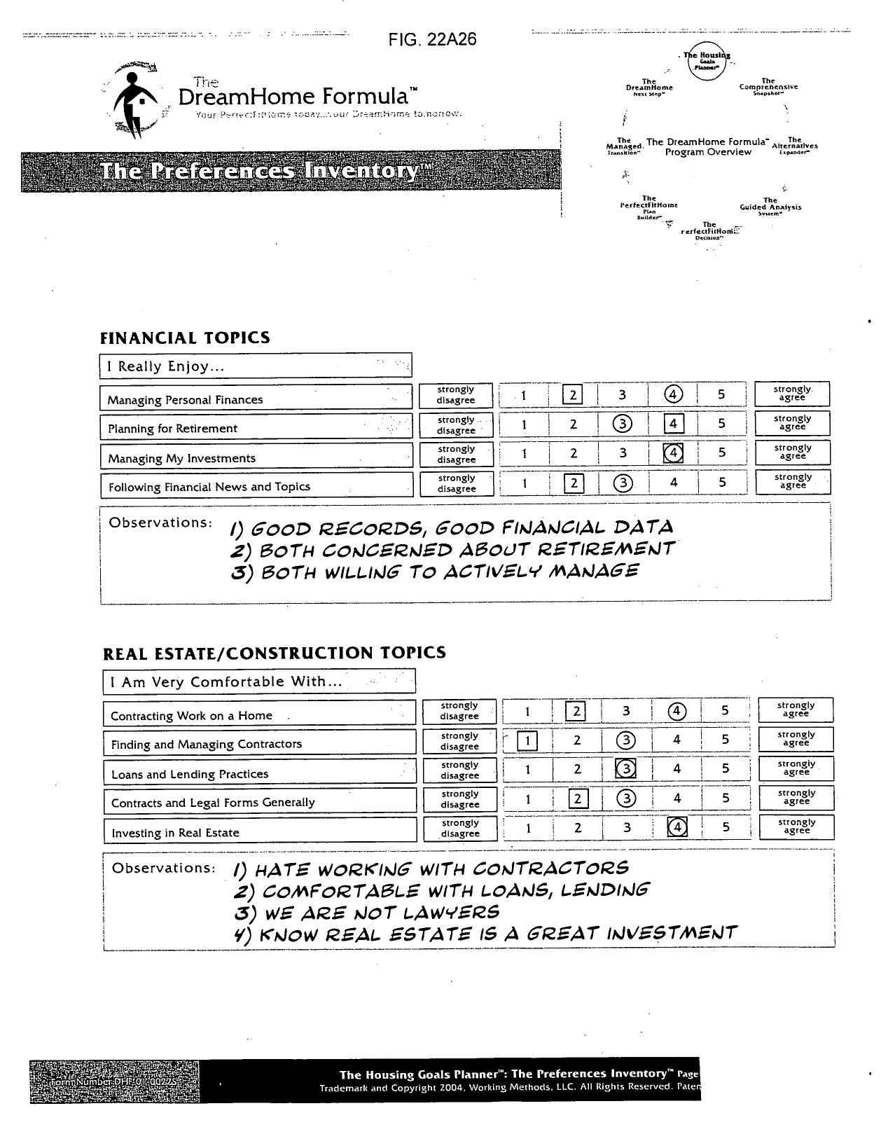

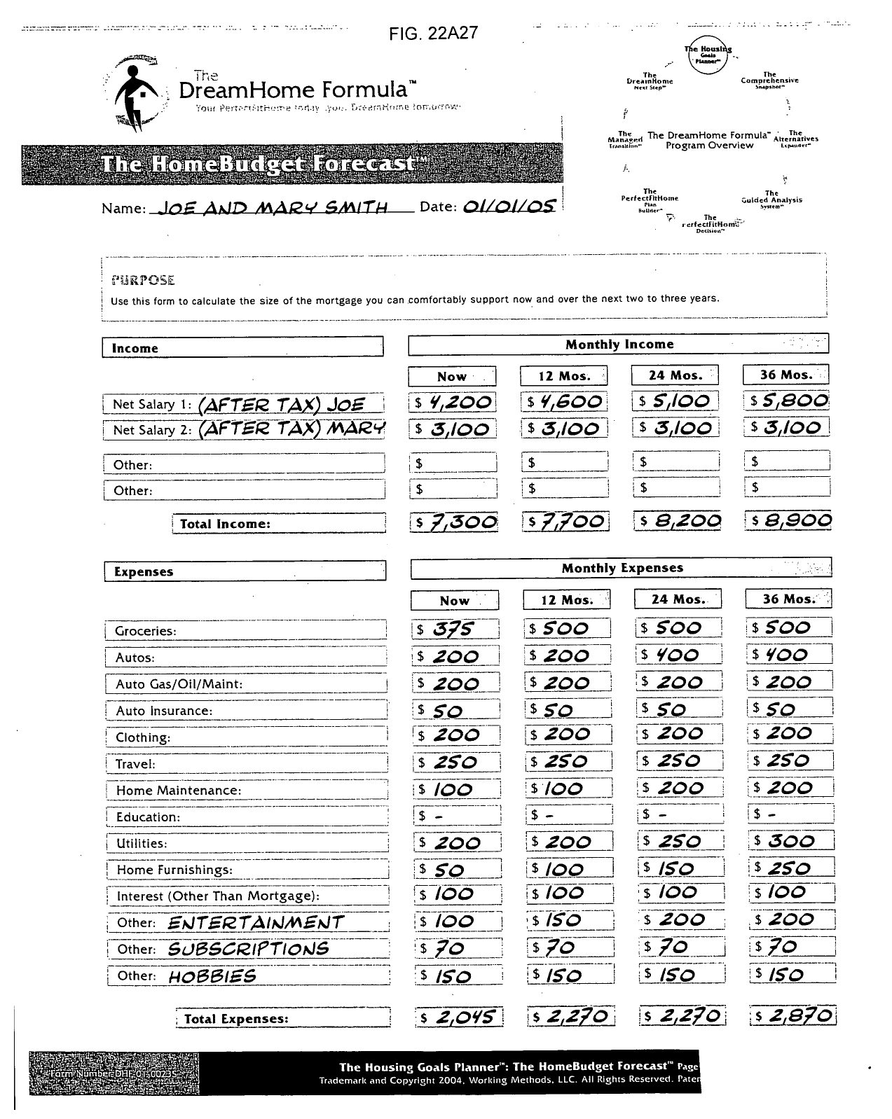

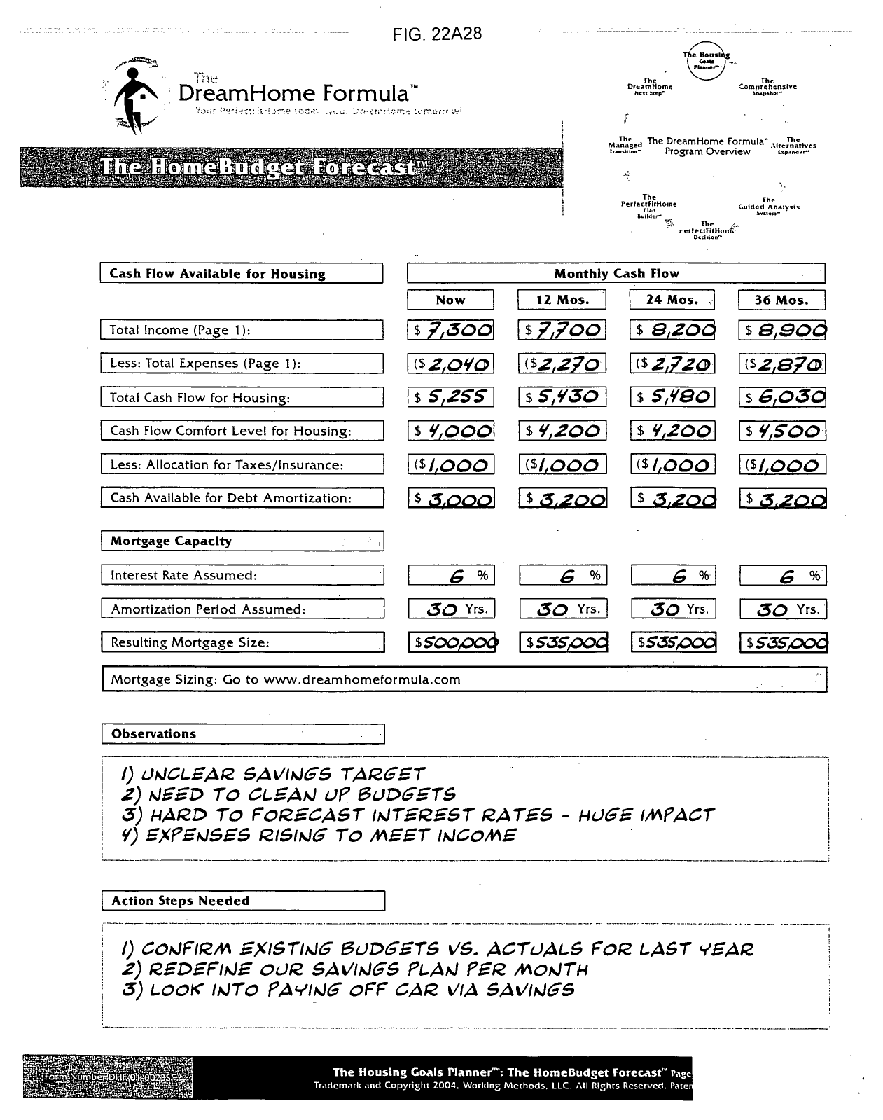

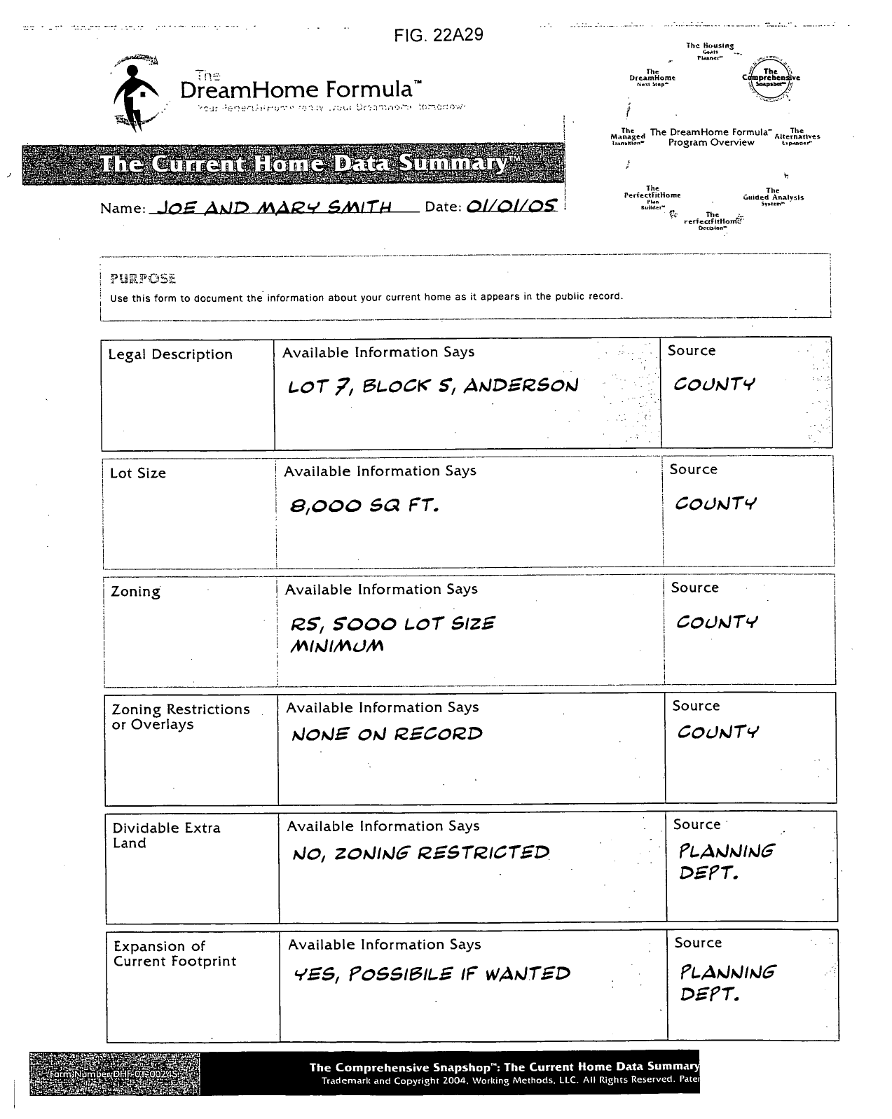

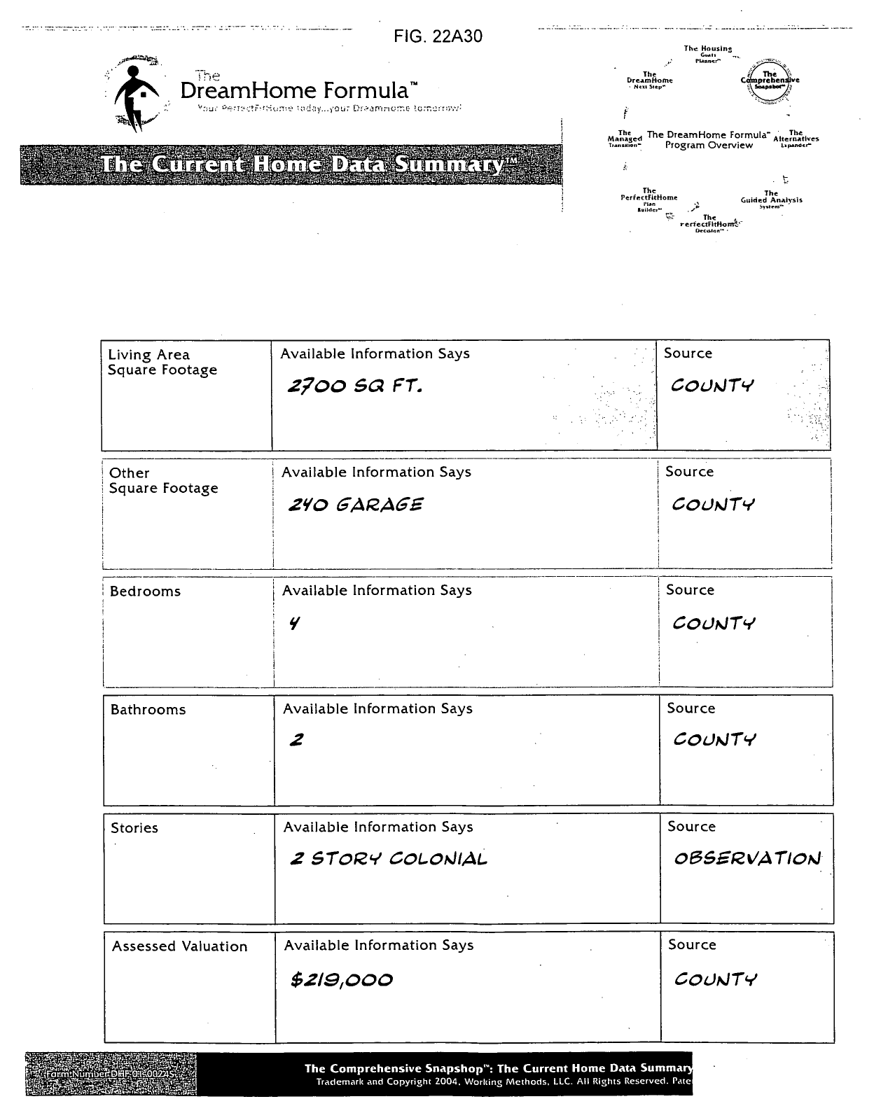

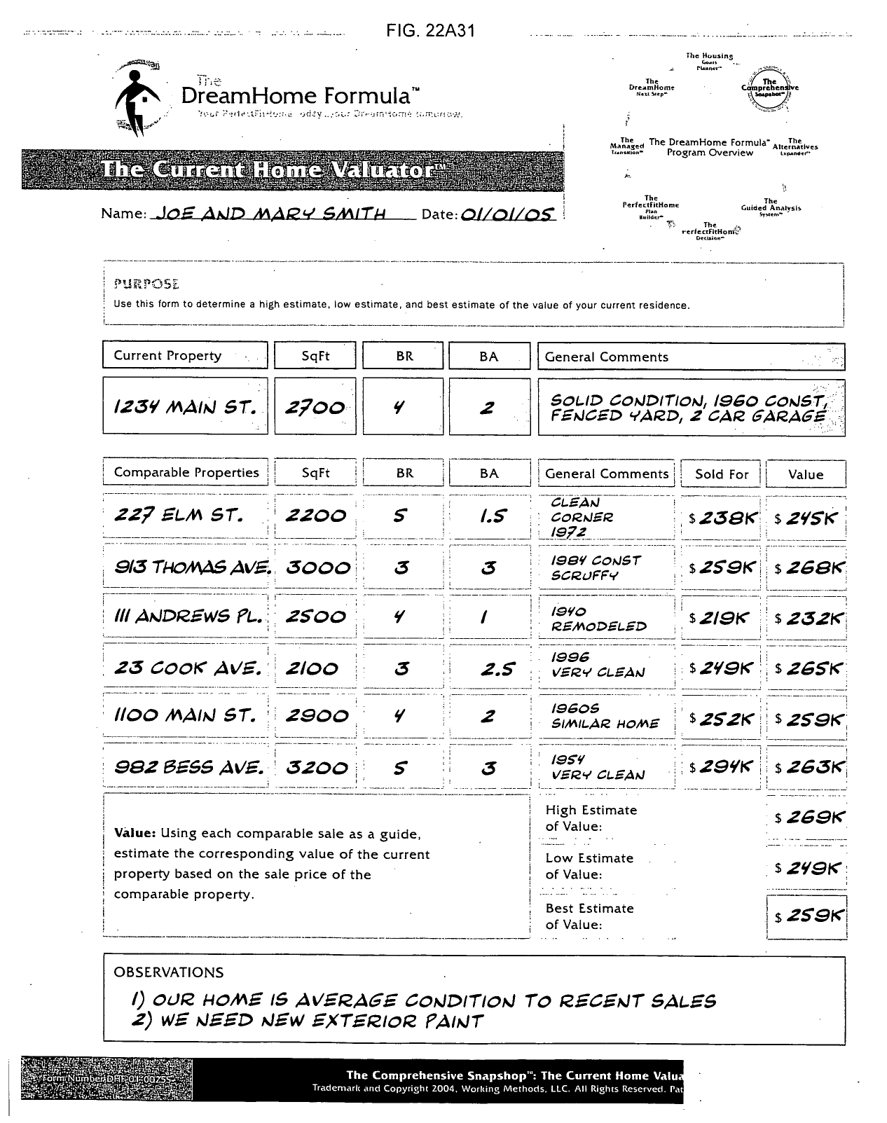

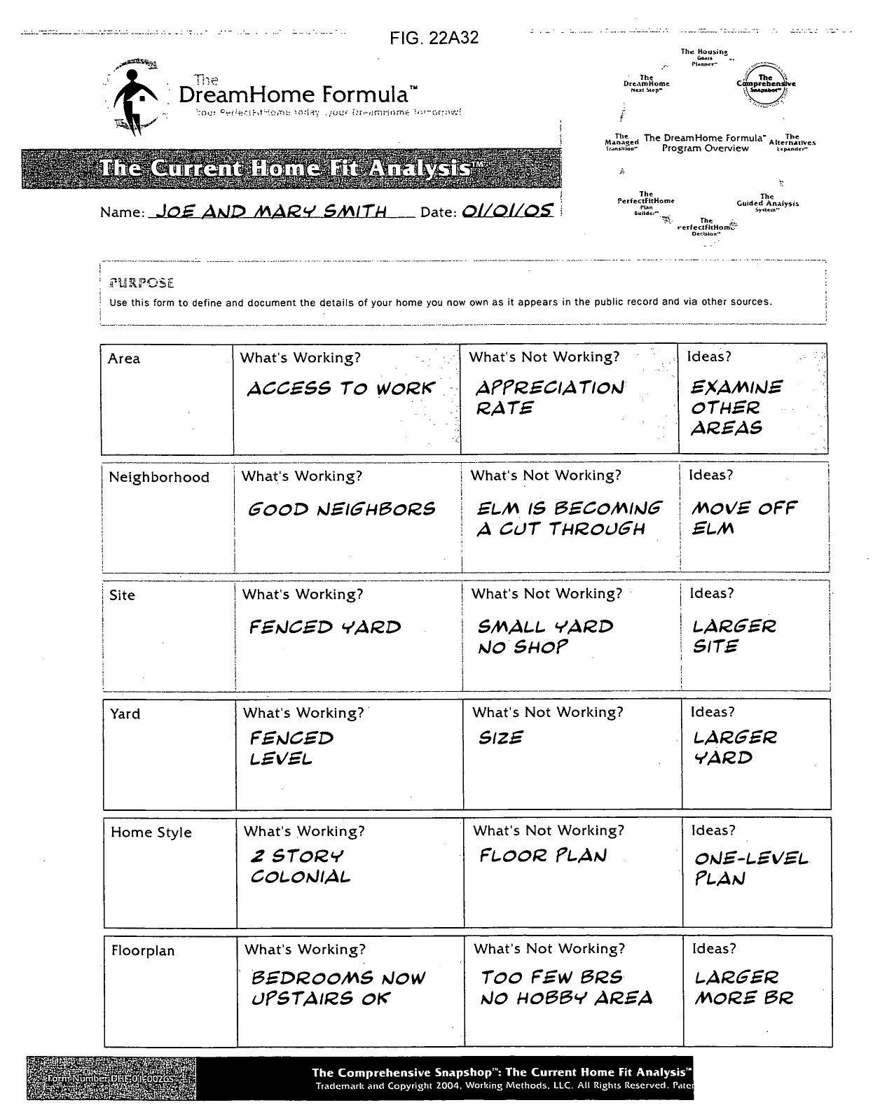

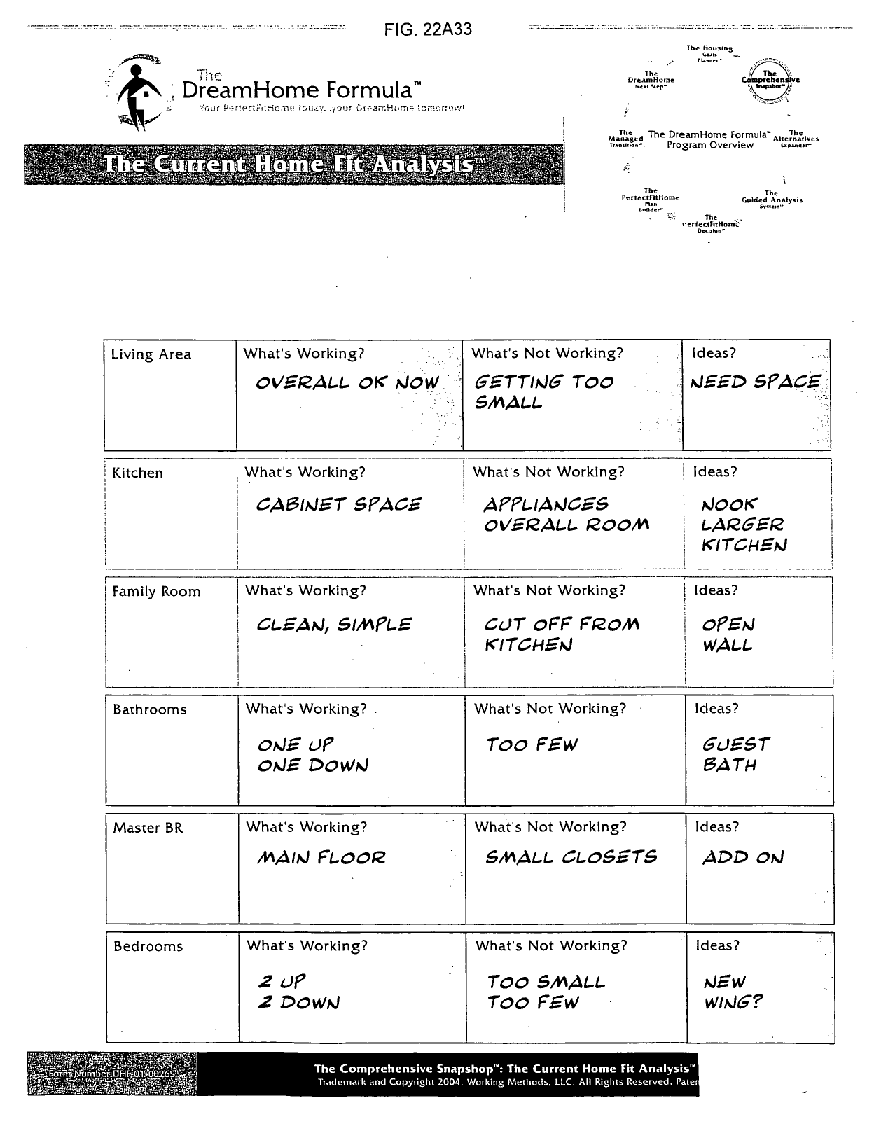

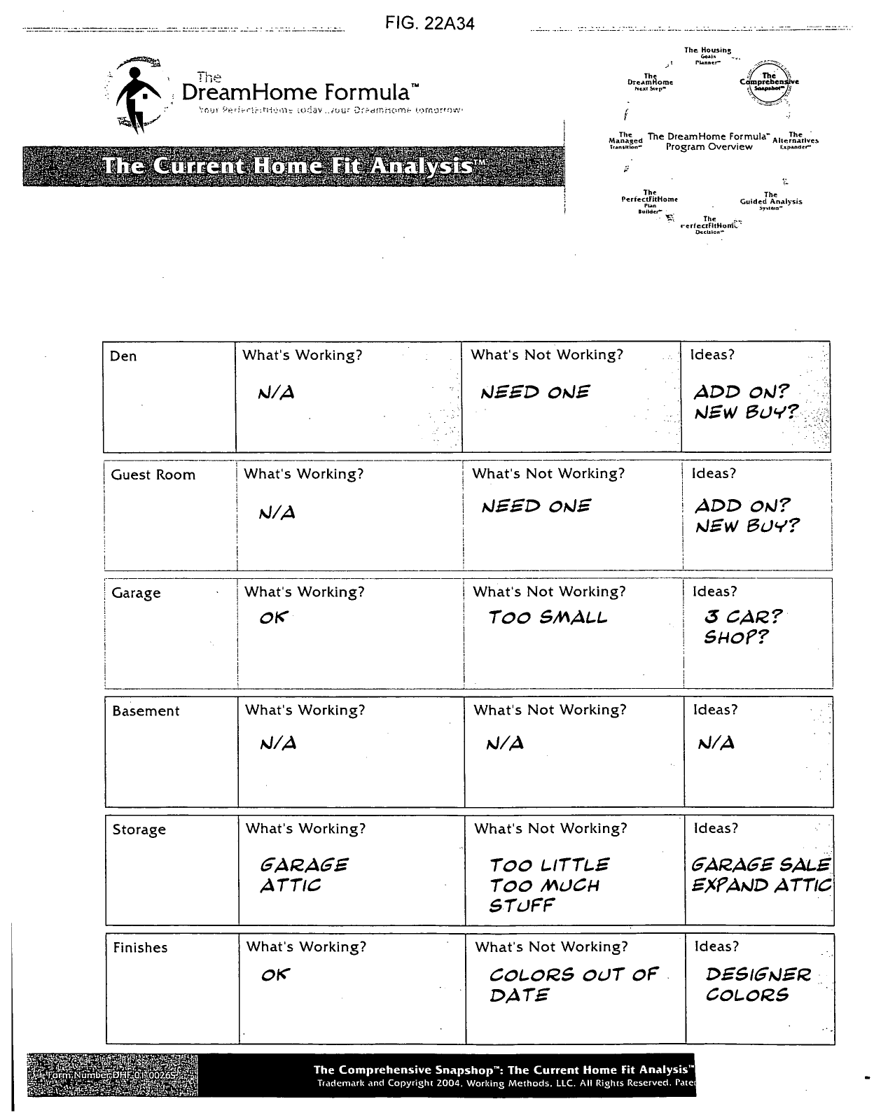

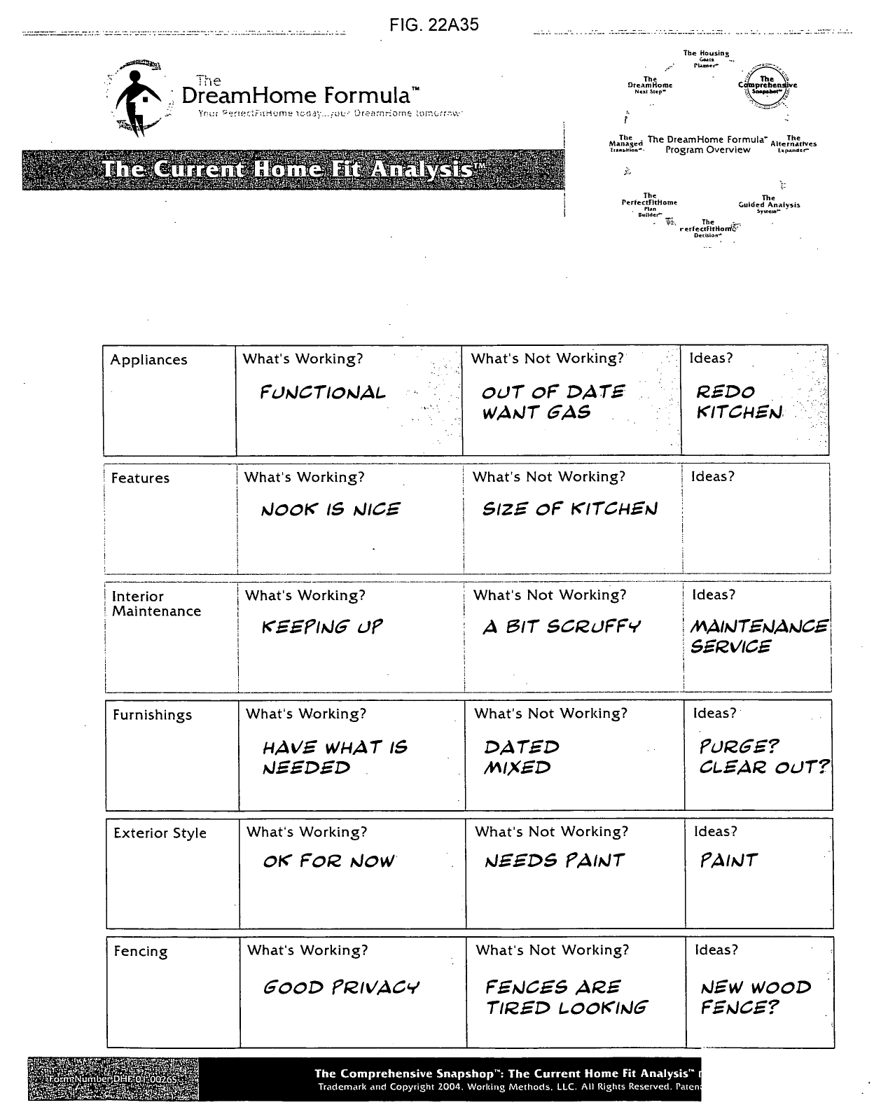

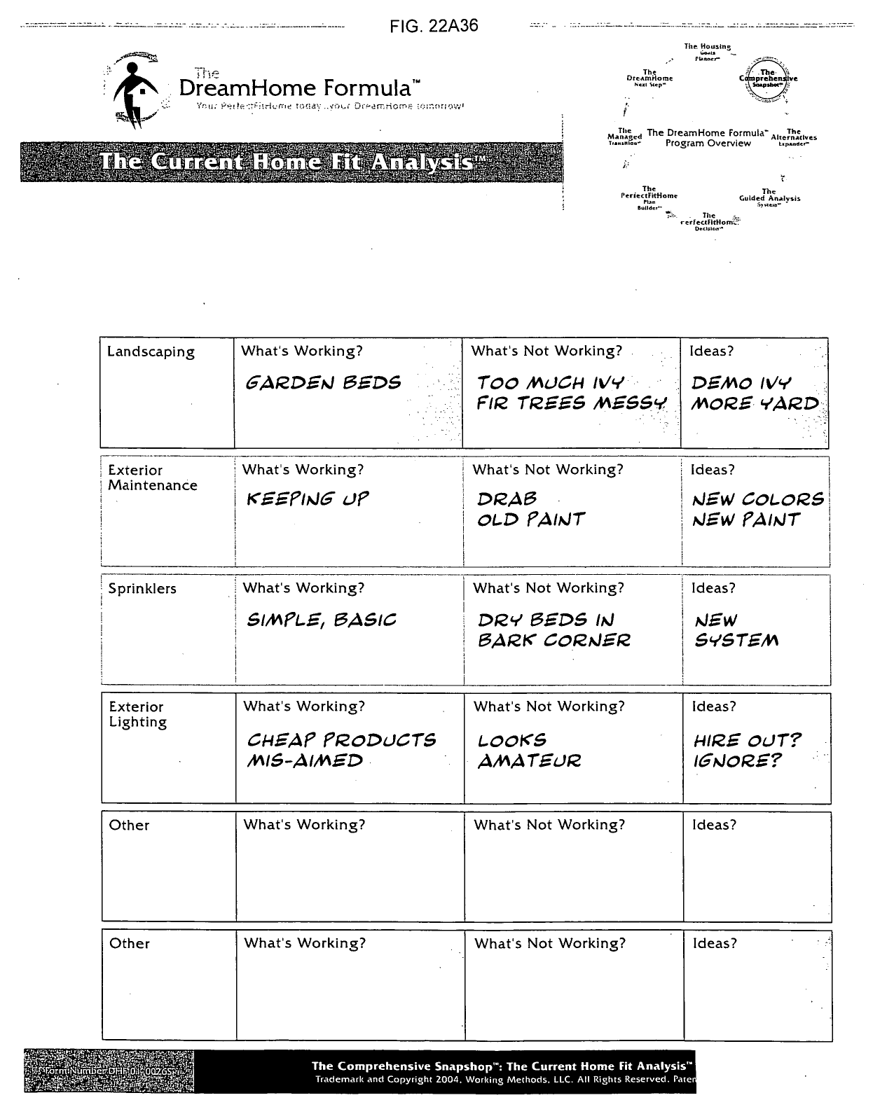

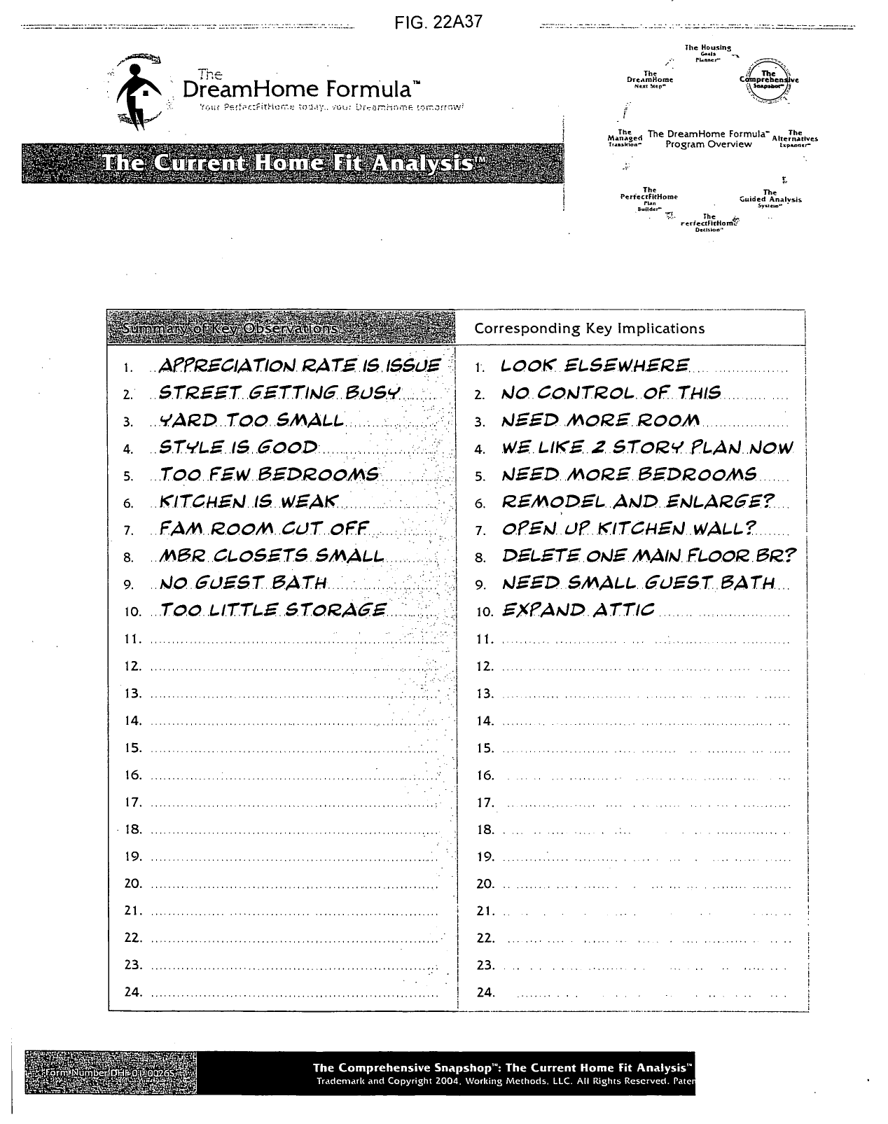

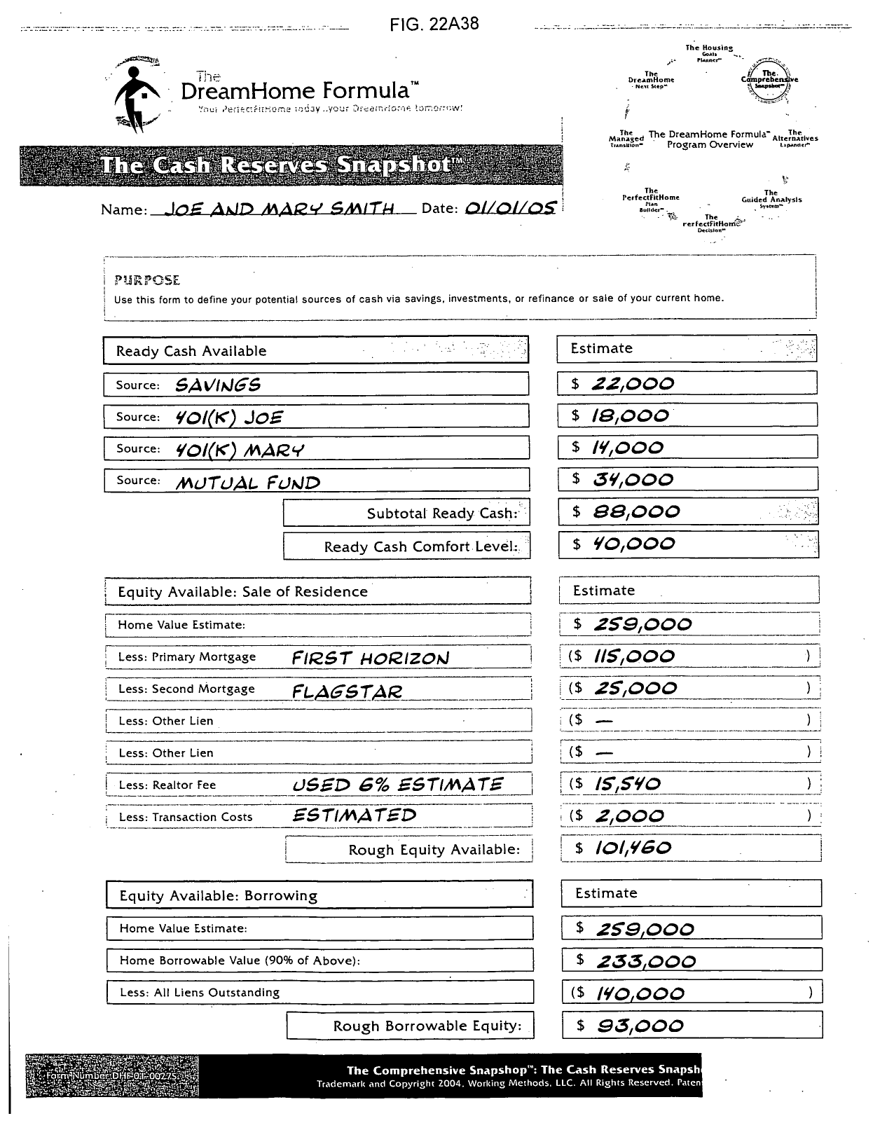

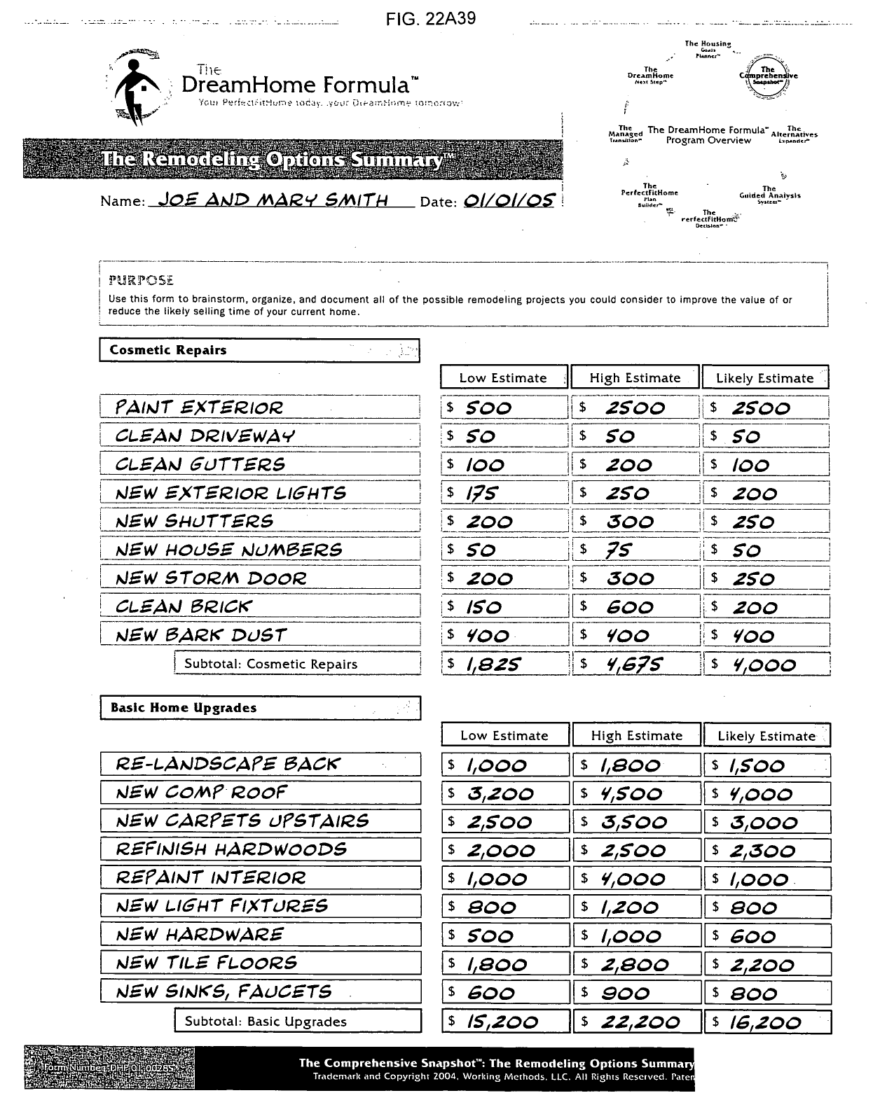

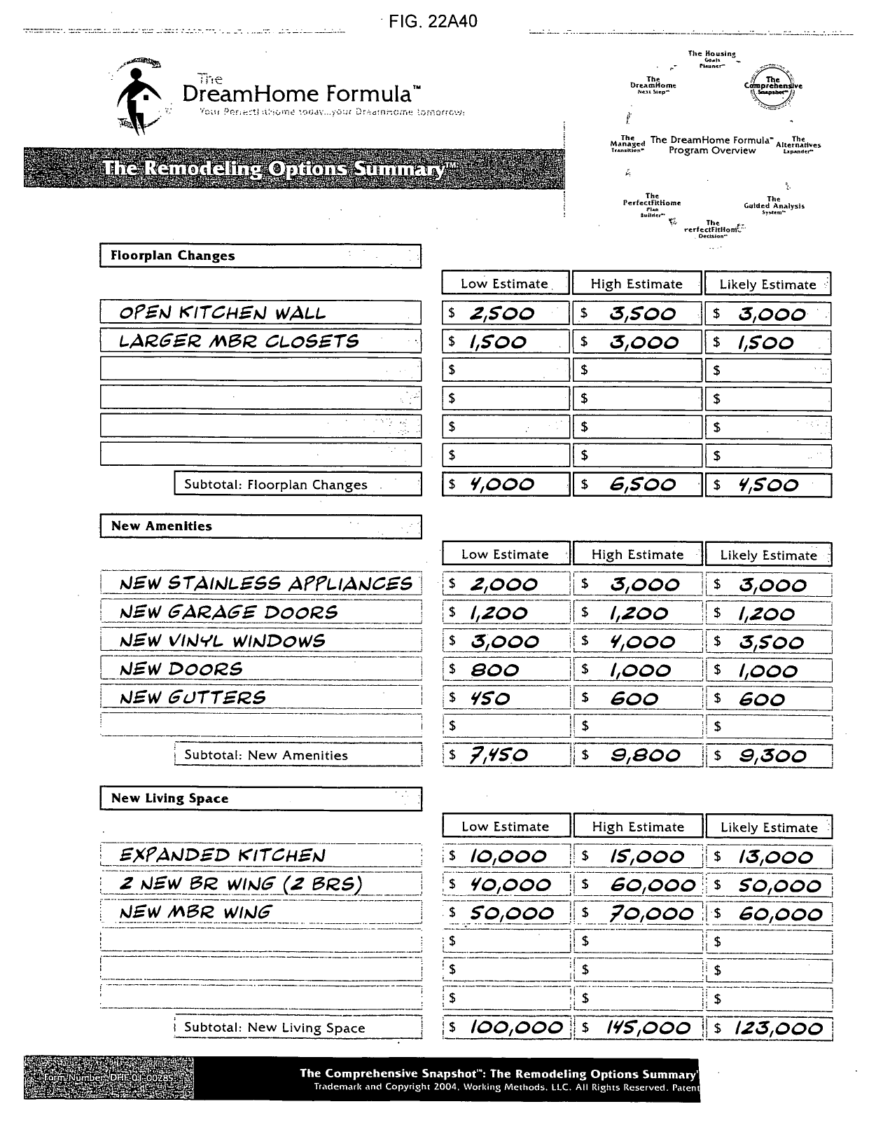

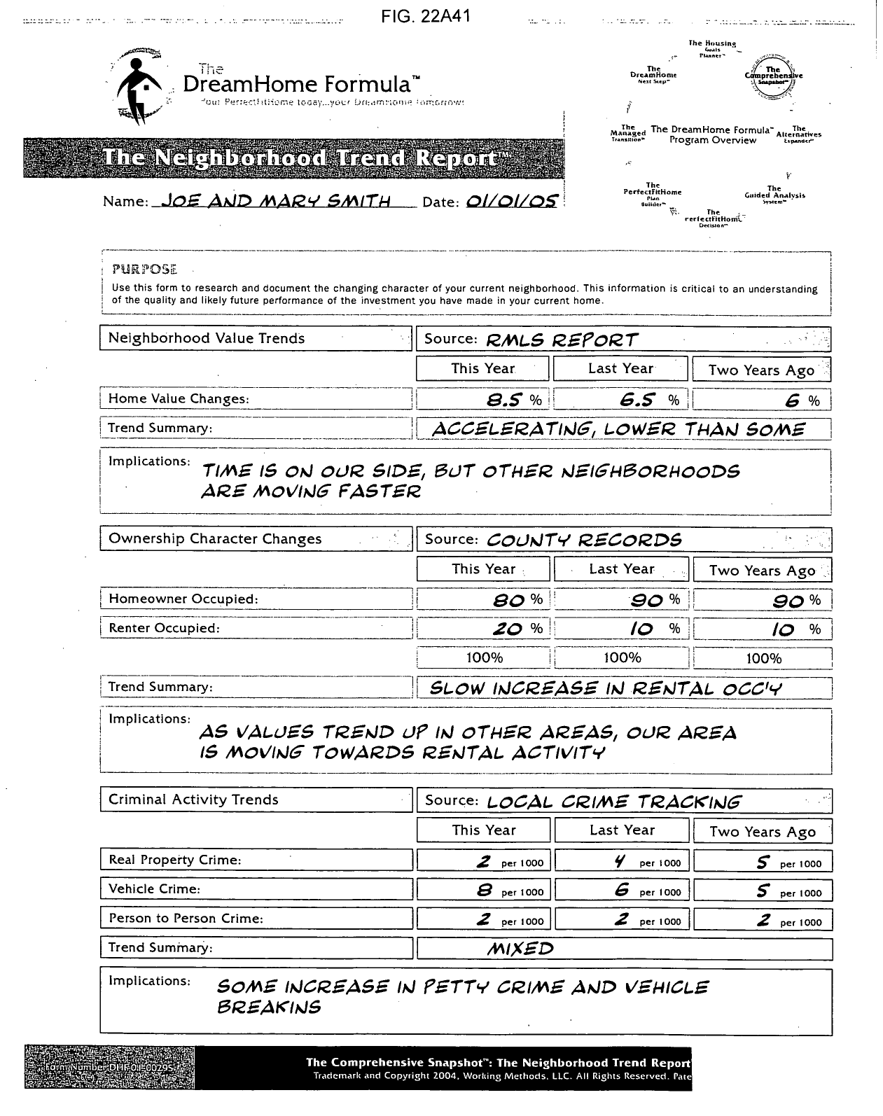

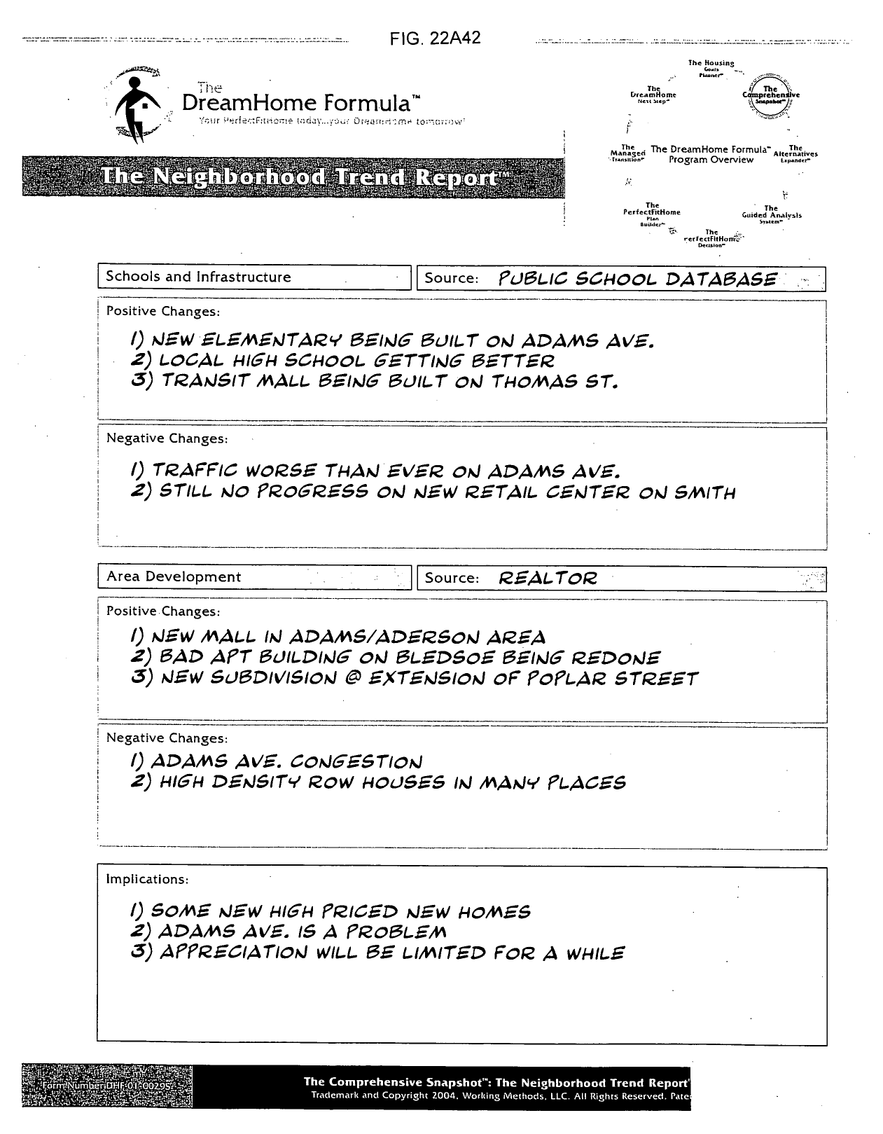

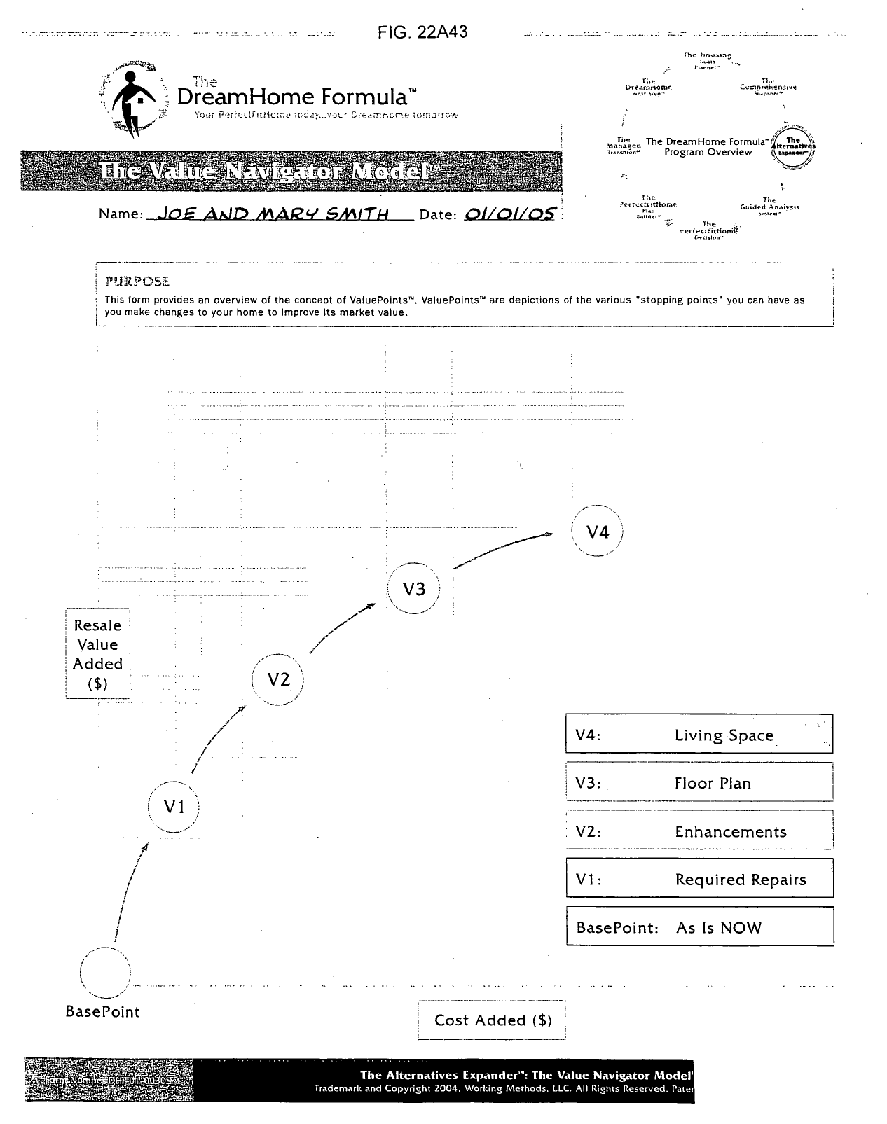

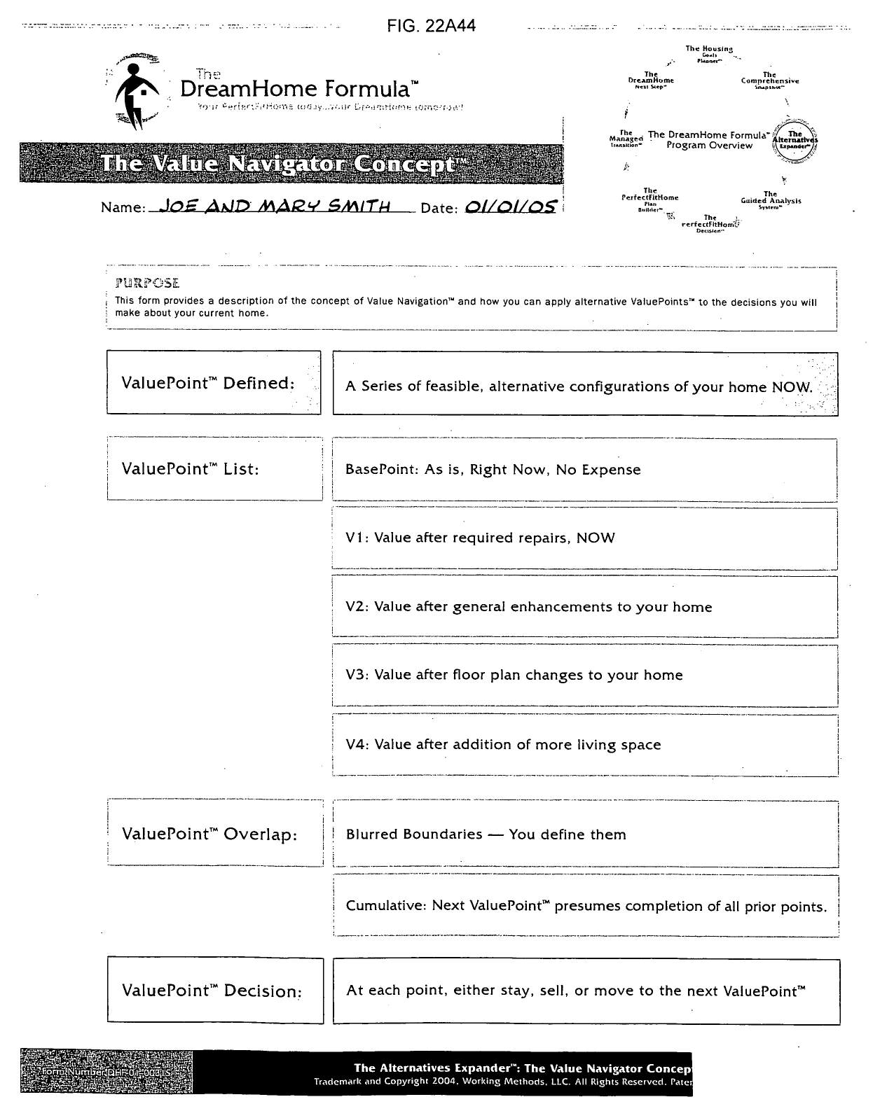

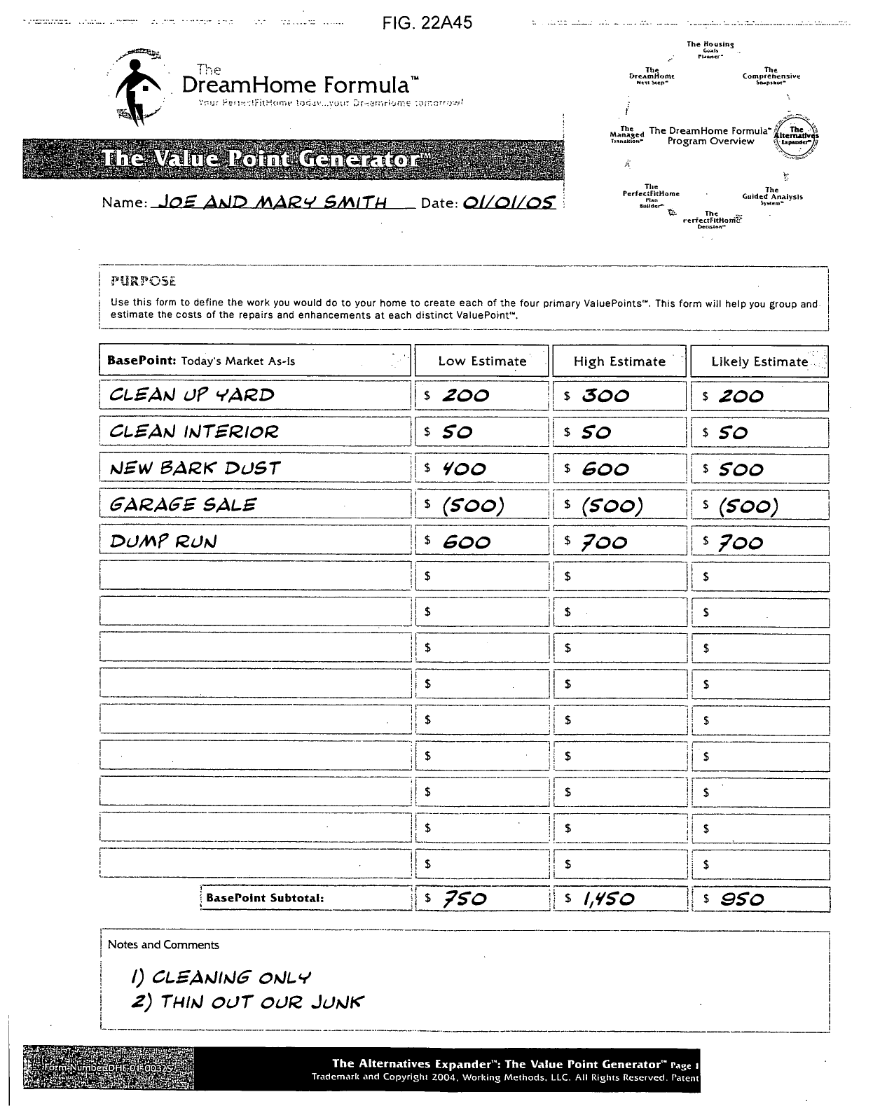

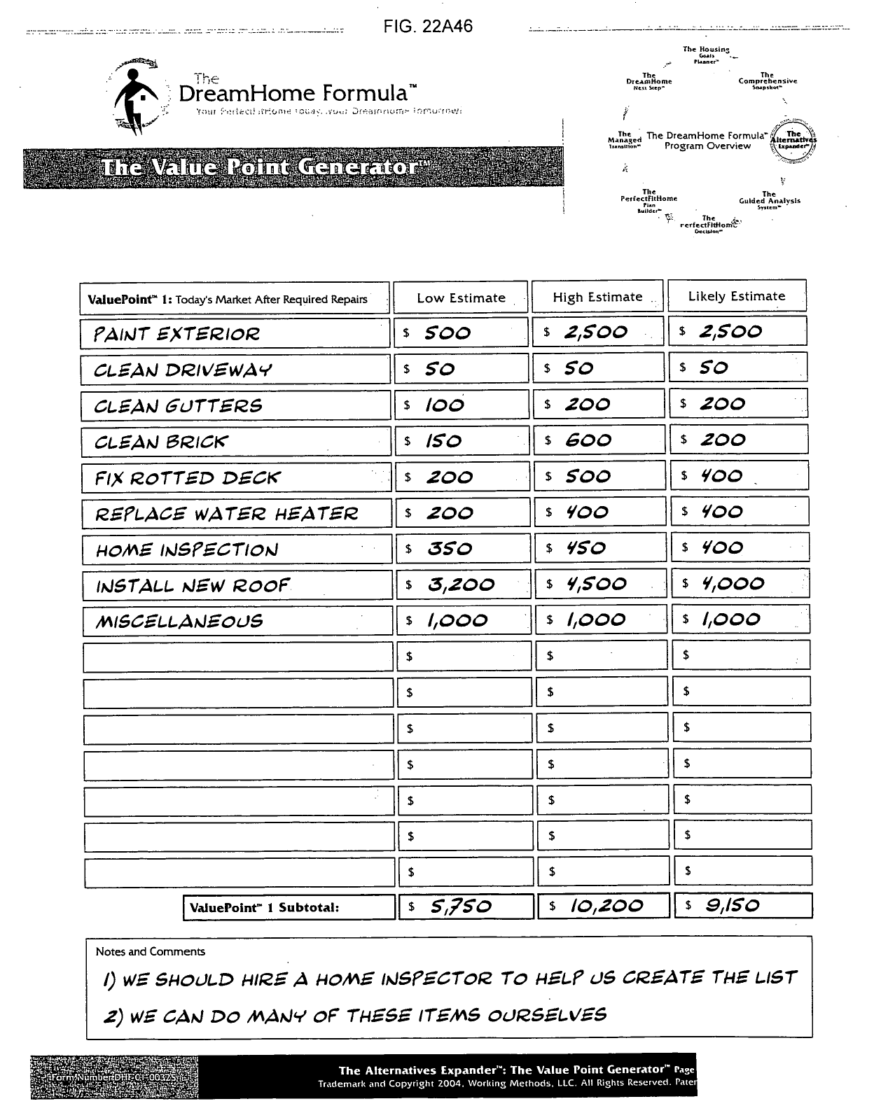

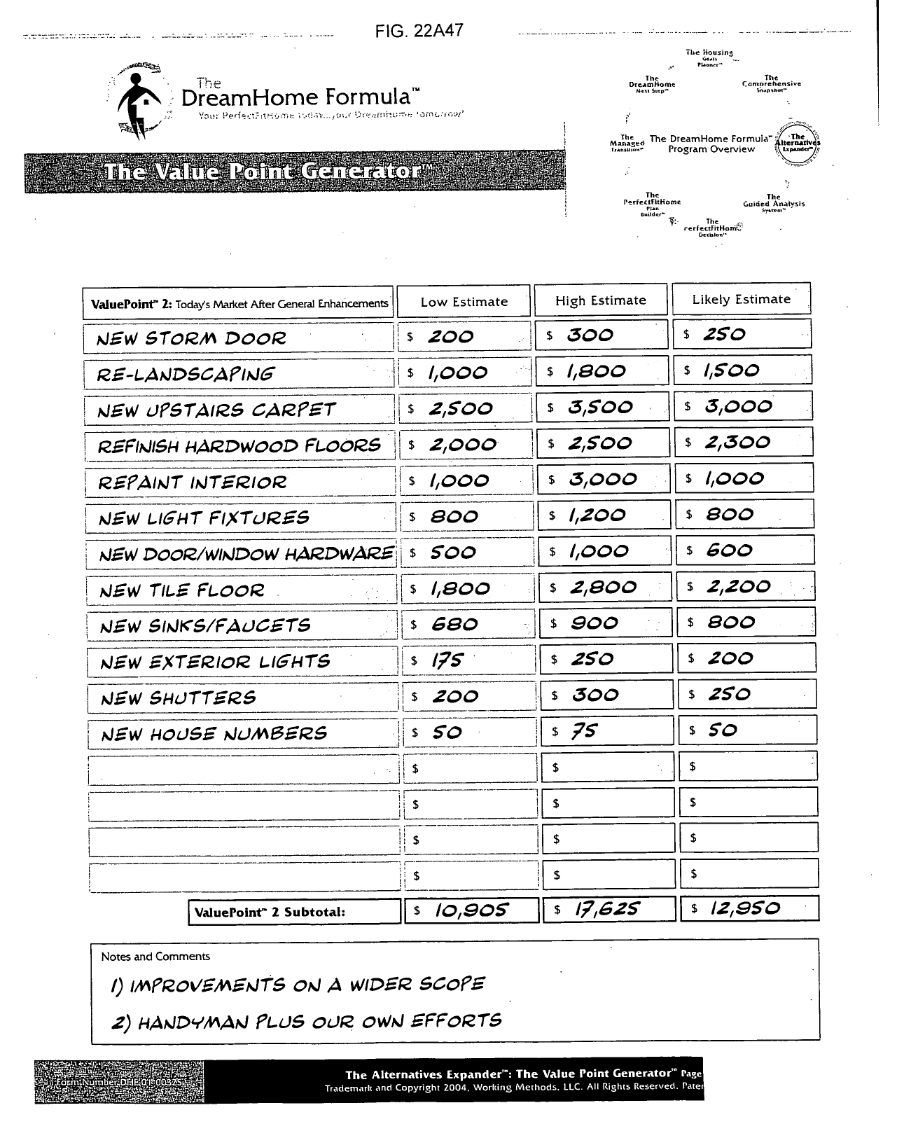

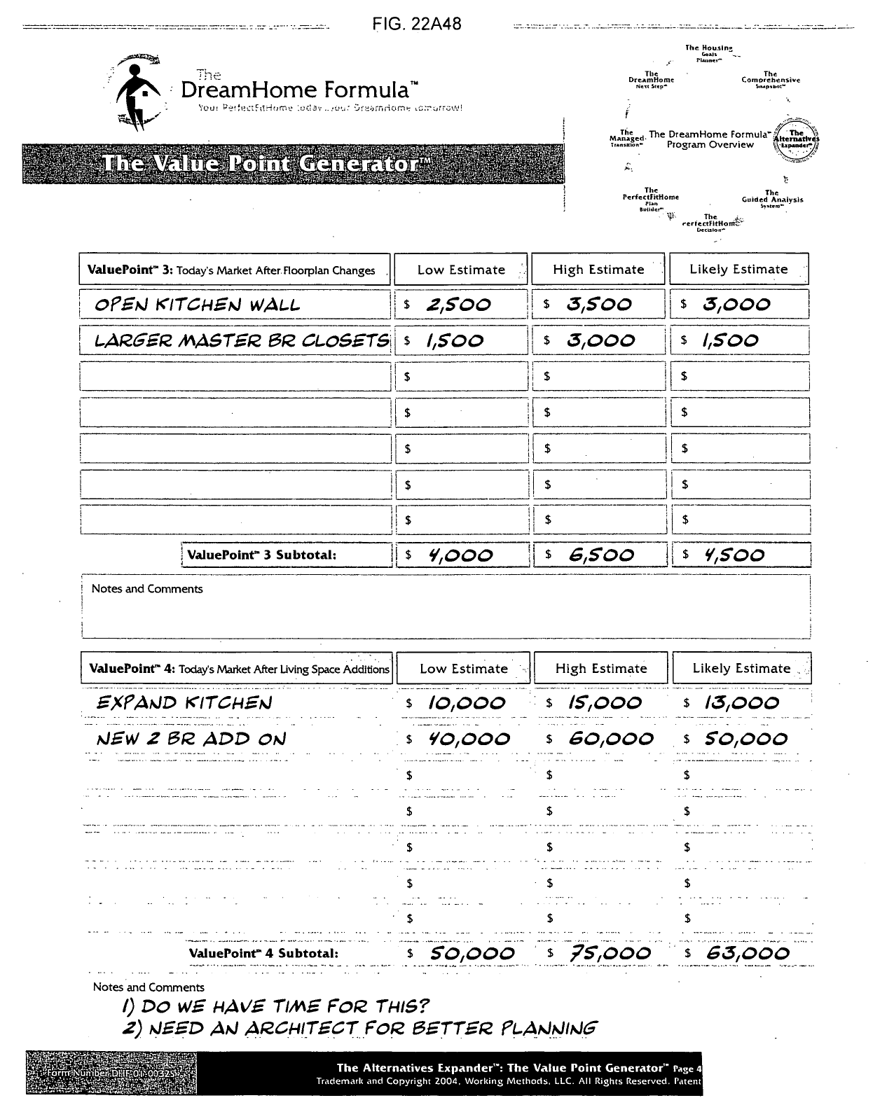

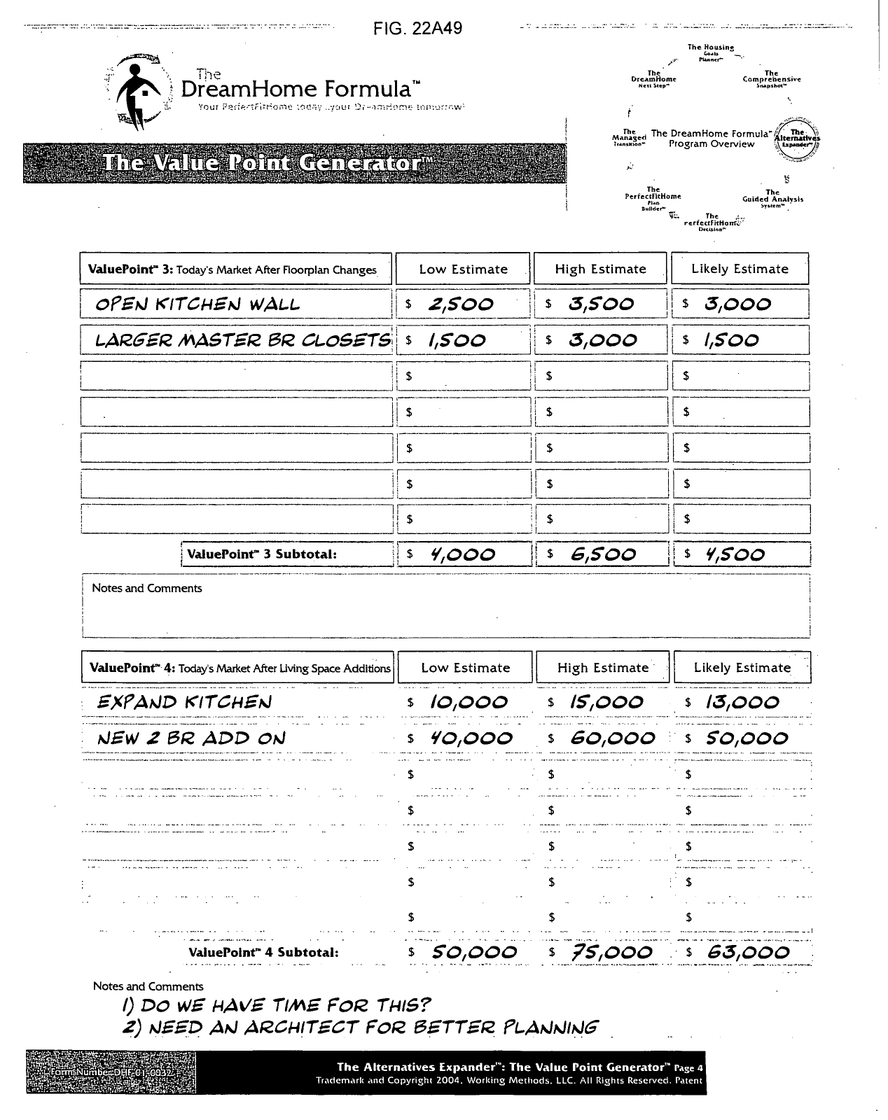

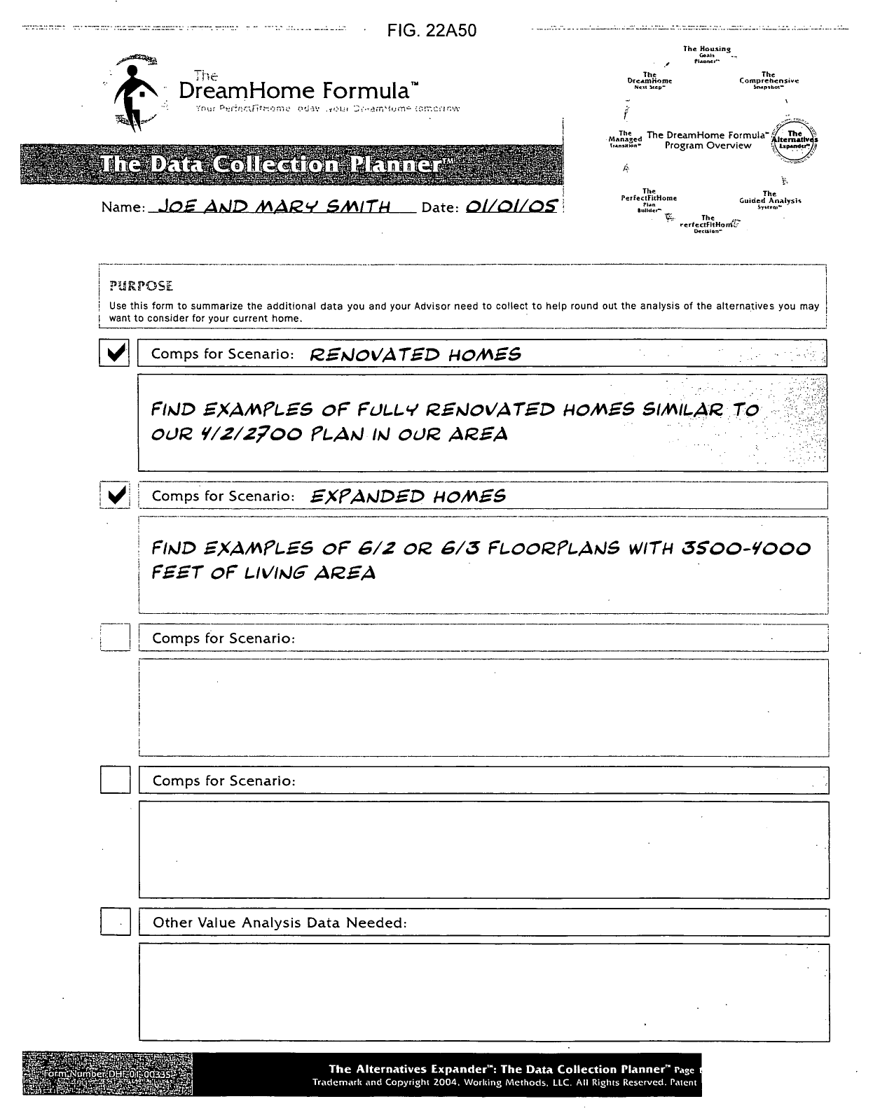

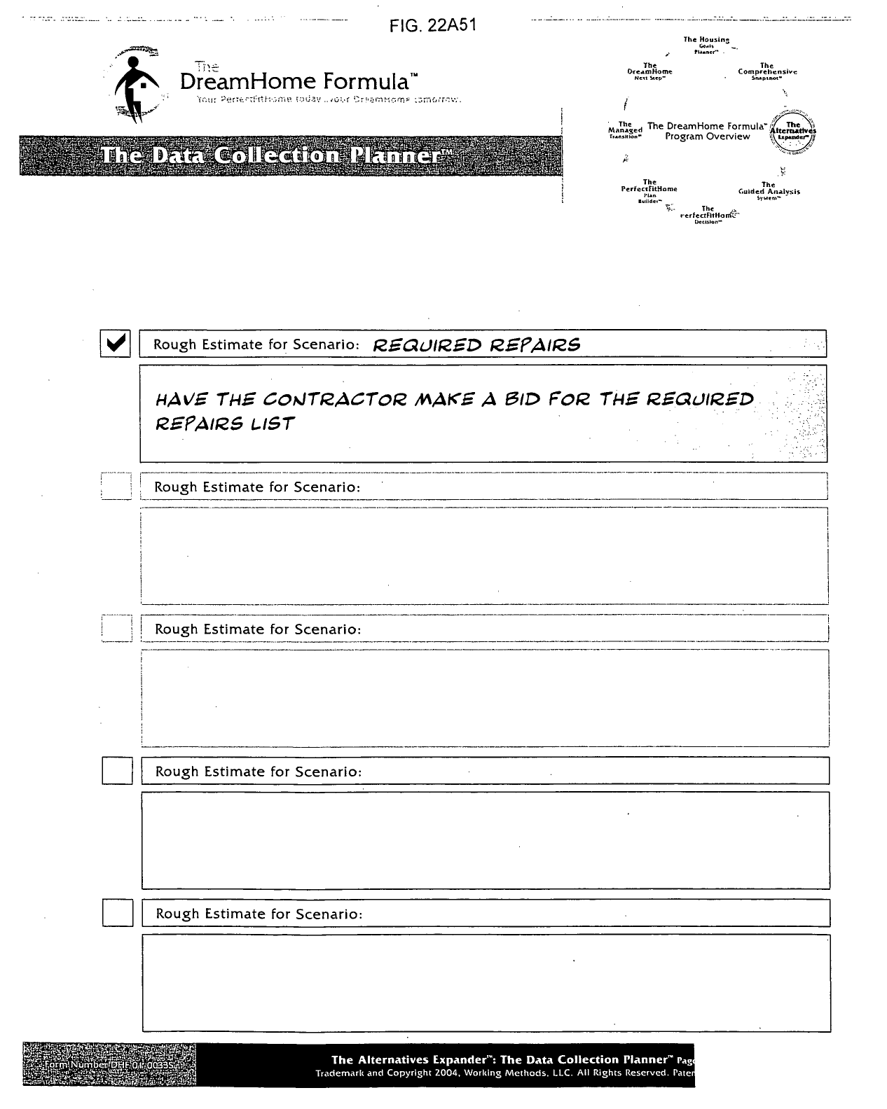

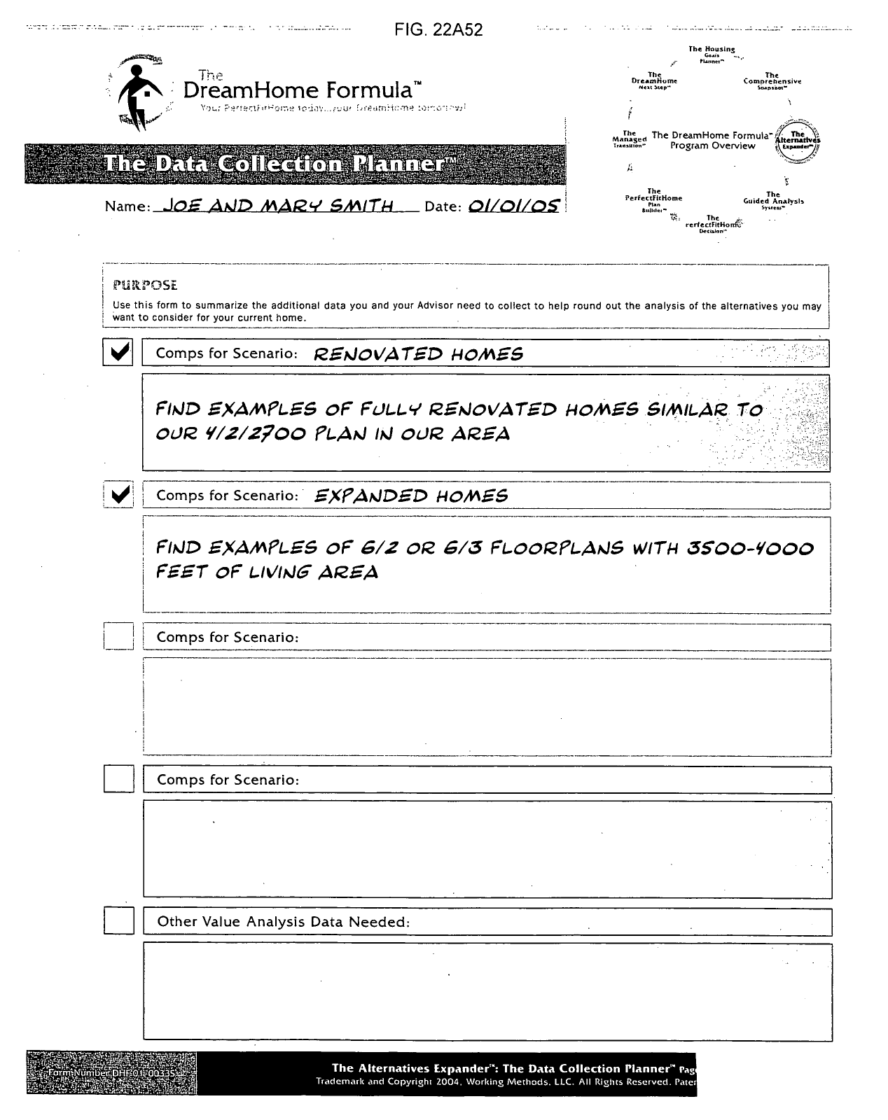

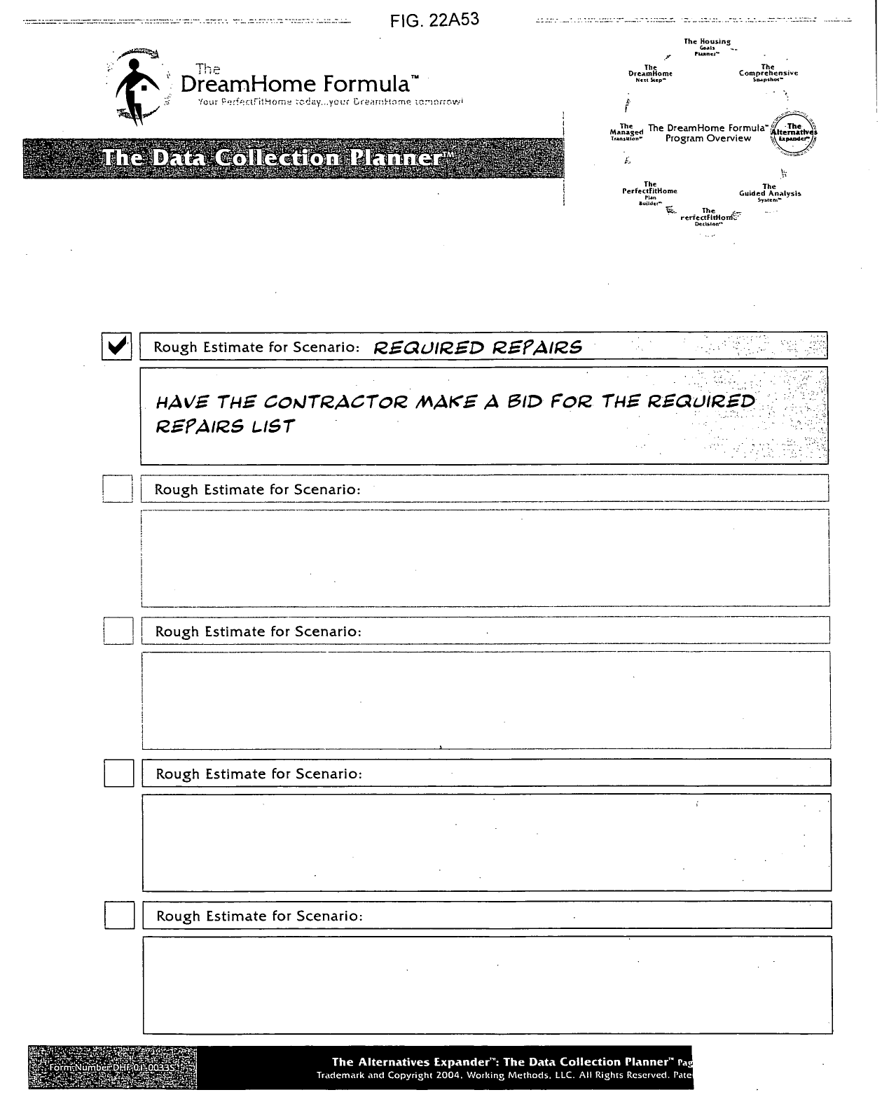

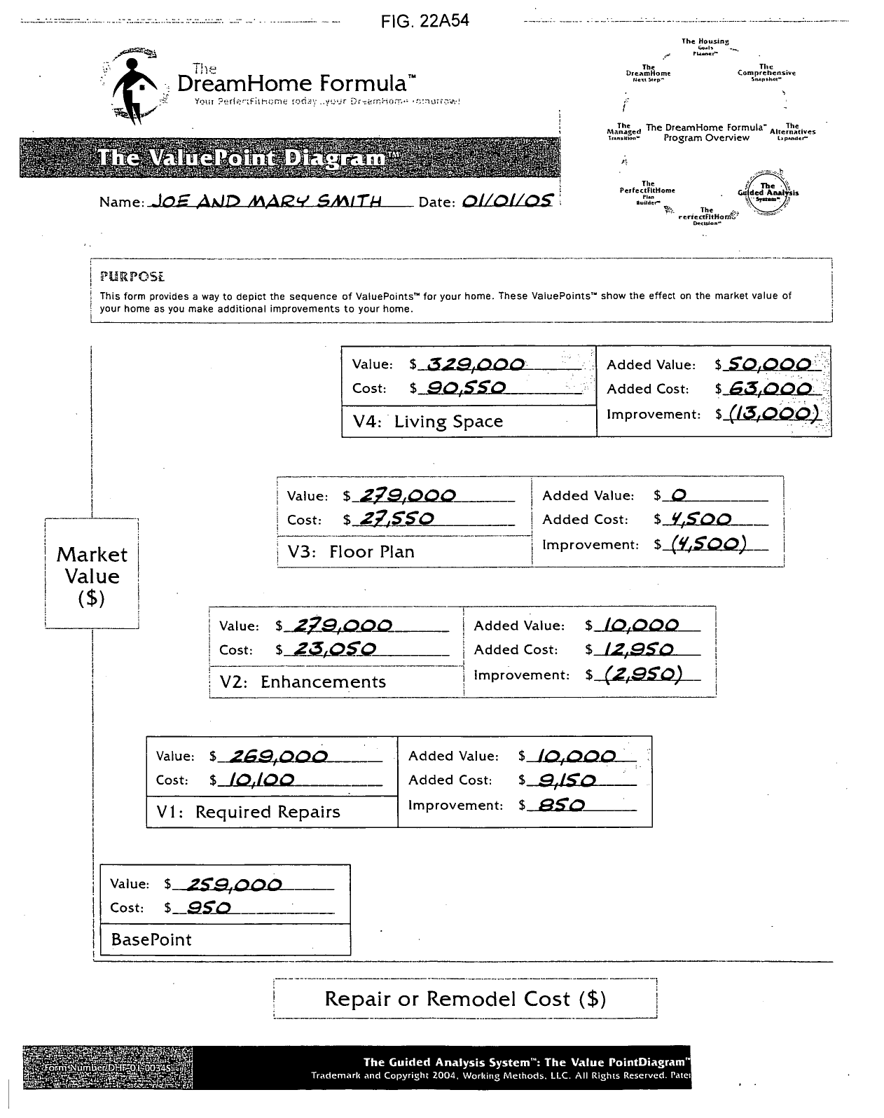

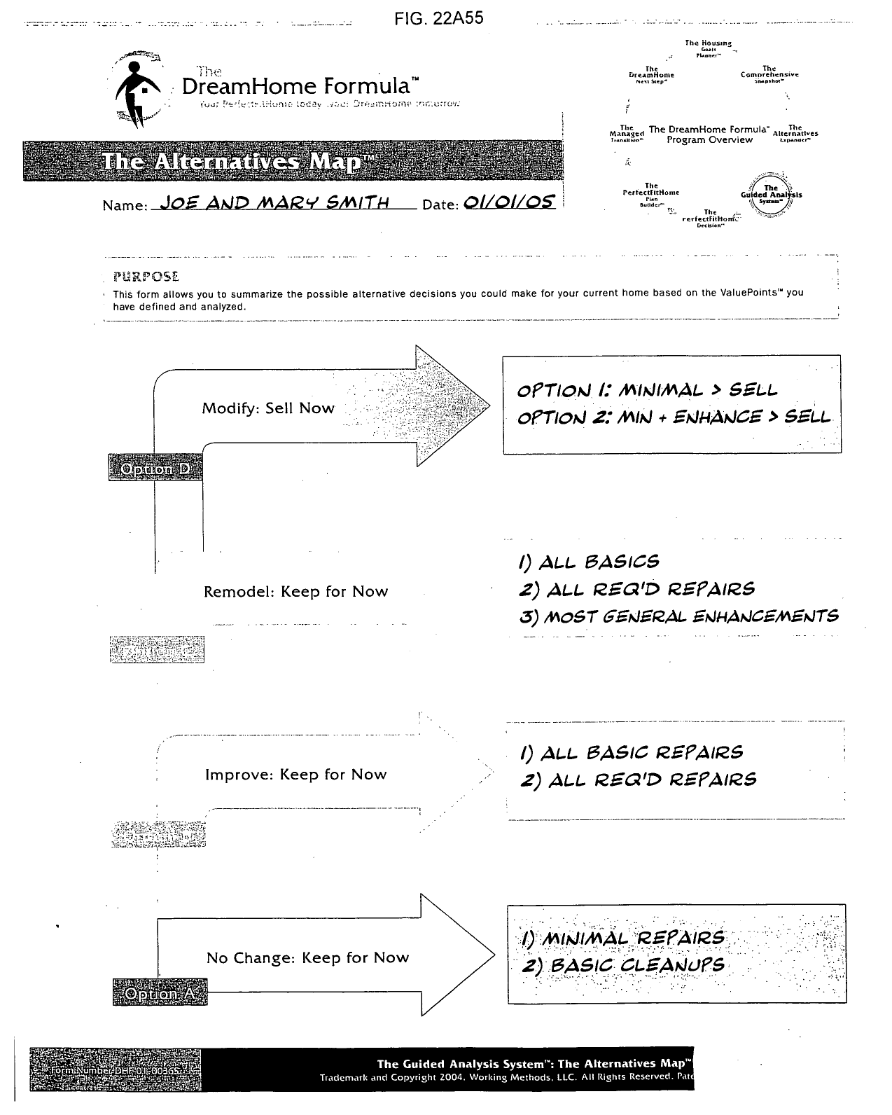

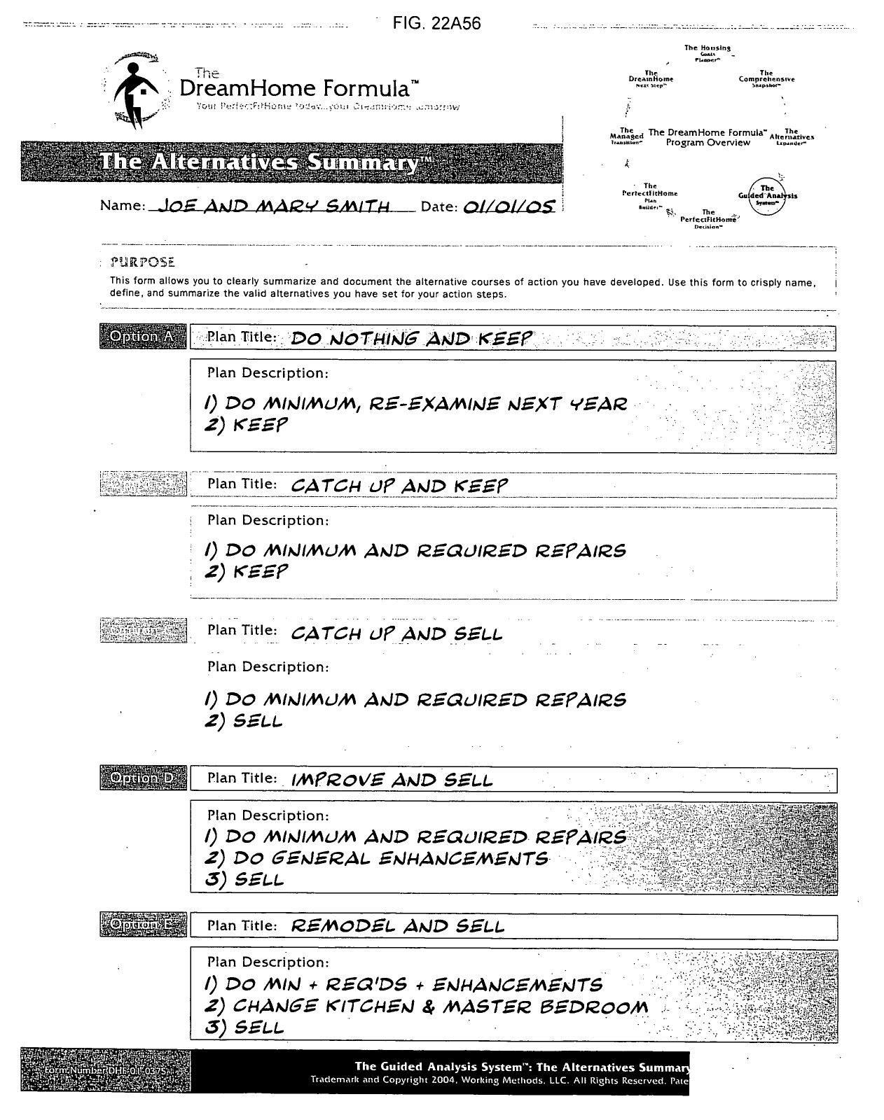

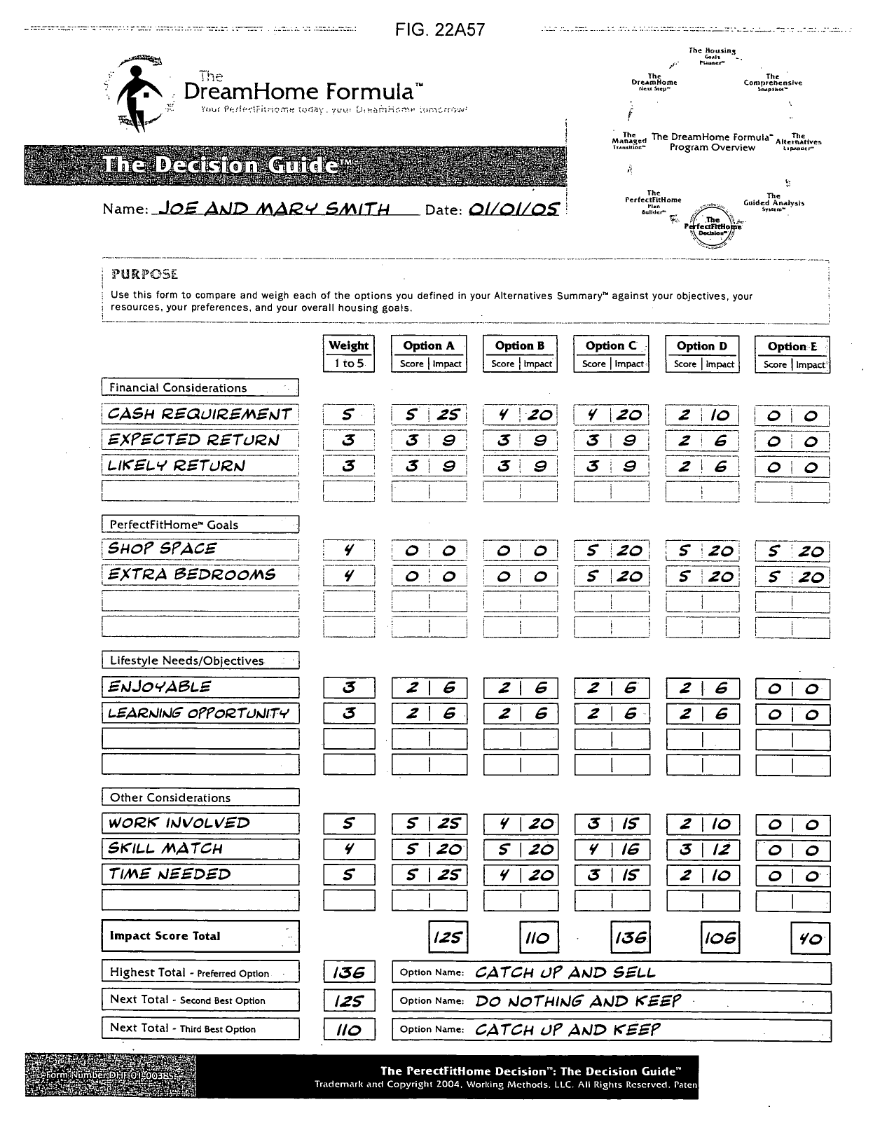

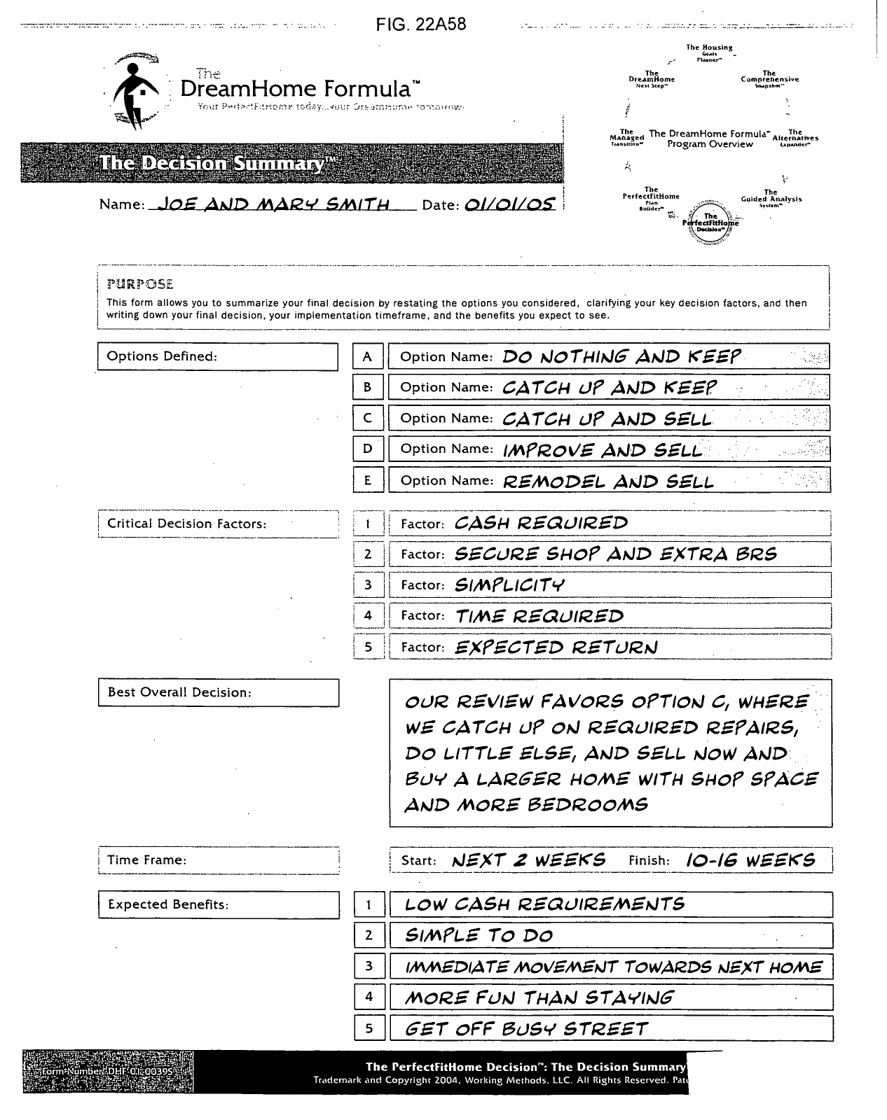

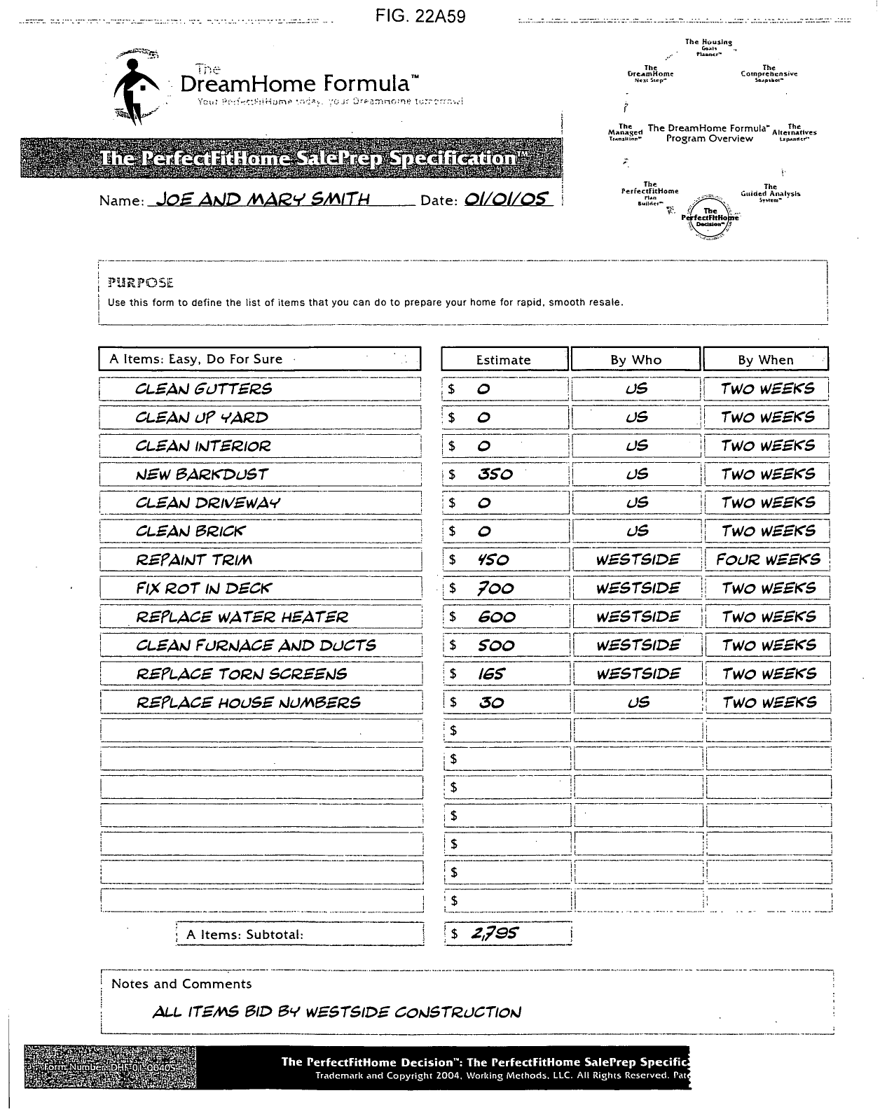

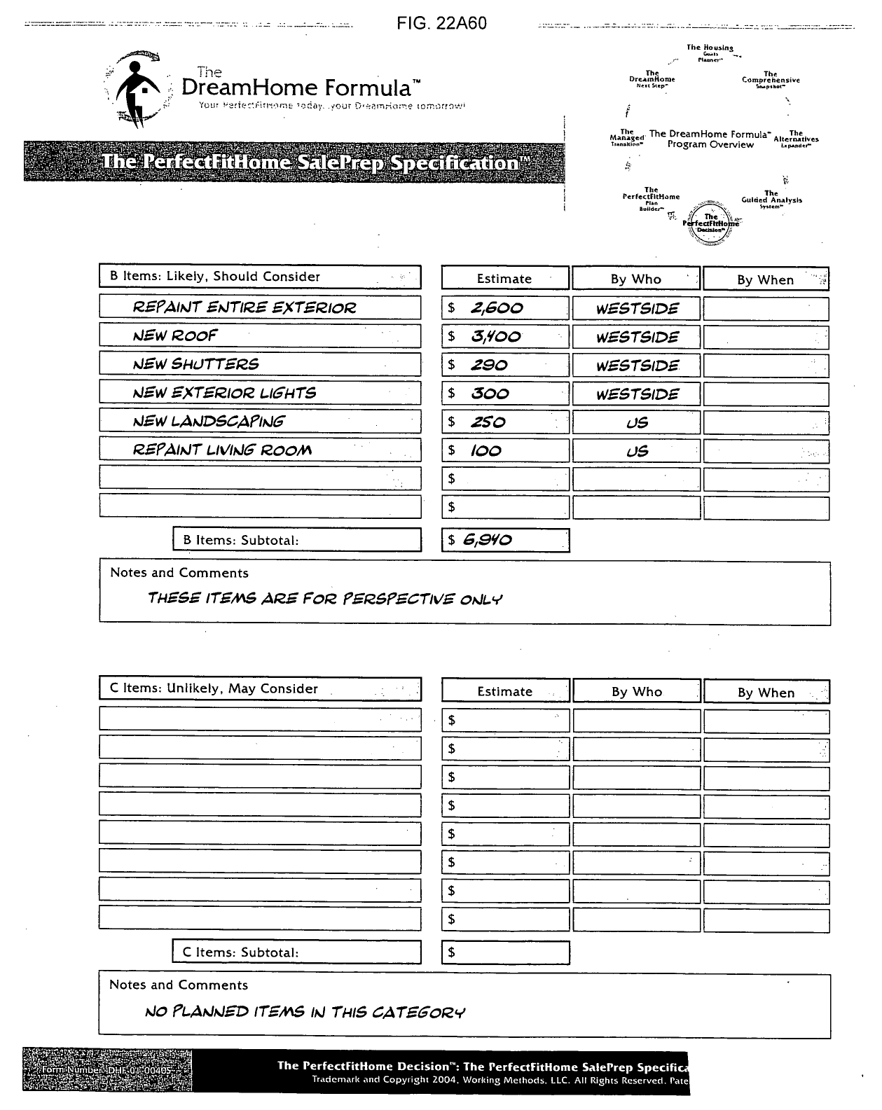

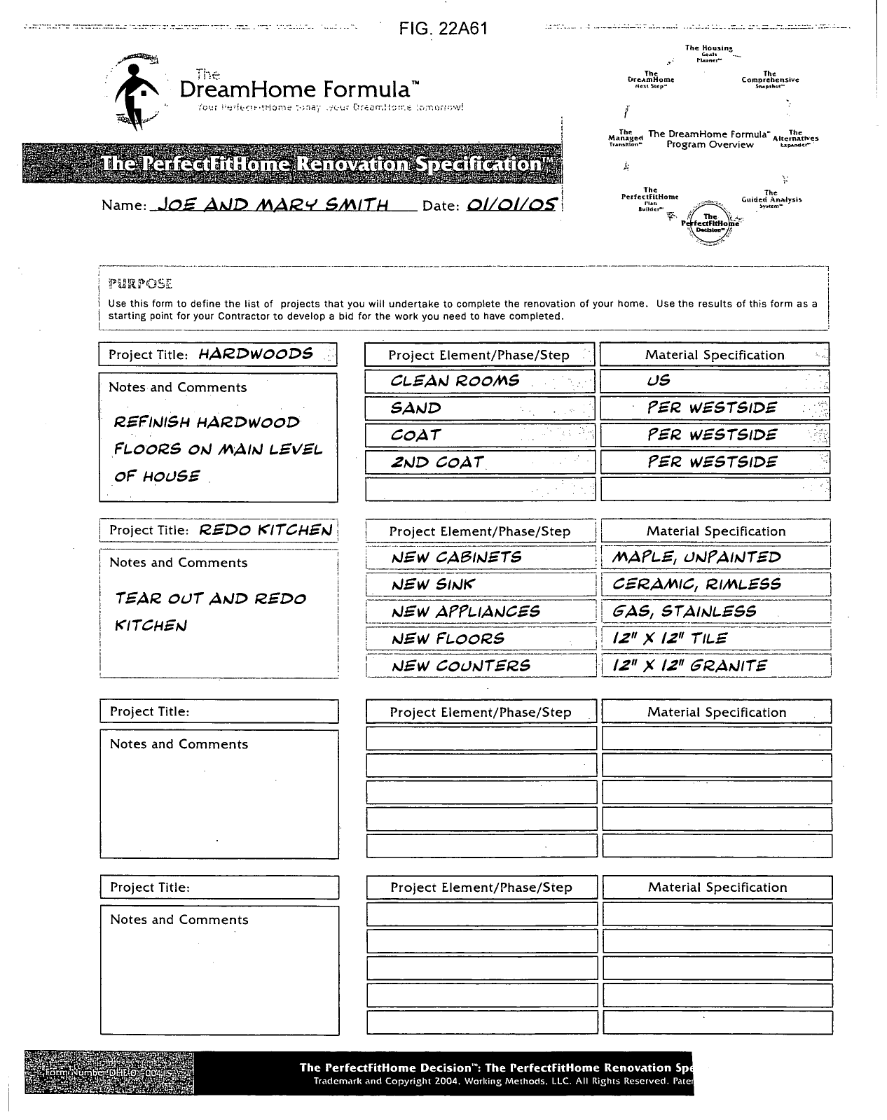

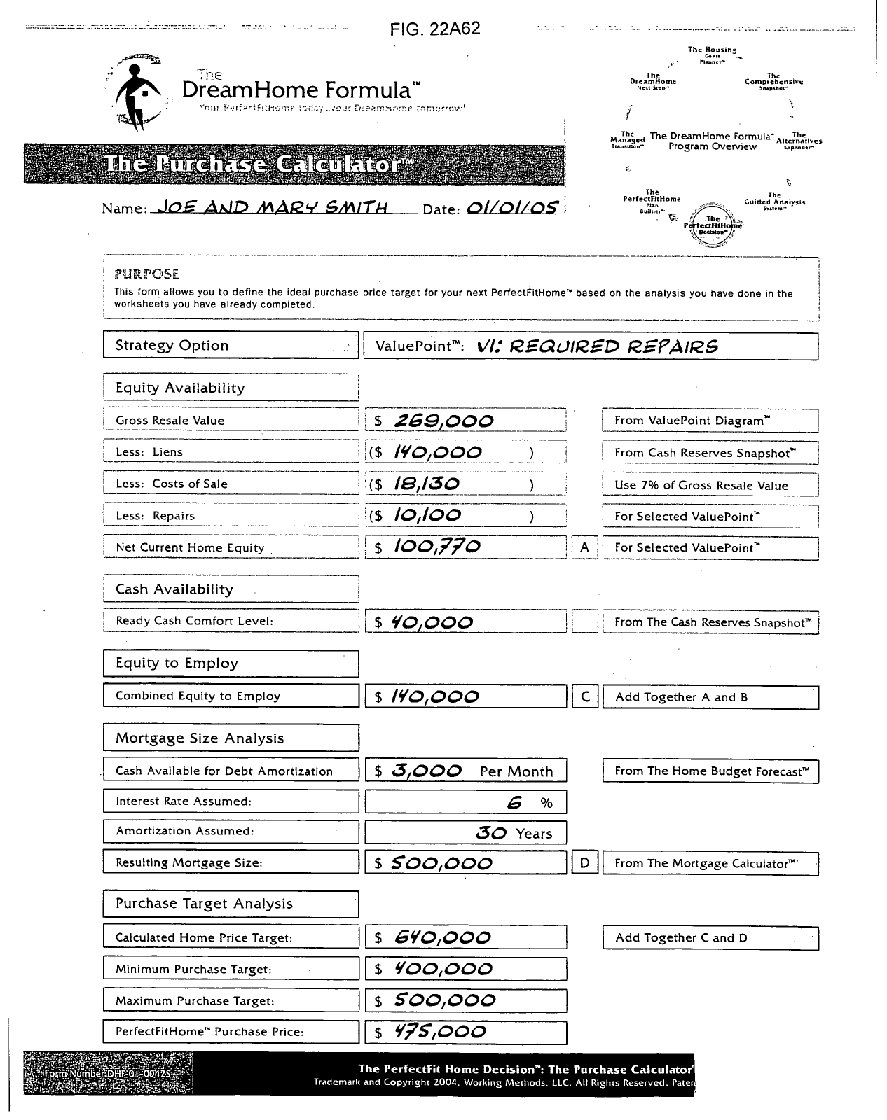

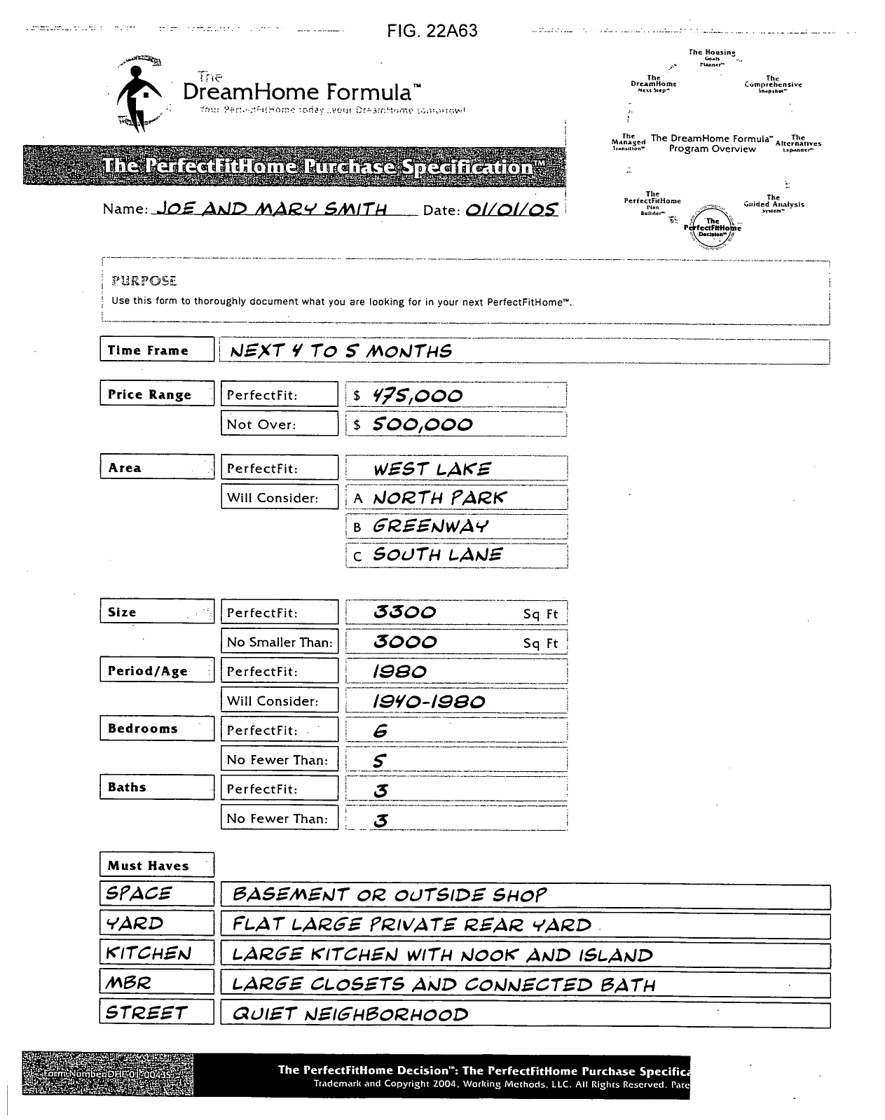

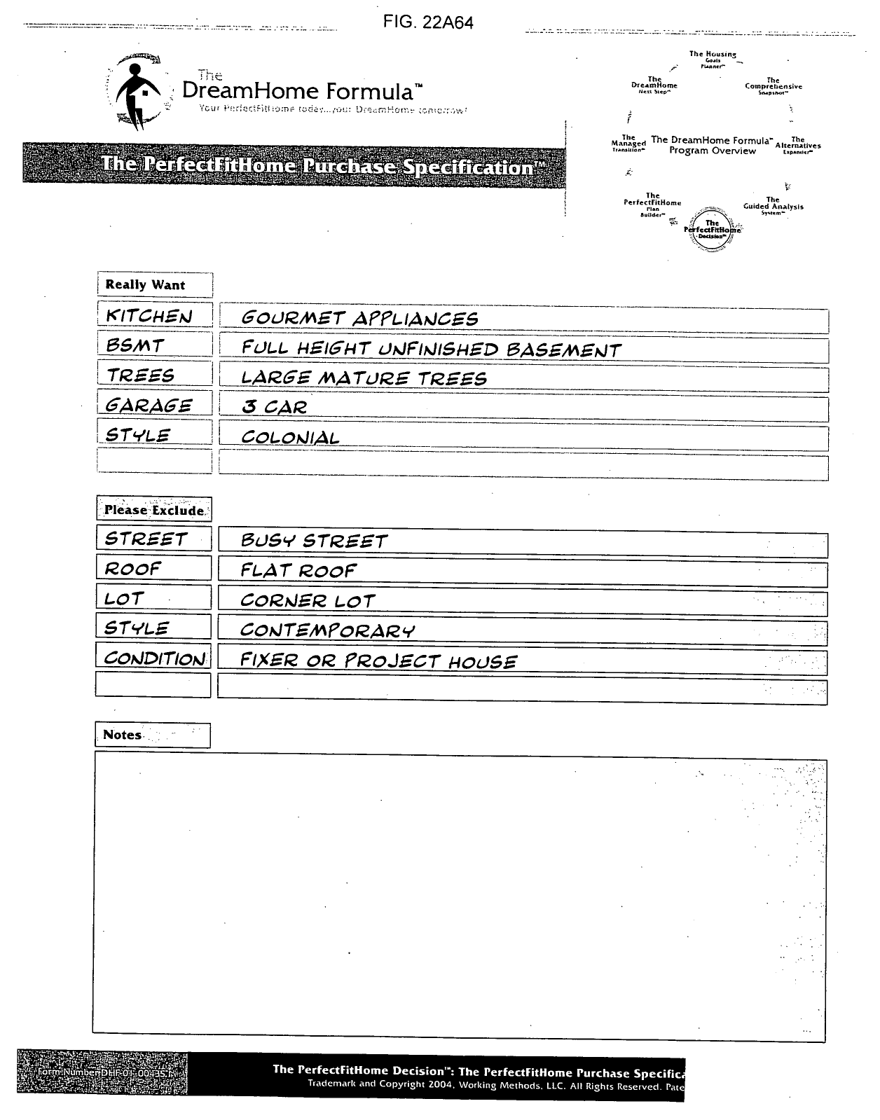

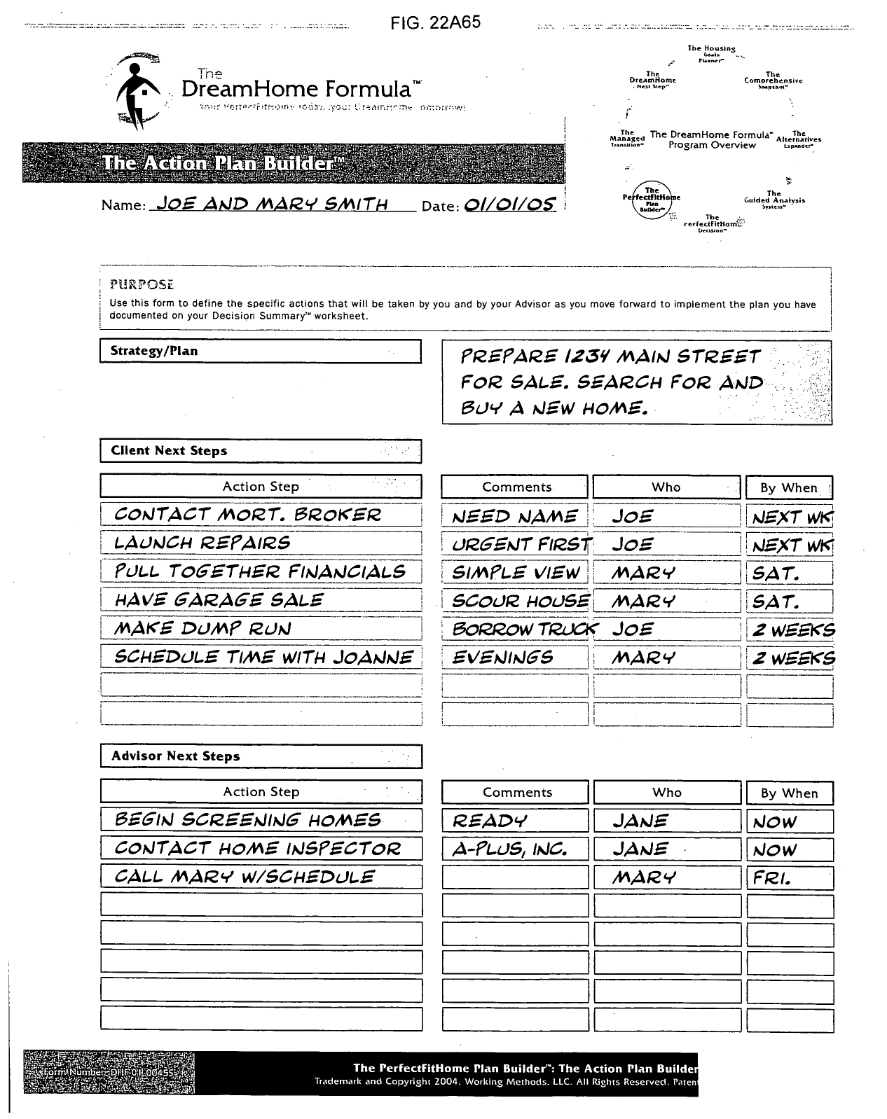

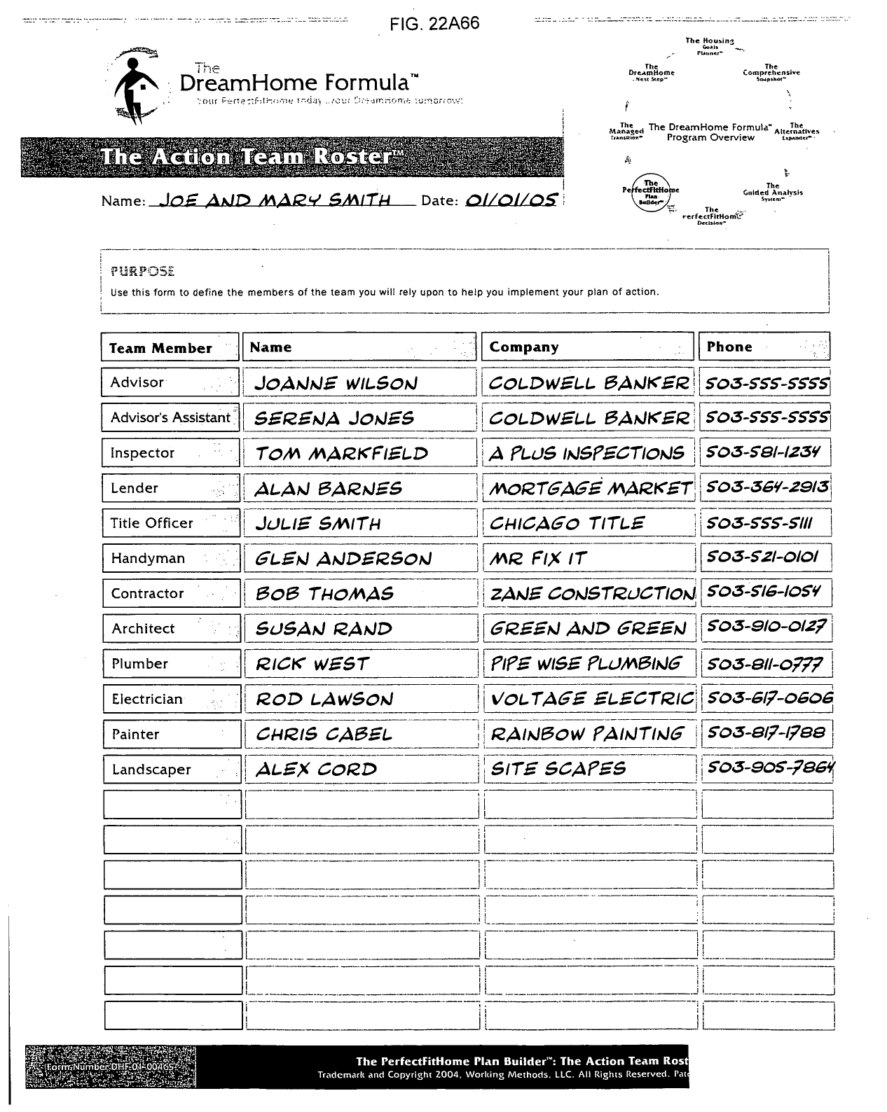

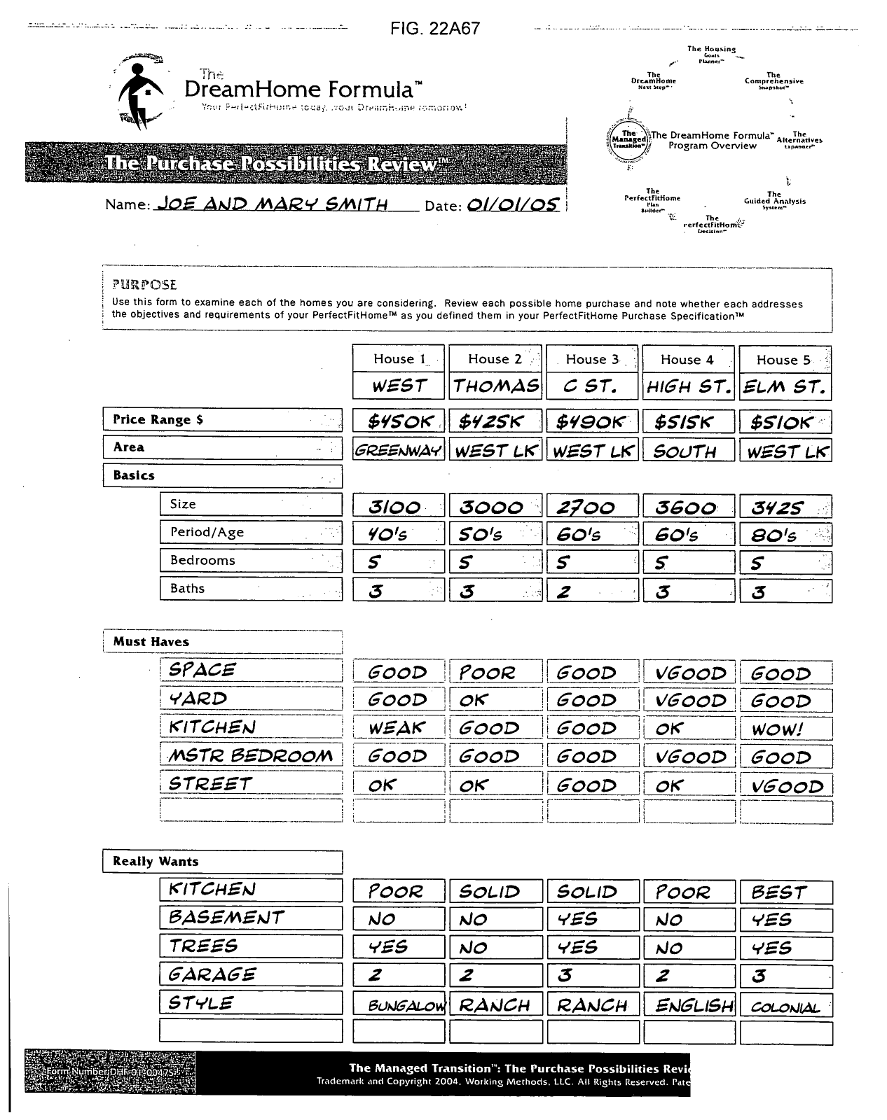

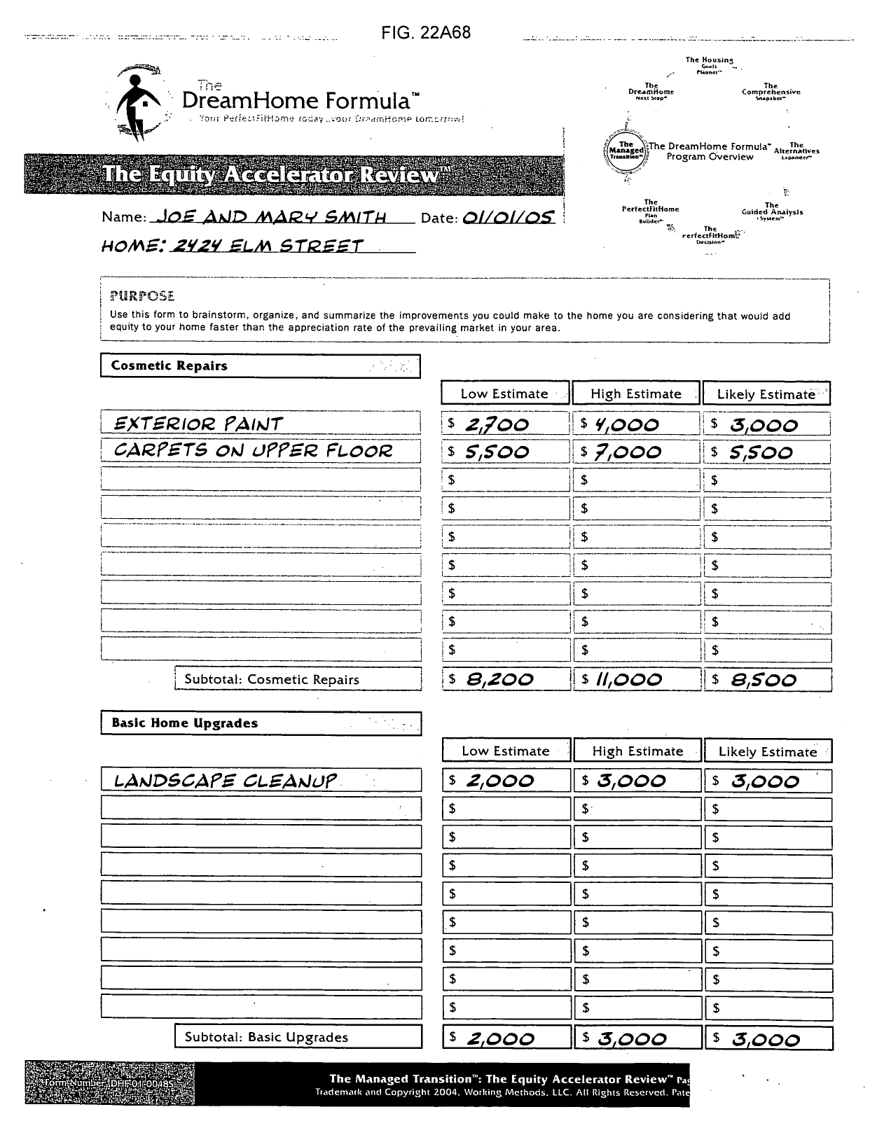

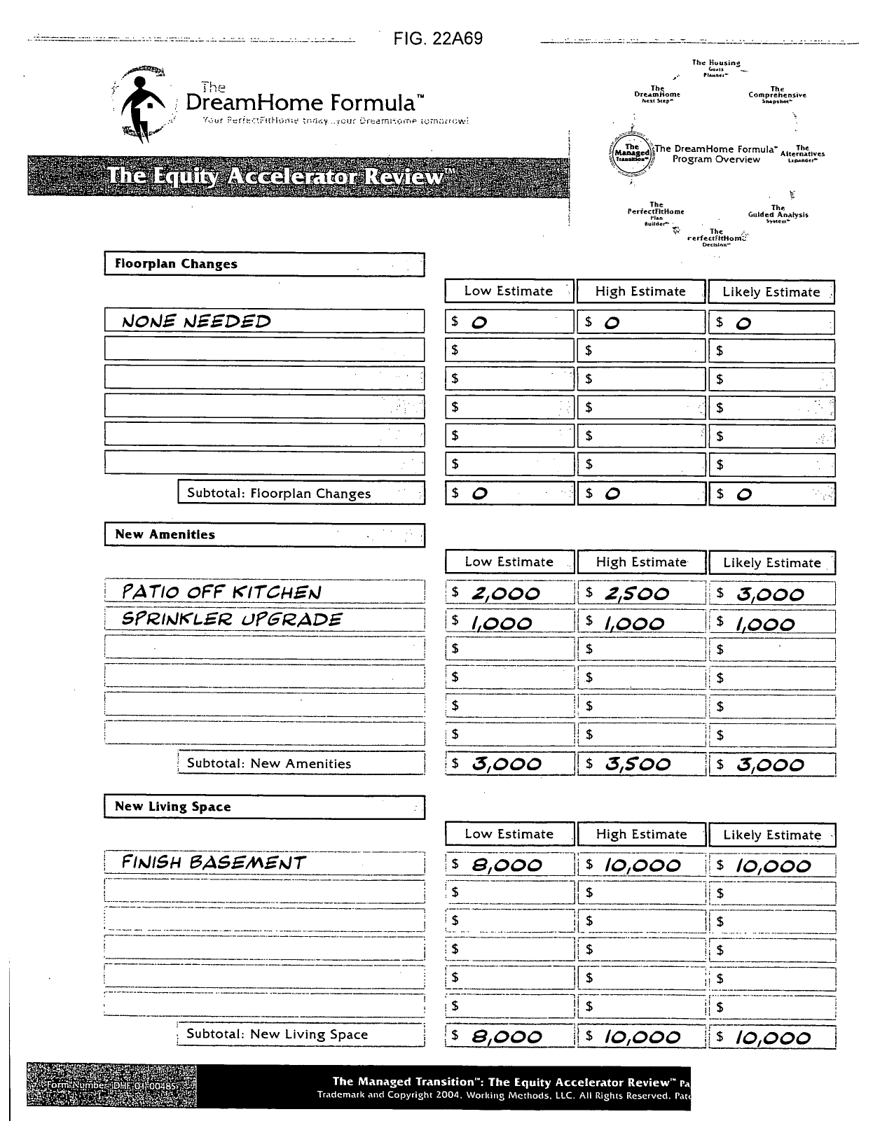

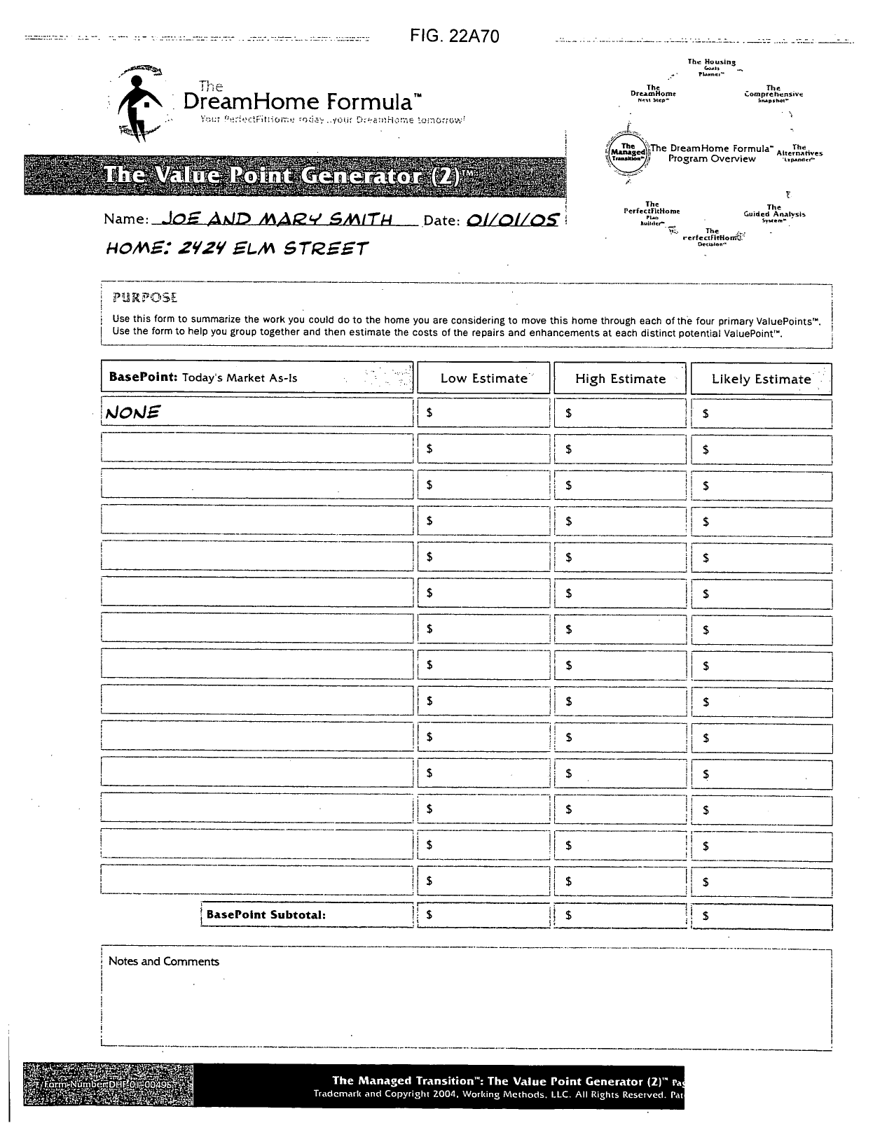

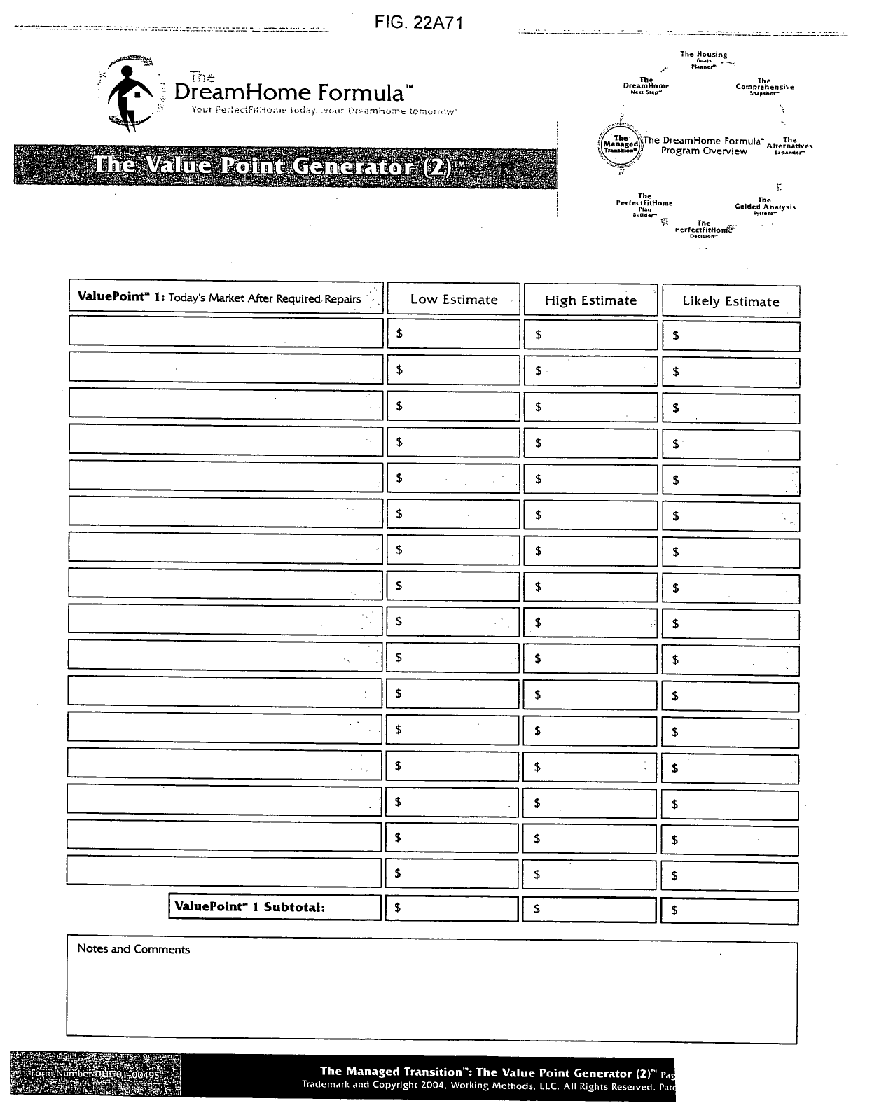

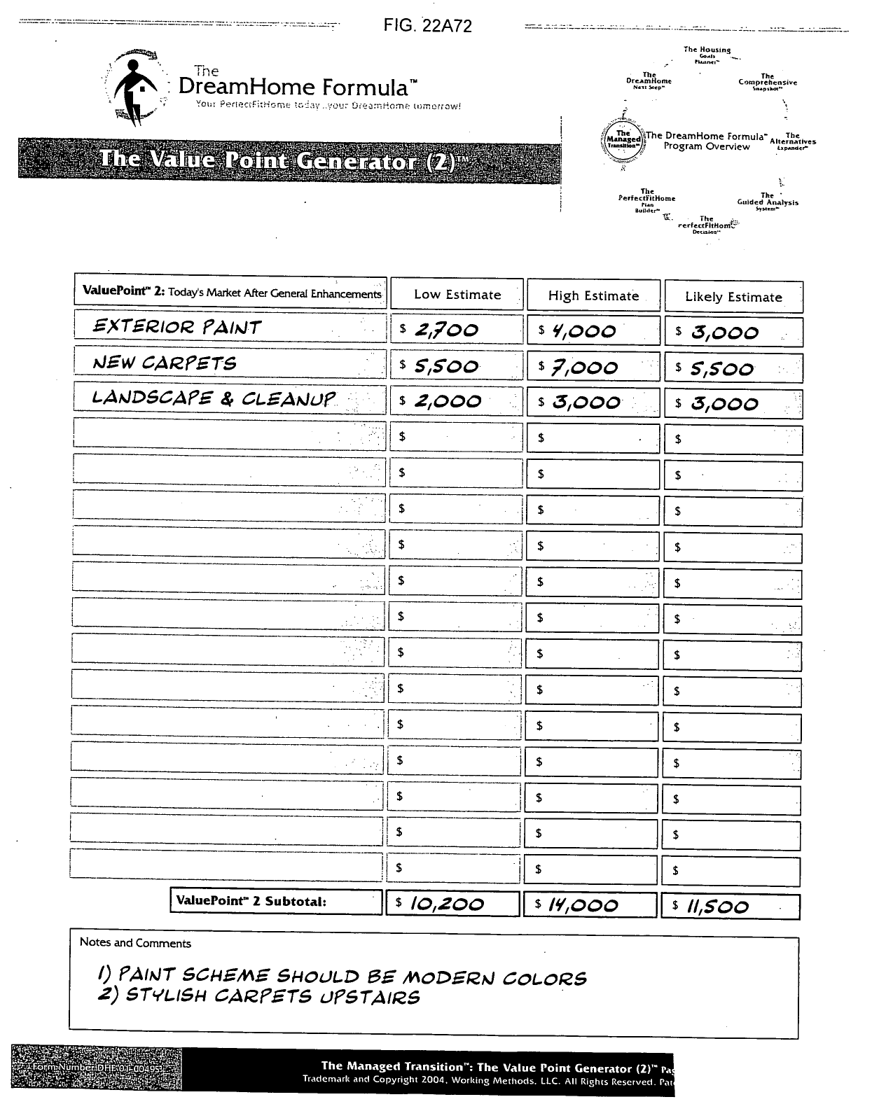

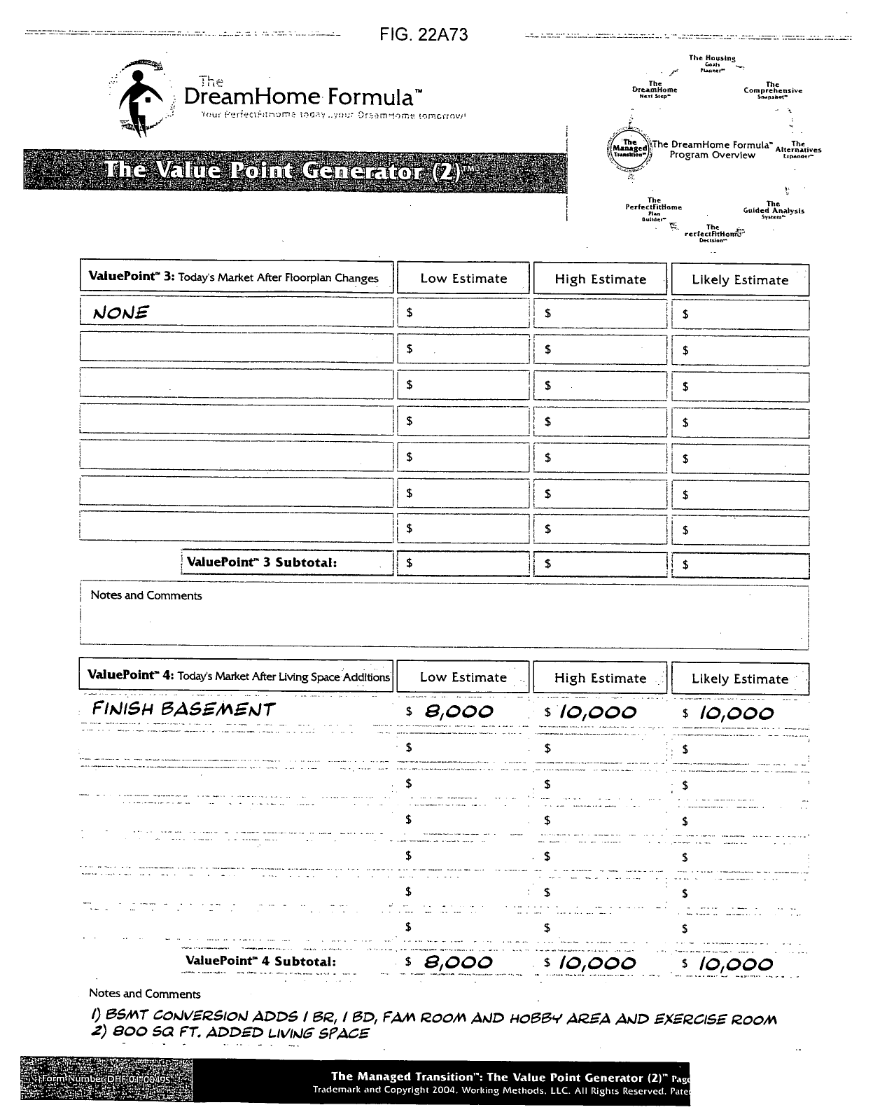

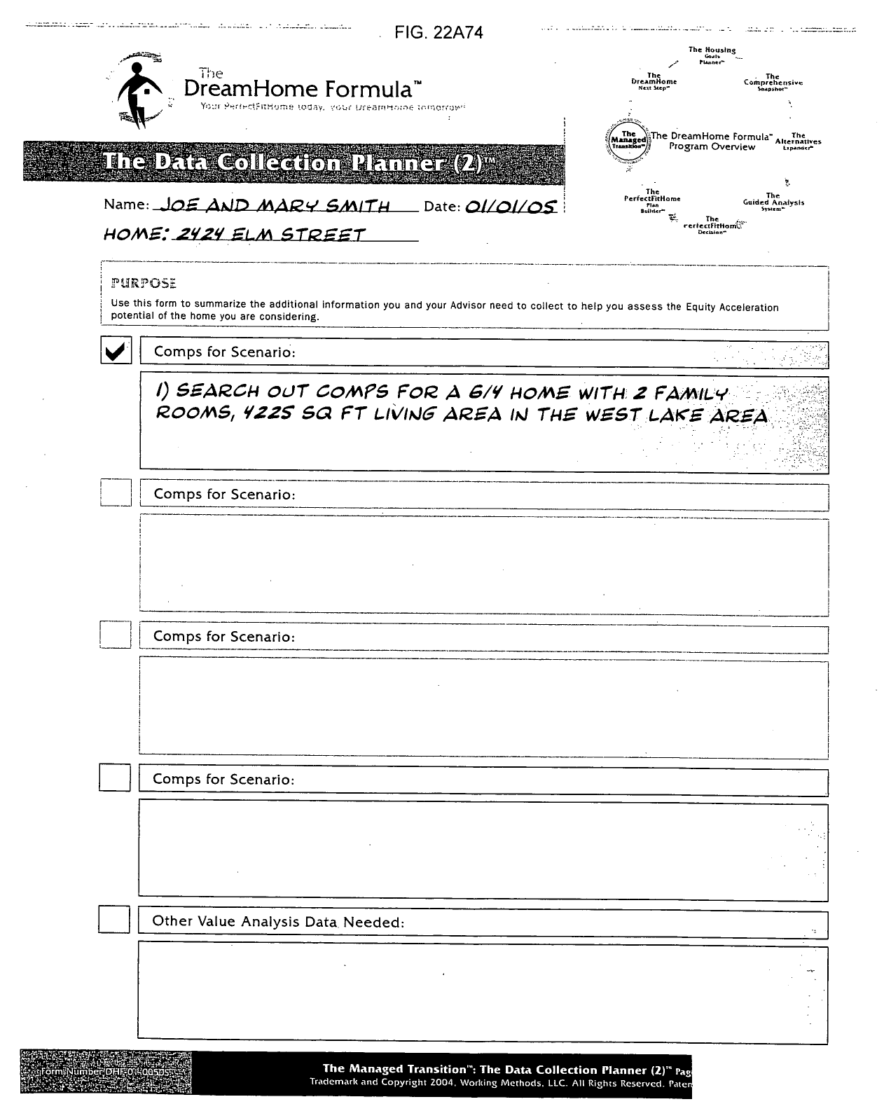

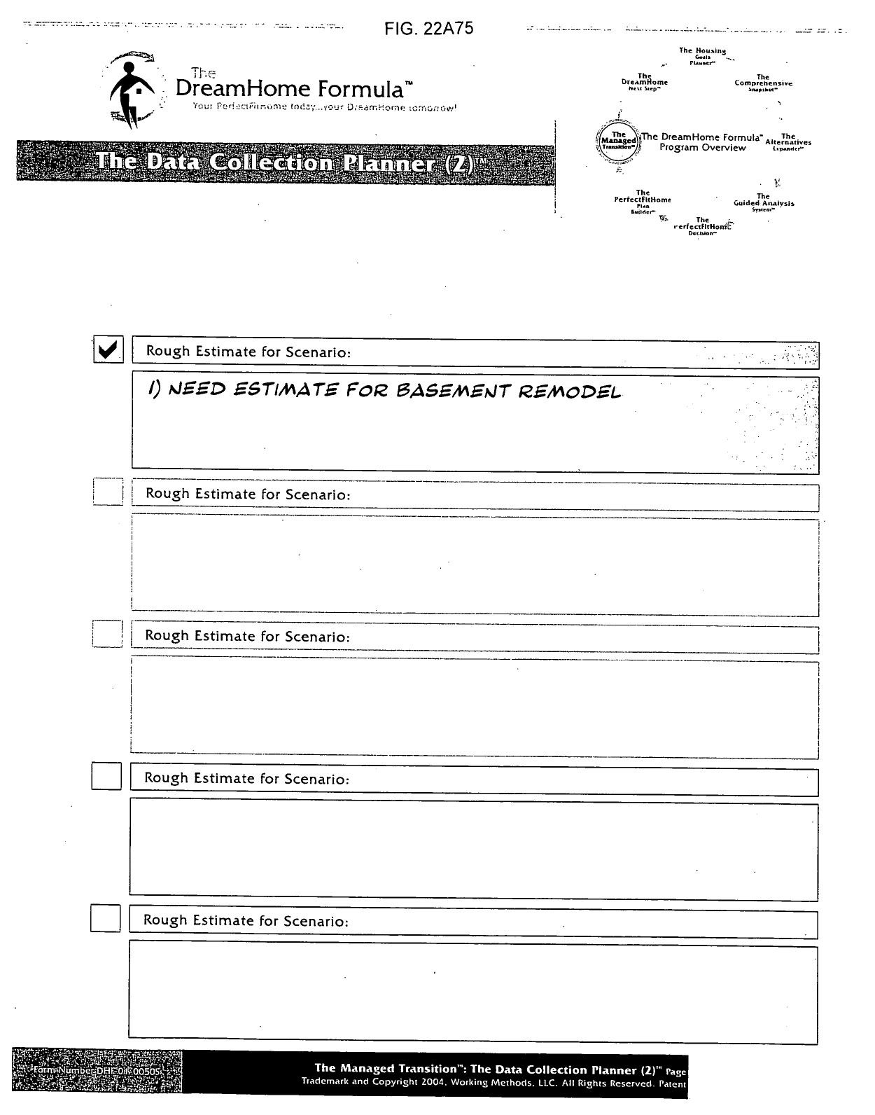

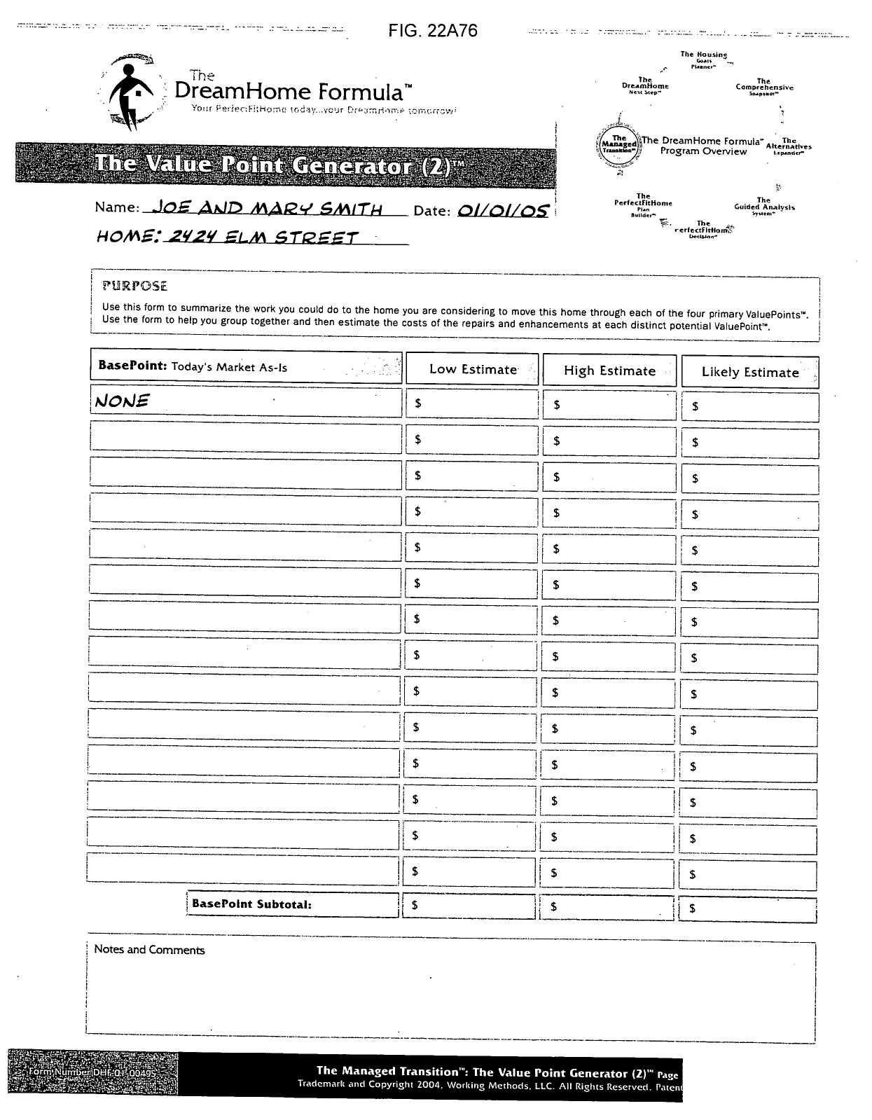

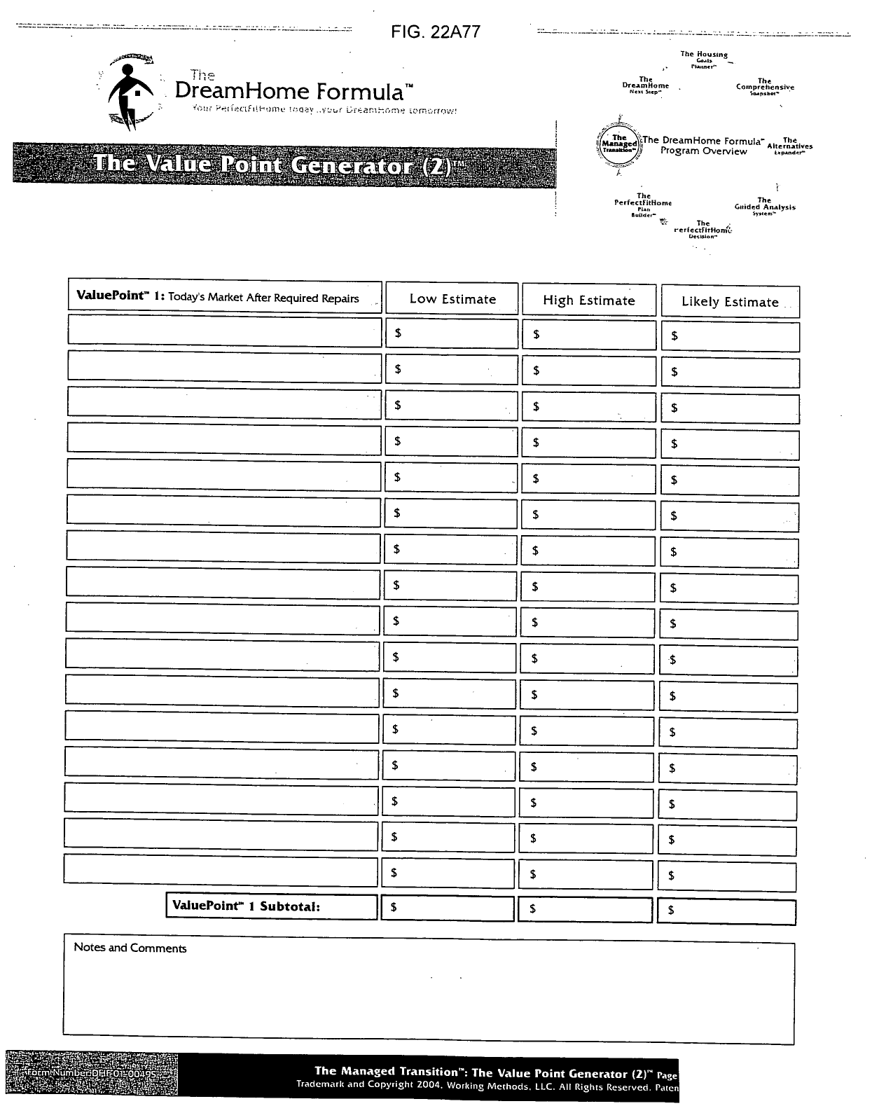

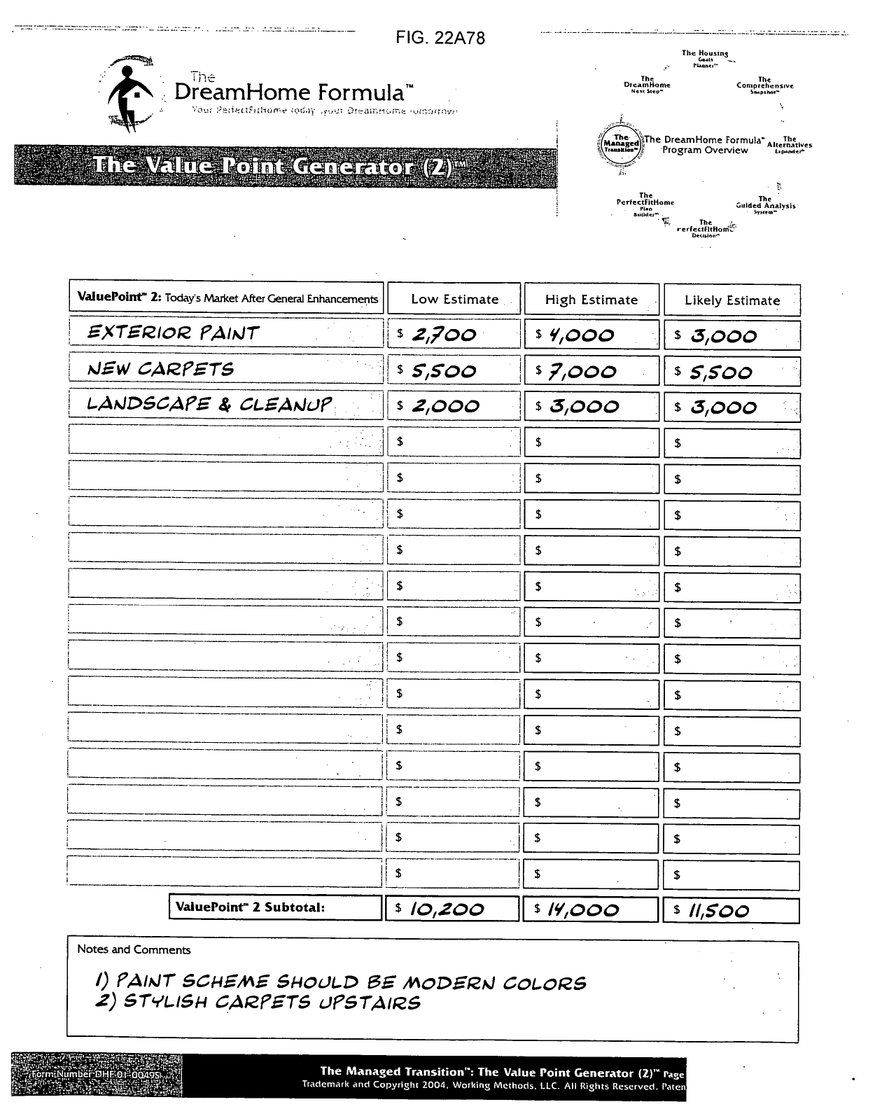

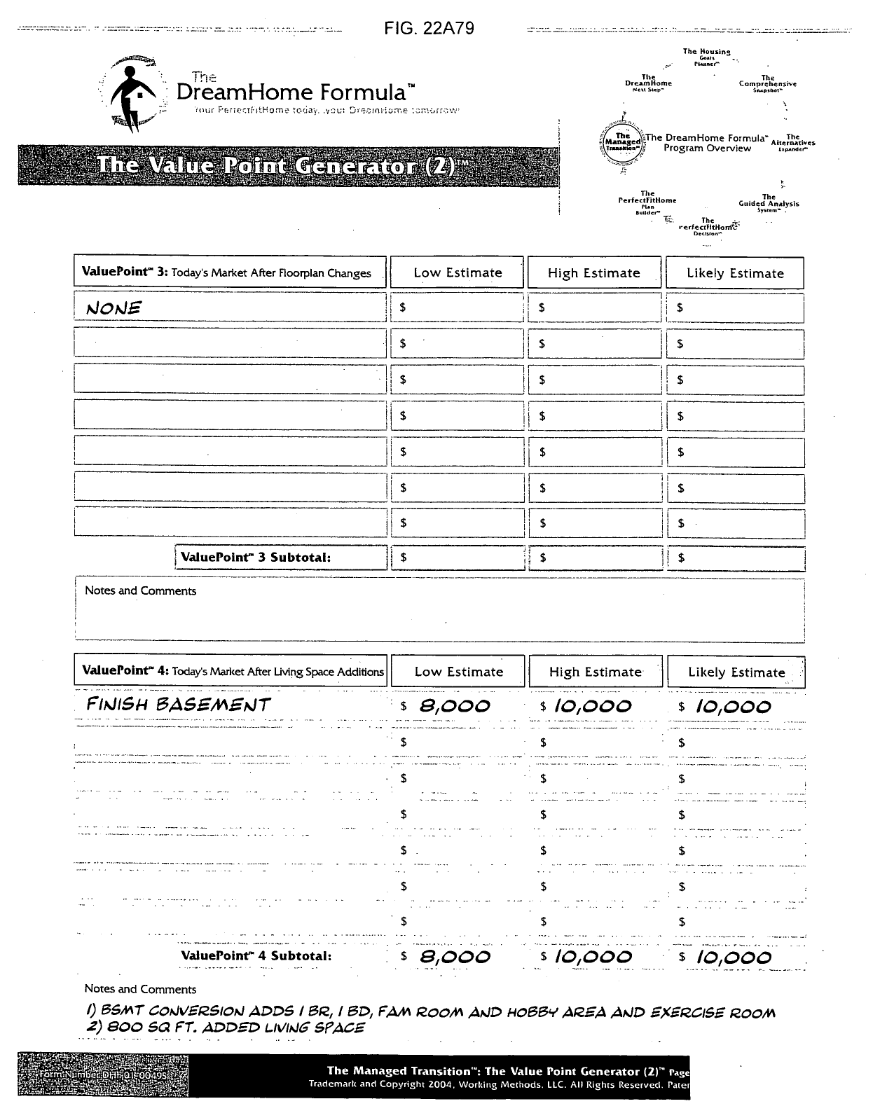

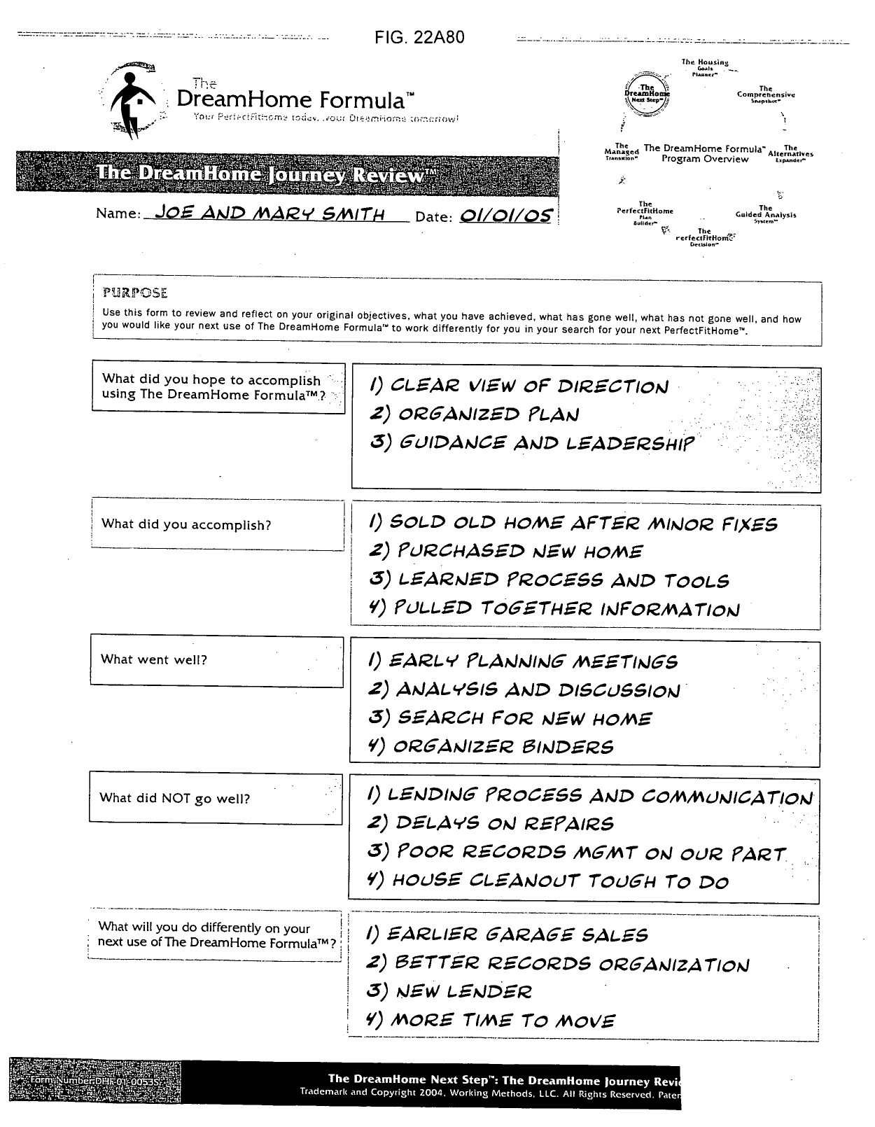

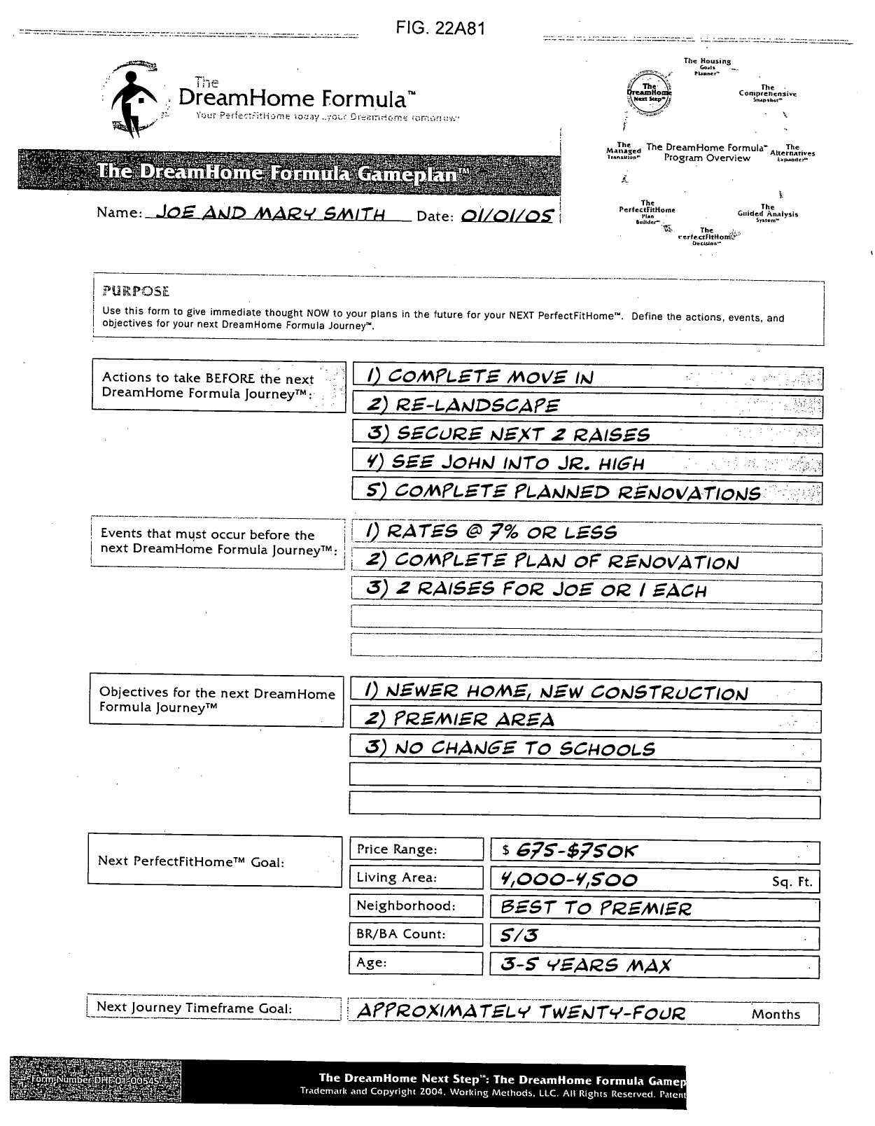

The structured analysis described herein may be performed manually by a person or automatically by a computer. When a person manually performs the structured analysis, input information may be collected and organized, for example, using paper worksheets incorporating any combination of the display images shown in FIGS. 22A1-22A81. The display images are provided for illustration purposes only and do not limit the scope of the structured analysis. Moreover, manual analysis may be performed without worksheets at all, for example a person performing a manual structured analysis may collect and organize the input information using a computer or any other system.

When the structured analysis is performed automatically, a computer may be used. The computer may be configured to automatically perform the structured analysis according to the example of the real estate analyzer 8 described herein. Also, when part of the analysis is performed manually, a computer may be used to perform the remaining portion of the analysis.

When the structured analysis is performed with the assistance of an electronic device, a storage “vault” may be configured for the user. The vault stores all of the information and analyses associated with the particular user. Storage in the vault offers several key advantages. First, regardless of how many users perform the analysis, each user can easily update only his own vault with new information. Thus the user does not have to re-perform every analysis when his life undergoes changes. Second, the vault offers transportability. For example, if the user moves across country away from his real estate advisor, his vault can simply be transferred to a new real estate advisor. Thus, the user saves time providing the new advisor with input information. Third, the vault offers visibility of data and analyses between the user and his advisor. The user can configure full or partial access to the vault allowing the advisor to see only what he needs to see. Moreover, the user can configure access only to total or summary information so that the advisor does not see initial analysis information.

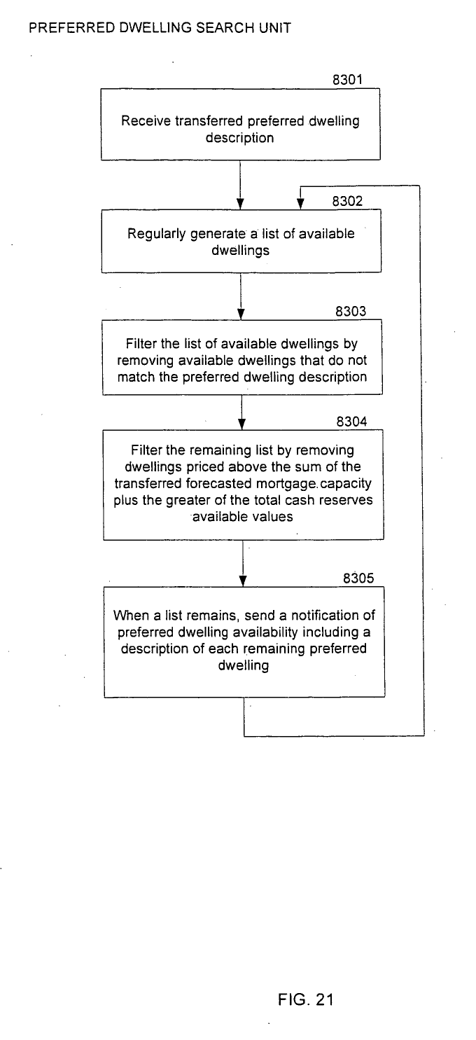

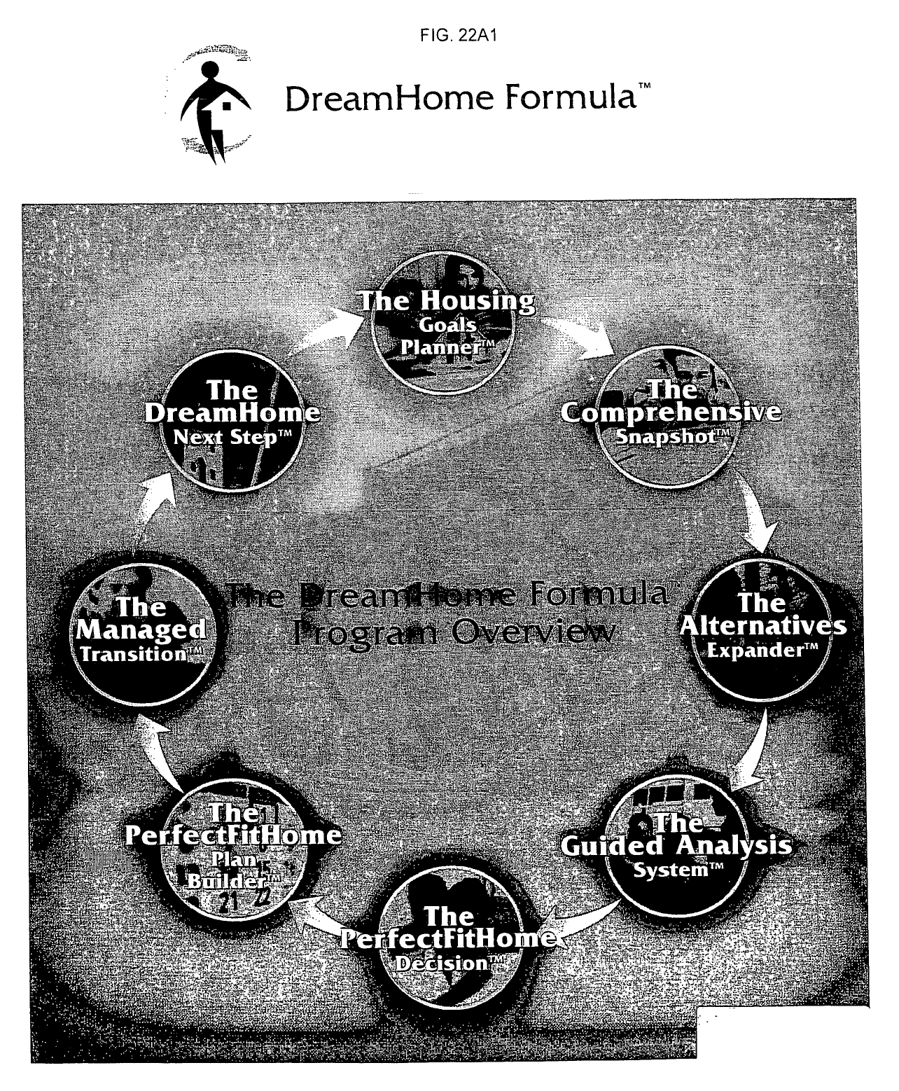

Regardless of what system is used to perform the structured analysis, performance for the benefit of an advisee facilitates an ongoing business relationship between the advisor and the advisee. For example, in contrast with a transactional relationship, here the advisor will have regular business reasons to contact the advisee. As one example, the advisor may regularly perform the functions of the continuous housing consideration unit 71 and the preferred dwelling search unit 83 respectively described with reference to FIGS. 20 and 21. After performing these functions, the advisor will have a business reason to communicate with the advisee, even if that advisee is not actively considering purchasing or selling real estate. These ongoing communications expose the homeowner to better opportunities.

Although the above describes the structured analysis being performed in an advisor-advisee relationship, the analysis may also be performed without the involvement of an advisor. For example, a user may manually perform the analysis for his own benefit, or alternatively use his own computer for automatic analysis.

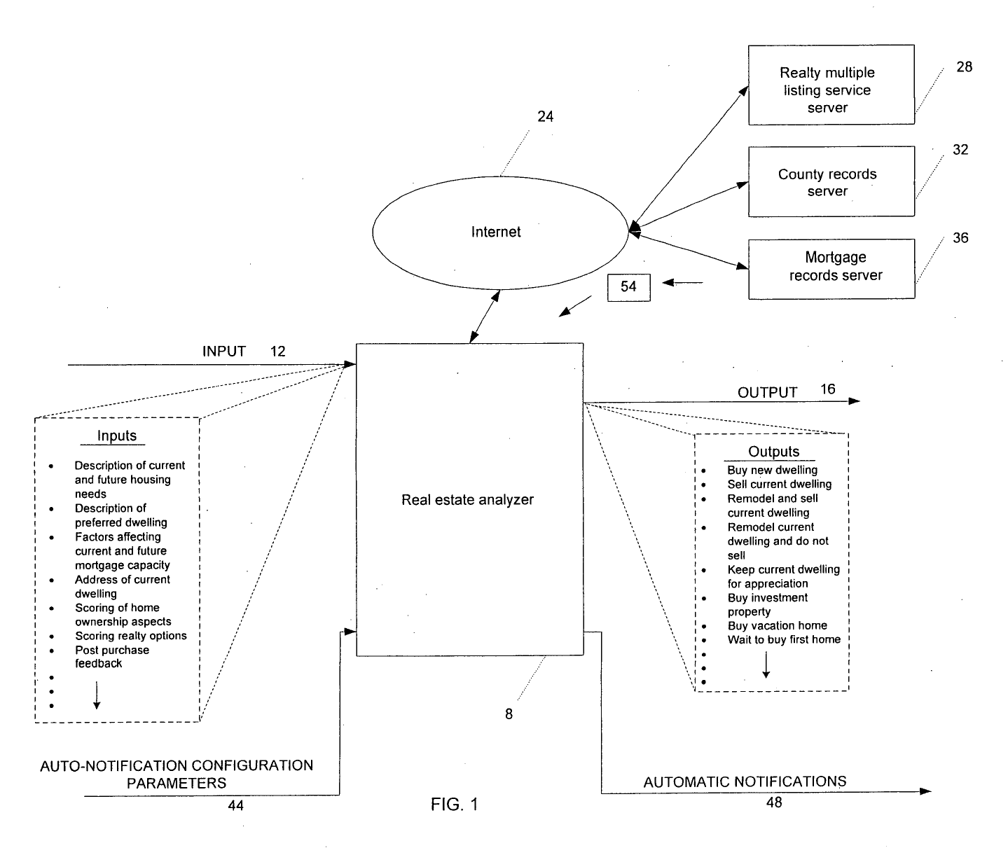

FIG. 1 shows one example of a real estate analyzer 8 that automatically performs a structured analysis to select a preferred real estate option. In one embodiment the analyzer 8 is a personal computer, processor, PDA, cell phone, smart phone, etc. that includes software that operates the analysis described herein.

The real estate analyzer receives inputs 12 and provides outputs 16. The inputs 12 may include user selections, user scorings, user weightings, a current dwelling address for a user, user preferences and user financial information. The outputs 16 may include a preferred realty option and summary displays.

The analyzer 8 may communicate over a network, for example the Internet 24, to gather data 54 from various servers 28, 32 and 36. Gathered data 54 is generally compared to inputs 12 to calculate outputs 16.

The analyzer also may be configured according to auto-notification configuration parameters 44. These parameters 44 may be used to control automatic notifications 48 provided by real estate analyzer.

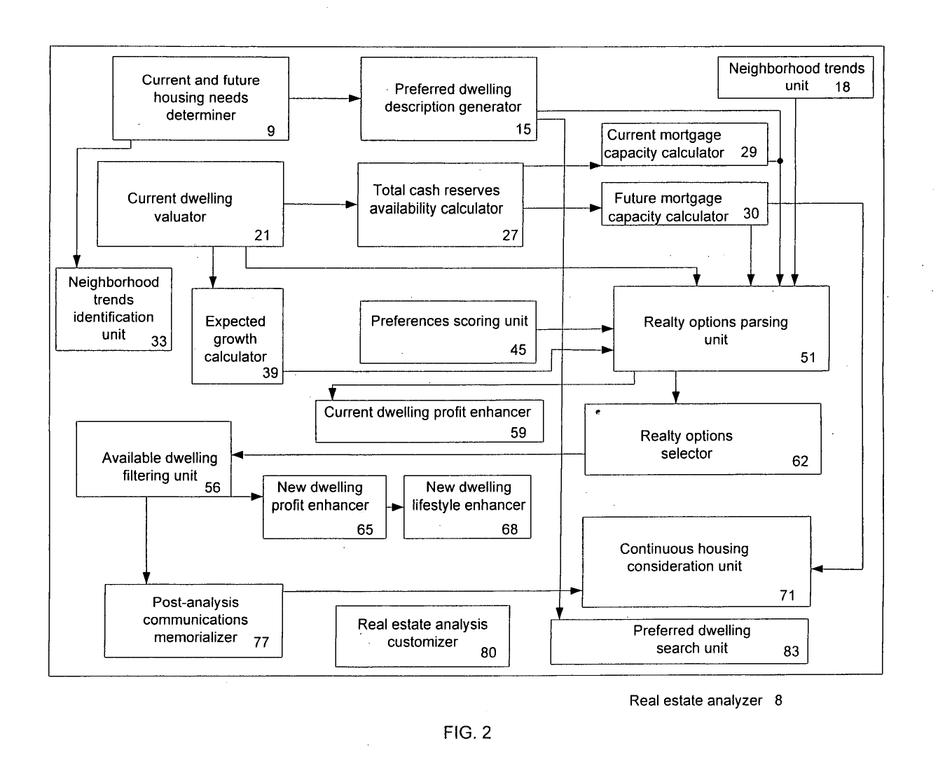

FIG. 2 shows the analyzer 8 in more detail by illustrating several functional blocks connected by arrows. The arrows show a portion of the relationships between different functional blocks, however, for clarity not all relationships are illustrated by the arrows. For example, although it is not shown, the current and future housing needs determiner 9 provides information directly to the available dwelling filtering unit 56. The functions performed by each function block are described with reference to the forgoing figures.

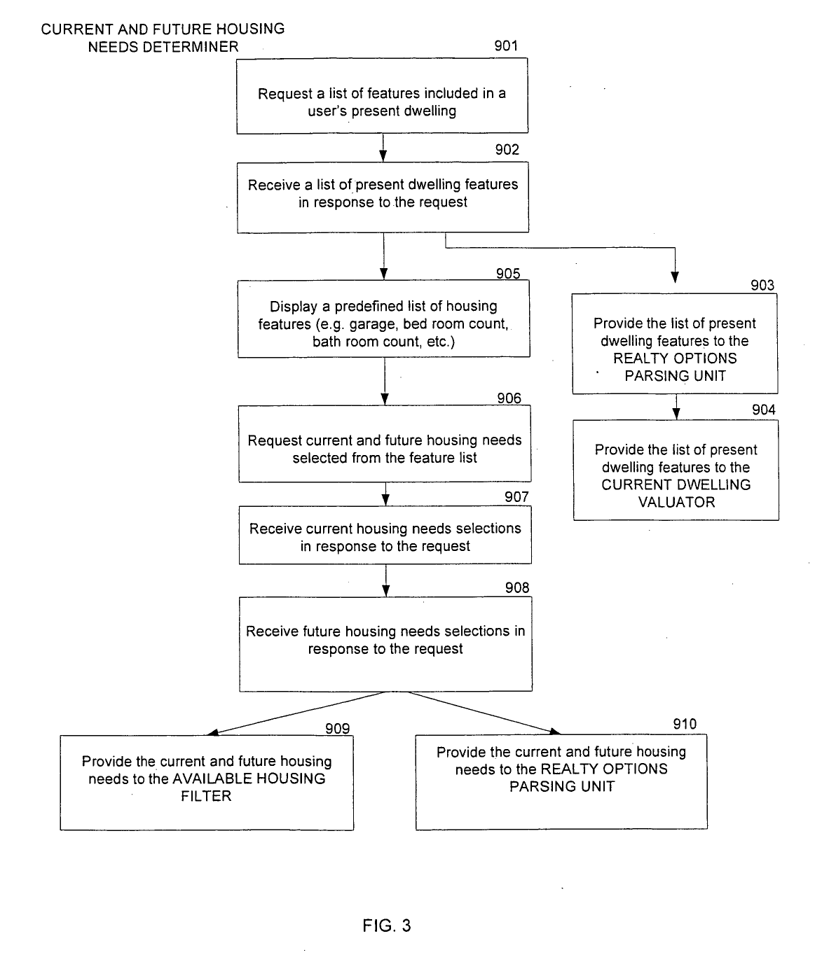

FIG. 3 shows a flowchart of the processes performed by current and future housing needs determiner 9.

The determiner 9 requests a list of features included in a user's present dwelling in block 901. As with all of the analyzer 8 requests described throughout this specification, the request may allow a user to select predefined entries from a table, or the request may allow a user to define his own entries. These entries may, for example, include housing features such as square footage, bathroom and bedroom count. Other examples of housing features are illustrated at least in FIGS. 22A19-22A23 and 22A30. Referring back to FIG. 3, in block 902 the determiner receives a list of present dwelling features in response to the request. In blocks 903 and 904 the list is provided to the realty options parsing unit 51 and the current dwelling valuator 21.

In block 905 a predefined list of all housing features is displayed. The list may be presented on a computer screen, in a notebook or any other media that can be displayed and then entered by the user or real estate advisor. The determiner requests the current and future housing needs of the user in block 906. The housing needs may be provided by selecting from the list, by filling in user-defined fields, or by some combination of selection and filling in fields. Examples of housing needs are provided at least in FIGS. 22A13-22A17. In blocks 907 and 908 the determiner receives current and future housing needs in response to the request. In blocks 909 and 910 the current and future housing needs are provided to the available dwelling filtering unit 56 and the realty options parsing unit 51.

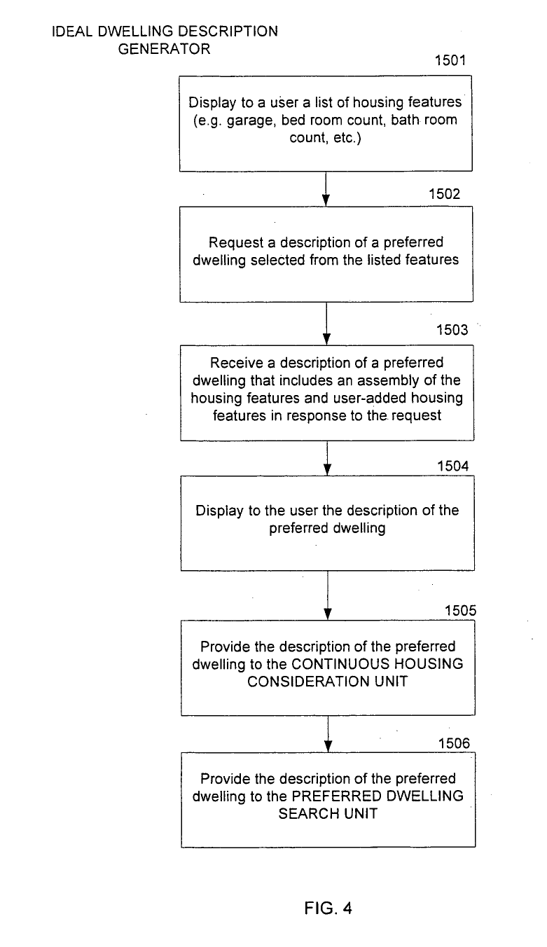

FIG. 4 shows a flowchart of the processes performed by preferred dwelling description generator 15.

In block 1501 the generator 15 displays a predefined list of all housing features. In block 1502 the generator 15 requests a description of a preferred dwelling. The request may include instructions directing a user to select features that they prefer, but do not need. In other words, the instructions direct the user to describe a preferred dream dwelling without consideration of cost. In response the generator receives back a description of a preferred dwelling that may include an assembly of the features and user-added housing features in block 1503.

In block 1504 the description of the preferred dwelling is displayed to the user in any form. One reason for displaying the preferred dwelling description is to provide the user with a concrete goal. Advantageously, the concrete goal may motivate the user to take advantage of all the features offered by the analyzer 8. An example of a preferred dwelling description is provided at least in FIGS. 22A19-22A24. Referring back to FIG. 4, in blocks 1505 and 1506 preferred dwelling description is transferred to the continuous housing consideration unit 71 and the preferred dwelling search unit 83.

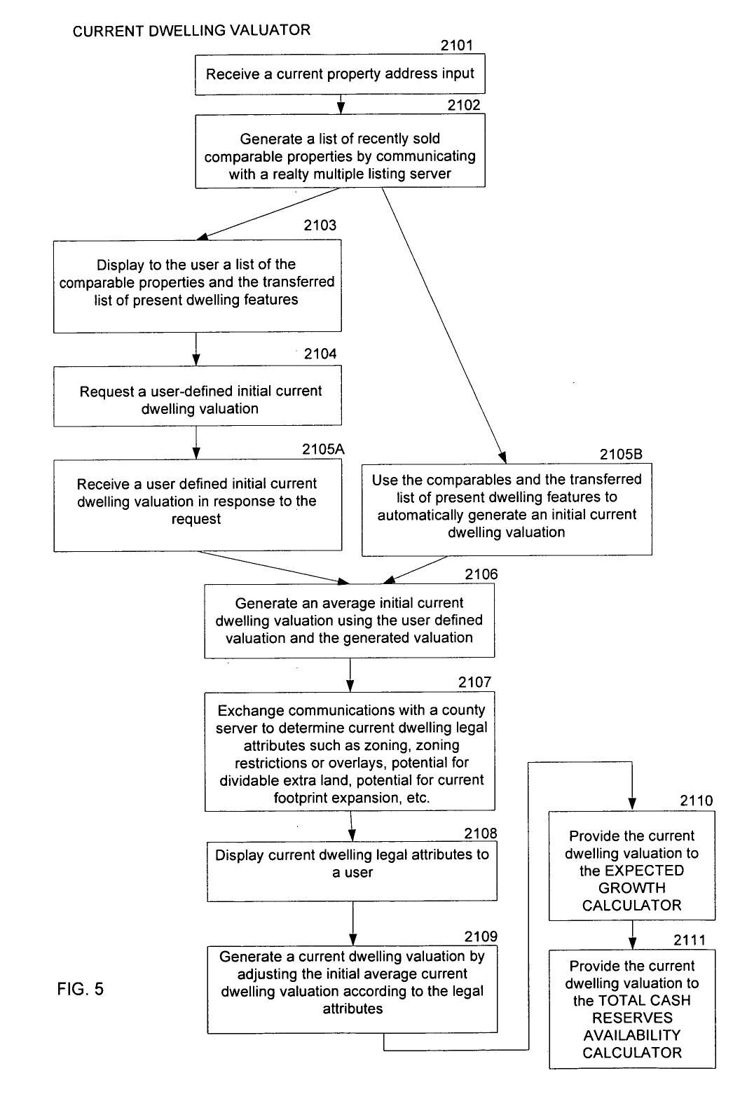

FIG. 5 shows a flowchart of the processes performed by the current dwelling valuator 21.

In block 2101 the valuator 21 receives a current property address input. In block 2102 the valuator 21 exchanges communications with a realty multiple listing service server to generate a list of recently sold comparable properties.

In block 2103 the valuator 21 displays both the list of comparable properties and the transferred list of present dwelling features. In block 2104 the valuator 21 requests a user-defined initial valuation. Next a user-defined initial valuation is received in response to the request in block 2105A.

Allowing a user to define an initial valuation is advantageous for at least several reasons. First, the user-defined initial valuation may be more accurate if it incorporates information about the comparables that has not been provided to the valuator 21. In one example, the user may know that one of the particular comparables sold for lower than market value due to highly motivated sellers. If the user-defined initial valuation compensates for the highly motivated sellers, and the valuator 21 is not provided that information, the user-defined initial valuation may be more accurate. Second, users generally accept a current dwelling valuation more readily when they have participated in the valuation process themselves. Third, the user may have made certain improvements to the dwelling that are exceptional for the neighborhood and affect value more than what would be indicated by the comparables.

In block 2105B the valuator 21 uses the list of comparables and the transferred list of present dwelling features to automatically generate an initial valuation. The initial valuation may be calculated using a variety of methods. According to one method, the valuator 21 first accesses a predetermined list of features that strongly correlate to value. This list may include square footage, bedroom count, bathroom count and yard size. Next the valuator 21 compares the comparables to each other based both on price and features to extrapolate a value-adding estimate for each of the listed features. Then the valuator 21 compares the present dwelling to the comparables based on features to identify a comparable having the most listed features in common with present dwelling. Finally, the valuator 21 determines the value of the present dwelling by adjusting the price of the identified comparable according to the value-adding estimates to account for feature differences. In block 2106 the valuator 21 uses both initial valuations to generate an average initial valuation.

Next, in block 2107 the valuator 21 exchanges communications with a county server to determine current dwelling legal attributes. Examples of current dwelling attributes are shown at least in FIGS. 22A29 and 22A30. In block 2108 the valuator 21 displays the legal attributes to the user. In addition to the legal attributes, the valuator 21 may display explanations of each attribute. In one example, when the user hovers a pointer over a legal attribute a display boxes gives an explanation of how the attribute affects the valuation. Advantageously, through this process the user may gather information about the current dwelling that he was never previously aware of. For example, the user may learn that the add-on room intended for build out in the future is not permitted under current zoning.

In block 2109 the valuator 21 generates a current dwelling valuation by adjusting the initial average current dwelling valuation according to the legal attributes. In other embodiments, the value adjustment may instead be based on any other factors that affect the value of the current property. Information about the additional factors may be provided to the valuator 21 either by the user or by any other source. In blocks 2110 and 2111 the current dwelling valuation is provided to the total cash reserves availability calculator 27 and the expected growth calculator 39.

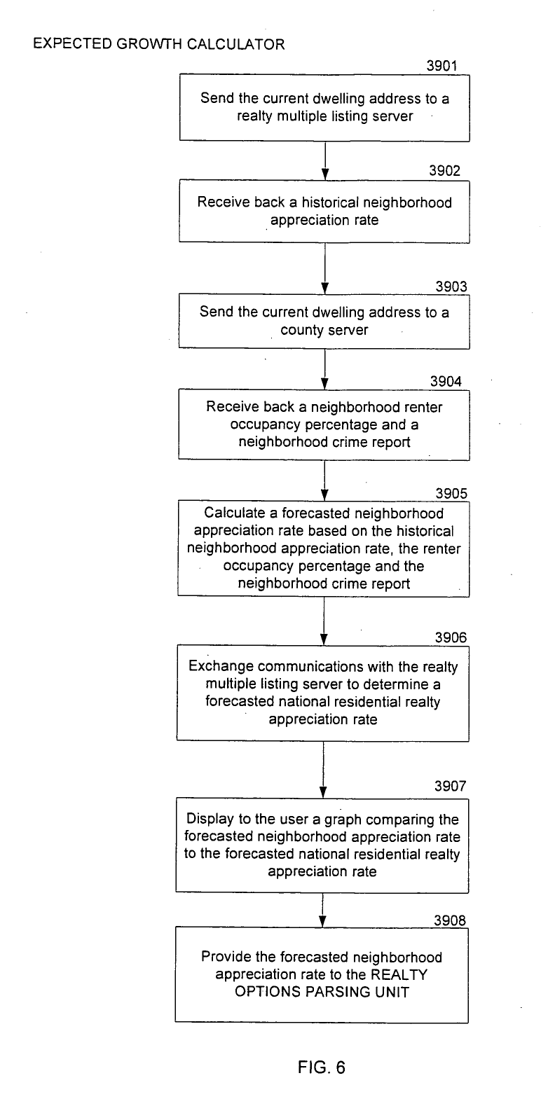

FIG. 6 shows a flowchart of the processes performed by the expected growth calculator 39.

In block 3901 the current dwelling address is sent to a realty multiple listing service server. The calculator 39 receives back a historical neighborhood appreciation rate in block 3902. Alternatively, the calculator may receive back historical comparables data to be used by the calculator 39 to generate a historical neighborhood appreciation rate. In block 3903 the calculator 39 sends the current dwelling address to a county server. In block 3904 the calculator 39 receives back neighborhood information, for example a neighborhood renter occupancy rate and a neighborhood crime report. Other examples of neighborhood information are provided at least in FIGS. 22A41 and 22A42. Any other available information that affects a forecasted neighborhood or dwelling appreciation rate may also be collected.

Next, in block 3905 a forecasted neighborhood appreciation rate is calculated based on the historical neighborhood appreciation rate and the neighborhood information. Any other available information may also be used when forecasting a neighborhood appreciation rate.

In block 3906 the calculator 39 exchanges communications with the realty multiple listing service server or any other server to determine a forecasted national residential realty appreciation rate. In block 3907 the calculator 39 displays a graph comparing the forecasted neighborhood appreciation rate to the forecasted national residential realty appreciation rate. In block 3908 the forecasted neighborhood appreciation rate is provided to the realty options parsing unit 51.

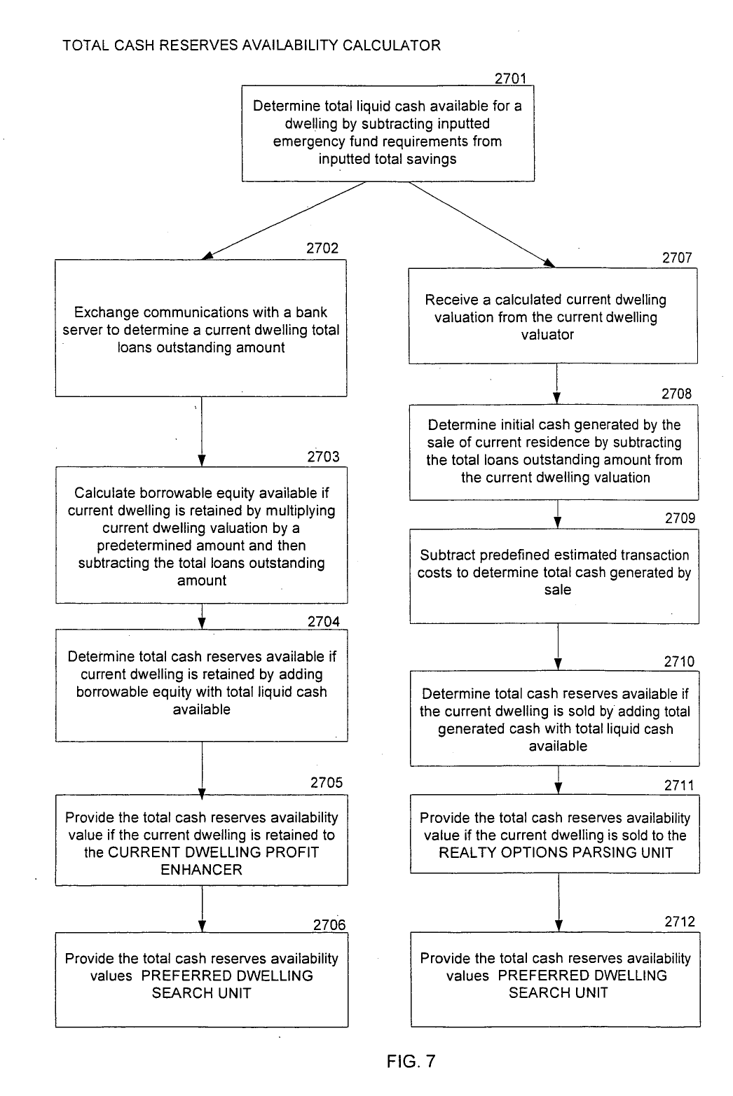

FIG. 7 shows a flowchart of the processes performed by the total cash reserves availability calculator 27.

In block 2701 the calculator determines total liquid cash available for a dwelling by subtracting emergency fund requirements from total savings. An example of this calculation is provided in FIG. 22A38.

Next, the process continues toward determining total cash reserves available when the current dwelling is retained. In block 2702 the calculator 27 exchanges communications, for example, with a bank server to determine a current dwelling total loans outstanding amount. In block 2703 borrowable equity when retaining the current dwelling is calculated by multiplying a transferred current dwelling valuation by a predetermined amount and then subtracting the total loans outstanding amount. In one example, the predetermined rate is 90%, which represents a conservative maximum debt load that lenders will generally allow. The predetermined rate could of course be set to any number and values of 80% or 100% may be advantageous for certain users. Next, in block 2704 total cash reserves available when retaining current dwelling is calculated by adding borrowable equity and total liquid cash available. A similar example of the preceding process is shown in FIG. 22A38. Referring back to FIG. 7, in blocks 2705 and 2706 the total cash reserves available value is provided to the current dwelling profit enhancer 59 and the preferred dwelling search unit 83.

The process also continues toward determining total cash reserves available when the current dwelling is sold. In block 2707 a current dwelling valuation is provided to the calculator 27. The calculator 27 determines how much initial cash is generated by a sale by subtracting the current dwelling total loans outstanding amount in block 2708. In block 2709 the total cash generated by a after a sale is calculated by deducting a predetermined amount of sales transaction costs. In block 2710 the calculator 27 determines total cash reserves available when the current dwelling is sold by adding the total cash generated with the total liquid cash available. In blocks 2711 and 2712 the total cash reserves available when the current dwelling is sold is provided to the realty options parsing unit 51 and the preferred dwelling search unit 83.

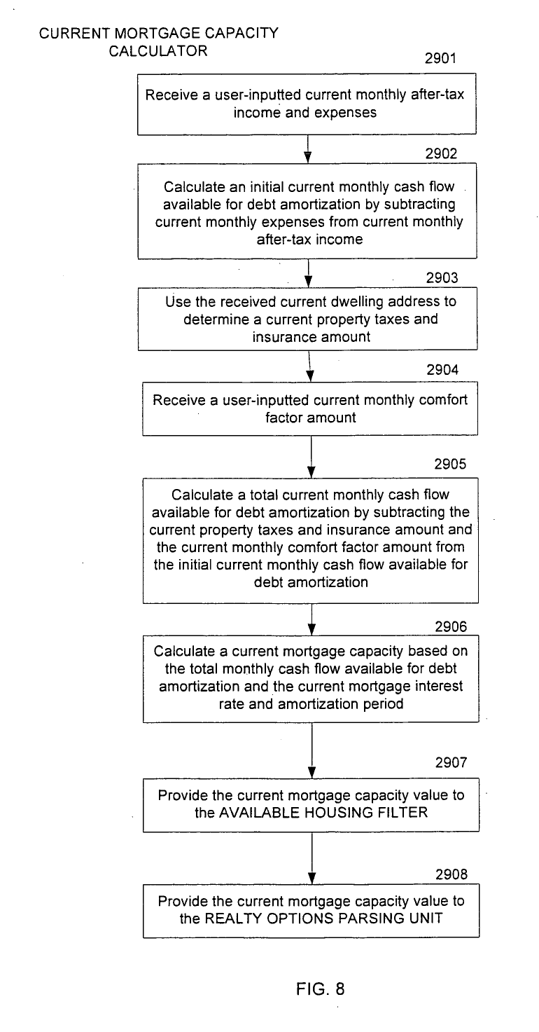

FIG. 8 shows a flowchart of the processes performed by the current mortgage capacity calculator 29.

In block 2901 the calculator 29 receives an inputted current monthly after-tax income and expenses. As shown in FIGS. 22A27 and 22A28, a preconfigured list of common monthly expenses may be displayed to the user to improve the accuracy of the inputted current monthly expenses value. Referring back to FIG. 8, in block 2902 the calculator determines an initial current monthly cash flow available for debt amortization by subtracting the current monthly expenses from the current monthly after-tax income. In block 2903 the calculator 29 determines a current property tax and insurance amount. These amounts may be provided by a user, or alternatively, may be determined by exchanging communications with a county server. In block 2904 the calculator receives a user-inputted monthly comfort factor amount.

In block 2905 the calculator 29 determines a total current monthly cash flow available for debt amortization by subtracting both the amount of the current property taxes and insurance and the amount of the current monthly comfort factor from the initial current monthly cash flow available for debt amortization. In block 2906 a current mortgage capacity is calculated based on the current mortgage interest rate, the current amortization period and the total current monthly cash flow available for debt amortization. In blocks 2907 and 2908 the total current monthly cash flow available for debt amortization is provided to the realty options parsing unit 51 and the available housing filter 56.

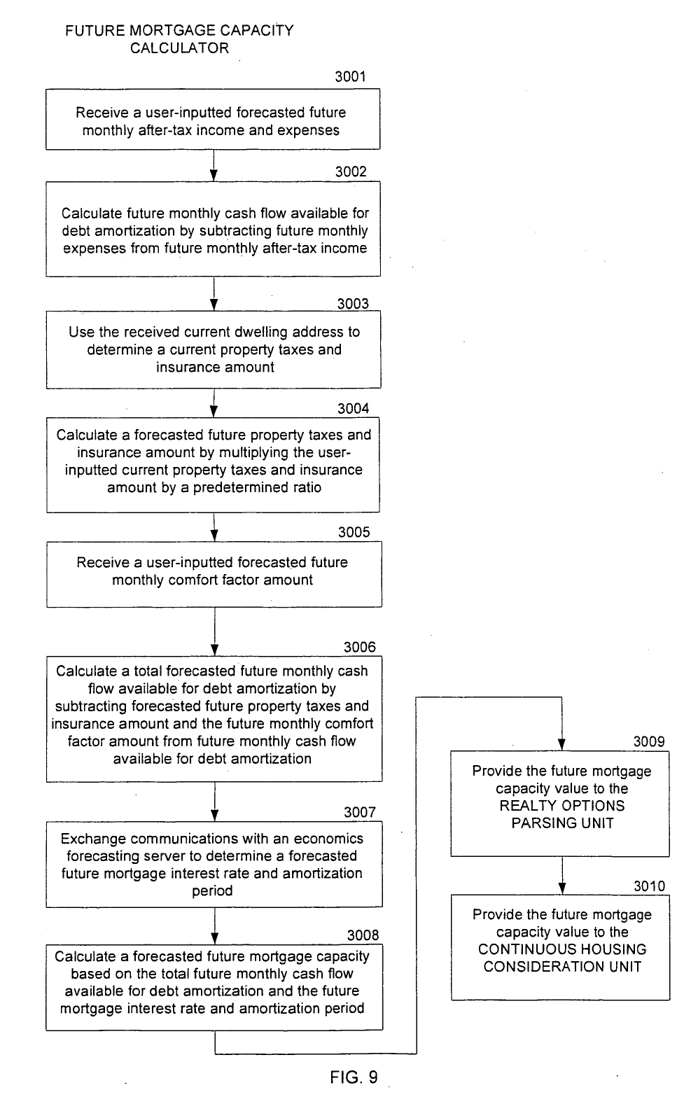

FIG. 9 shows a flowchart of the processes performed by the future mortgage capacity calculator 30.

In block 3001 the calculator 30 receives an inputted forecasted monthly after-tax income and expenses. As shown in FIGS. 22A27 and 22A28, a preconfigured list of common monthly expenses may be provided to the user to improve the accuracy of the inputted future monthly expenses value. Referring back to FIG. 9, in block 3002 the calculator determines an initial future monthly cash flow available for debt amortization by subtracting the current monthly expenses from the current monthly after-tax income. In block 3003 the calculator 30 determines a current property tax and insurance amount. These amounts may be provided by a user, or alternatively, may be determined by exchanging communications with a county server. In block 3004 the calculator 30 forecasts a future property taxes and insurance amount my multiply the current property tax and insurance amount by a predetermined ratio. In block 3005 the calculator receives a user-inputted forecasted comfort factor amount.

In block 3006 the calculator 30 determines a total future monthly cash flow available for debt amortization by subtracting both the amount of the forecasted property taxes and insurance and the amount of the forecasted monthly comfort factor from the initial future monthly cash flow available for debt amortization. In block 3007 the calculator 30 determines a forecasted future mortgage interest rate and amortization period by, for example, exchanging communications with an economics-forecasting server. In block 3008 a future mortgage capacity is calculated based on the forecasted mortgage interest rate, the forecasted amortization period and the total future monthly cash flow available for debt amortization. In blocks 3009 and 3010 the future mortgage capacity is provided to the realty options parsing unit 51 and the continuous housing consideration unit 71.

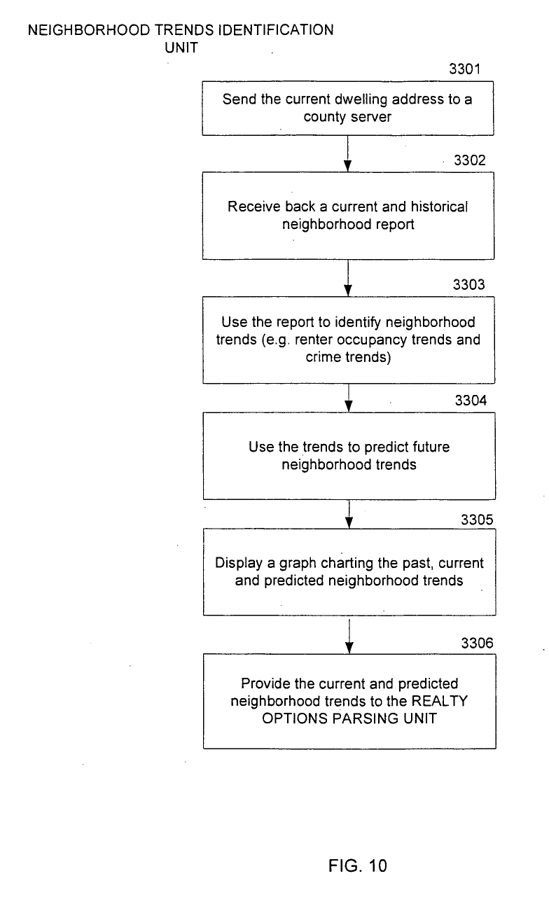

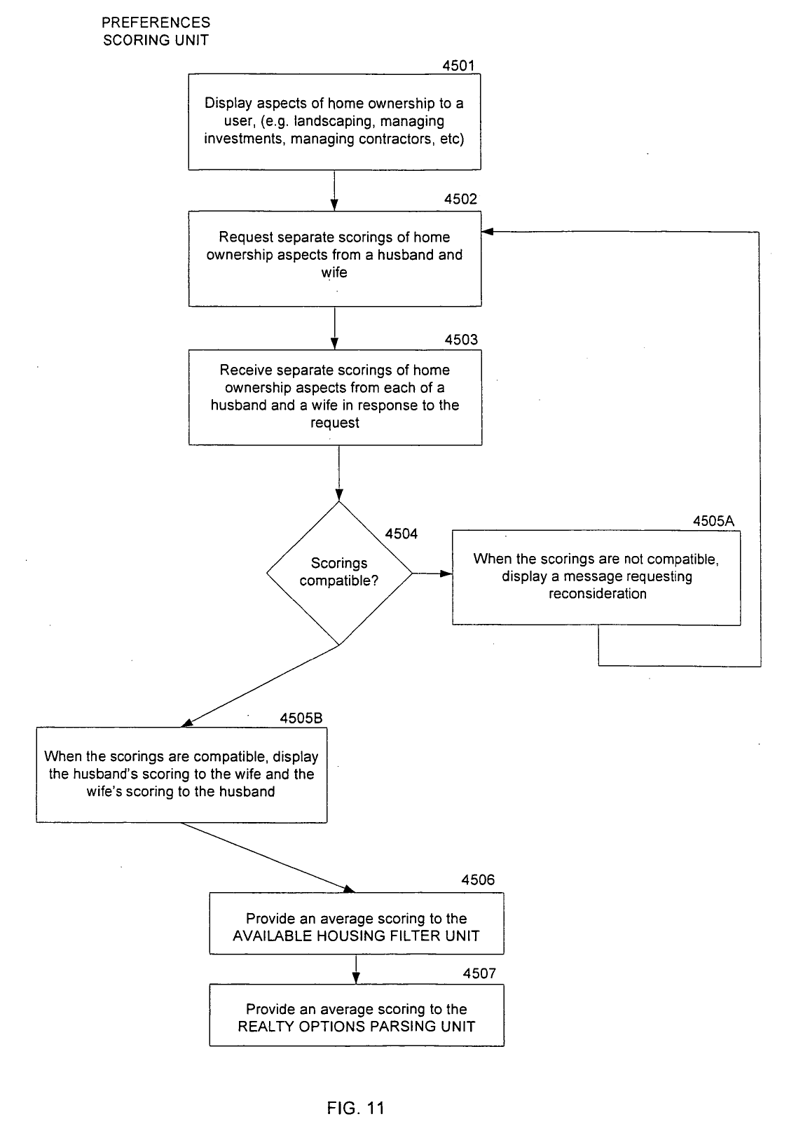

FIG. 10 shows a flowchart of the processes performed by the neighborhood trends identification unit 33.

In block 3301 the unit 33 sends the current dwelling address to a county server. In block 3302 the unit 33 receives back current and historical neighborhood information that may include a neighborhood renter occupancy rate and neighborhood crime report. Other examples of neighborhood information are provided at least in FIGS. 22A41 and 22A42.

Referring back to FIG. 10, in block 3303 the unit 33 uses the current and historical neighborhood information to identify neighborhood trends, for example, crime and occupancy trends. In block 3304 the neighborhood trends are used to predict future neighborhood trends. In block 3305 a graph is displayed to the user illustrating the past, current and predicted neighborhood trends. In block 3306 the current and predicted neighborhood trends are provided to the realty options parsing unit 51.

FIG. 11 shows a flowchart of the processes performed by the preferences scoring unit 45.

In block 4501 the unit 45 displays several aspects of home ownership to a user. Examples of aspects of home ownership are provided at least in FIGS. 22A25 and 22A26 and may include each of the categories of home ownership perspectives, home ownership topics, financial topics and real estate/construction topics. In block 4502 the unit 45 requests separate scorings of home ownership aspects from a husband and a wife. The unit 45 receives back separate scorings in response to the request in block 4503. FIGS. 22A26 and 22A27 show one example whereby circles and squares are used to delineate the different scorings.

Next the unit 45 compares the different scorings to determine whether the scorings are compatible in decision box 4504. In one embodiment, the unit 45 is configured to determine incompatibility when any of the homeownership aspects scorings have numerical difference of four or more. In other examples, the unit is configured to determine incompatibility only when the scorings have smaller numerical differences. When the scoring is not compatible in block 4505B, the unit 45 displays a message indicating scoring incompatibility and returns to block 4502.

When the scoring is compatible in block 4505A, the unit 45 displays the husband's scoring to the wife and the wife's scoring to the husband. In blocks 4506 and 4507 an average scoring is provided to the realty options parsing unit 51 and the available housing filter unit 56.

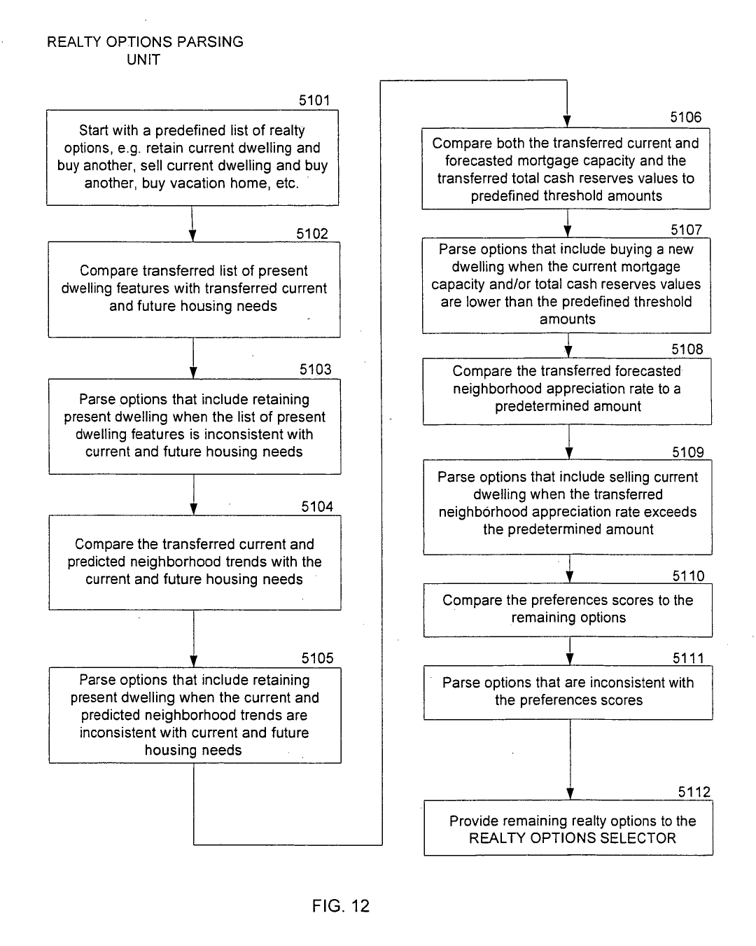

FIG. 12 shows a flowchart of the processes performed by the realty options parsing unit 51.

The unit 51 starts with a predefined list of realty options in block 5101. The predefined list includes all conceivable combination of realty options. For example, the predefined list may include retaining a current dwelling and buying a new house, selling a current dwelling and buying a new house, improving and keeping a current dwelling, improving and selling a current dwelling, buying an investment home, buying a vacation home, buying a first home, etc. More examples of realty options are provided in at least FIGS. 22A55 and 22A56.

In block 5102 the unit 51 compares the transferred list of present dwelling features with the transferred current and future housing needs. When the list of present dwelling features is inconsistent with the current and future housing needs, the unit 51 parses realty options that include retaining the present dwelling in block 5103. Instead of parsing, in some embodiments the unit 51 may be configured to deemphasize the realty options including retaining the present dwelling. In yet other embodiments the unit 51 may instead lower a ranking score of realty options that include retaining a present dwelling.

In block 5104 the unit 51 compares the transferred current and predicted neighborhood trends with the current and future housing needs. When either the current or predicted neighborhood trends are inconsistent with the current and future housing needs, the unit 51 parses realty options that include retaining the present dwelling in block 5105. In other embodiments the unit 51 may deemphasize or lower a ranking of realty options that include retaining a current dwelling.

In block 5106 the unit 51 compares the transferred current mortgage capacity, the transferred future mortgage capacity and the transferred total cash reserves values to a predetermined thresholds. When the transferred values are lower than the predetermined thresholds, the unit 51 parses realty options that include buying a new dwelling in block 5107. The unit 51 may be configured to parse only when any predefined combination of the mortgage capacity and cash reserves values are lower than a predefined combination threshold. In yet other embodiments, the predefined threshold is set according to the current and future housing needs.

In block 5108 the unit compares the transferred forecasted neighborhood appreciation rate to a predetermined amount. When the transferred rate is lower than the predetermined amount, in block 5109 the unit 51 parses realty options that include selling a current dwelling.

In block 5110 the unit 51 compares the transferred preferences scores to the remaining realty options. When any of the remaining options are inconsistent with the preferences scores, the unit 51 parses the inconsistent option(s) in block 5111. In block 5112 the remaining realty options are provided to the realty options selector 62.

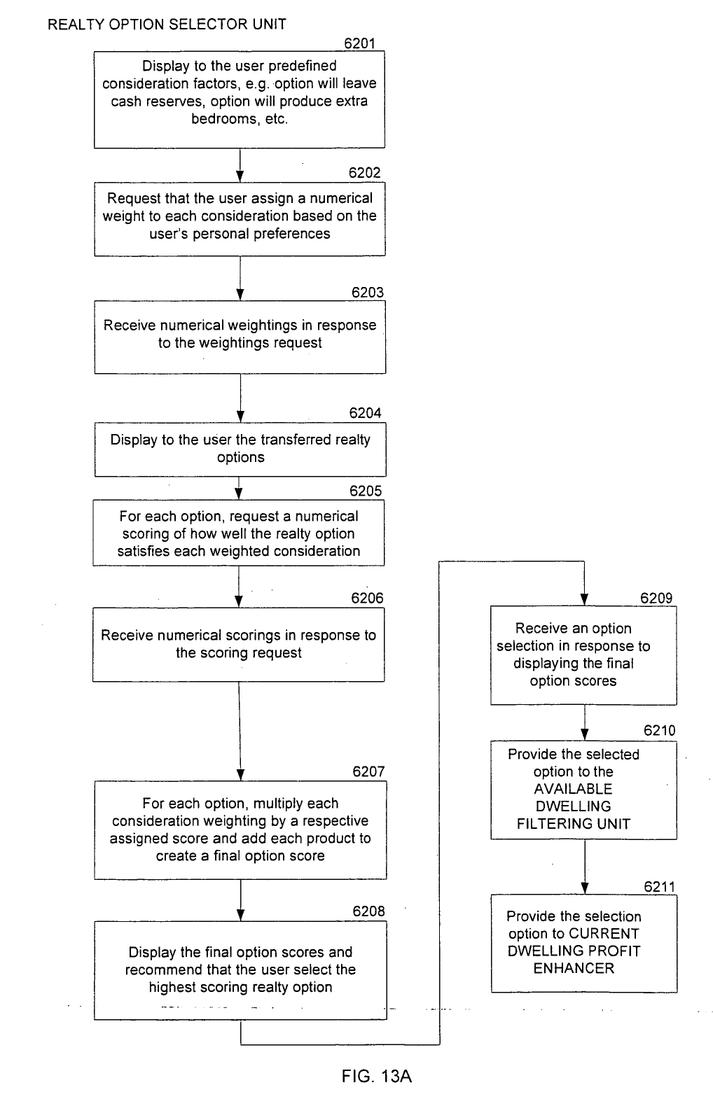

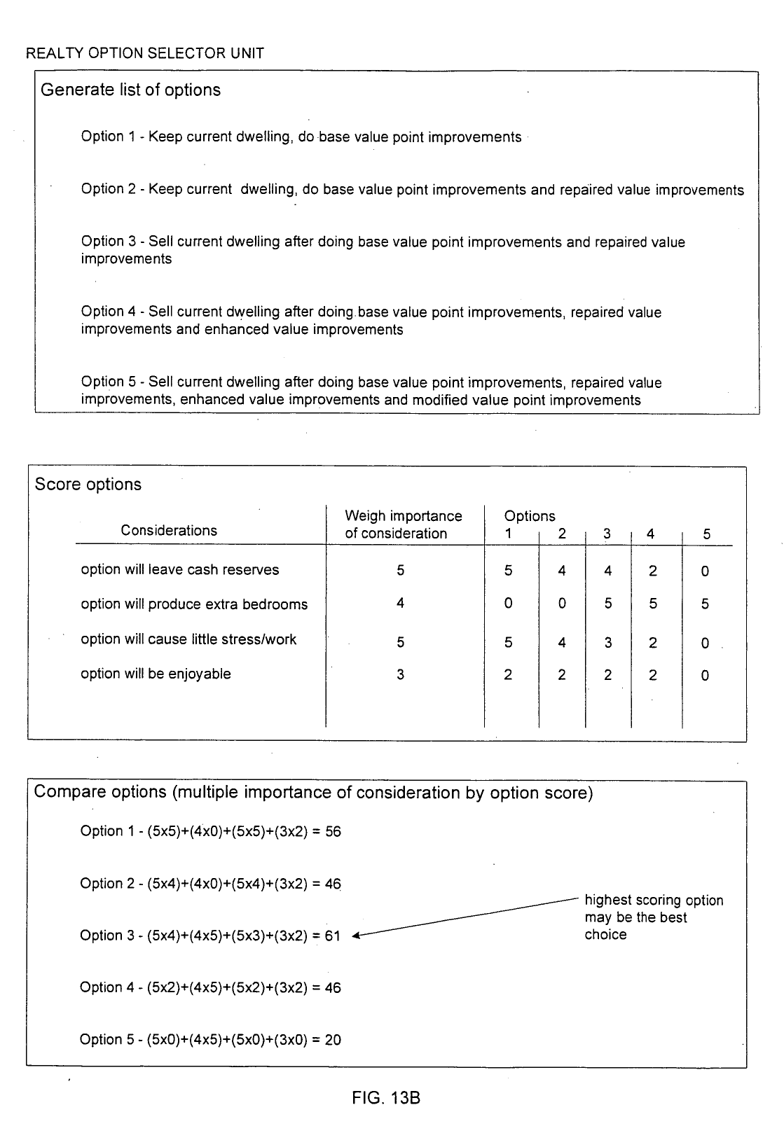

FIG. 13A shows a flowchart of the processes performed by the realty options selector 62.

In block 6201 the unit 62 displays predefined consideration factors. Examples of the consideration factors are shown in at least FIGS. 22A57 and 22A58. Referring back to FIG. 13A, In some embodiments, the predefined factors may overlap with the features displayed by the current and future housing needs determiner 9 allowing the overlapping factors to be twice considered. In block 6202 the unit 62 requests assignment of numerical weightings to each predefined factor based on the user's personal preferences. In block 6203 numerical weightings are received in response to the weighting request.

In block 6204 the unit 62 displays the transferred remaining realty options. In block 6205 for each remaining realty option the unit 62 requests a numerical scoring indicating how the option satisfies each weighted consideration. In block 6206 the unit 62 receives numerical scorings in response to the request.

In block 6207, for each option the unit 62 multiplies each consideration weighting by a respective assigned score and then adds each product to create a final score for that option. An example computation is illustrated in FIG. 13B. In other embodiments, varied processes may be used to compute the final option score. For example, in some embodiments the weighted considerations are added to the respective assigned scores. In other embodiments, only a predetermined percentage of each consideration weighting is multiplied with a respective assigned score.

Referring back to FIG. 13A, next the final option scores are displayed along with a selection request in block 6208. The selection request may include instructions recommending selection of the highest scoring option. In some embodiments, the instructions are displayed when a mouse pointer is hovered over a final option score. In block 6209 an option selection is received in request to the selection request. In blocks 6210 and 6211 the selected realty option is transferred to the available dwelling filtering unit 56 and the current dwelling profit enhancer 59.

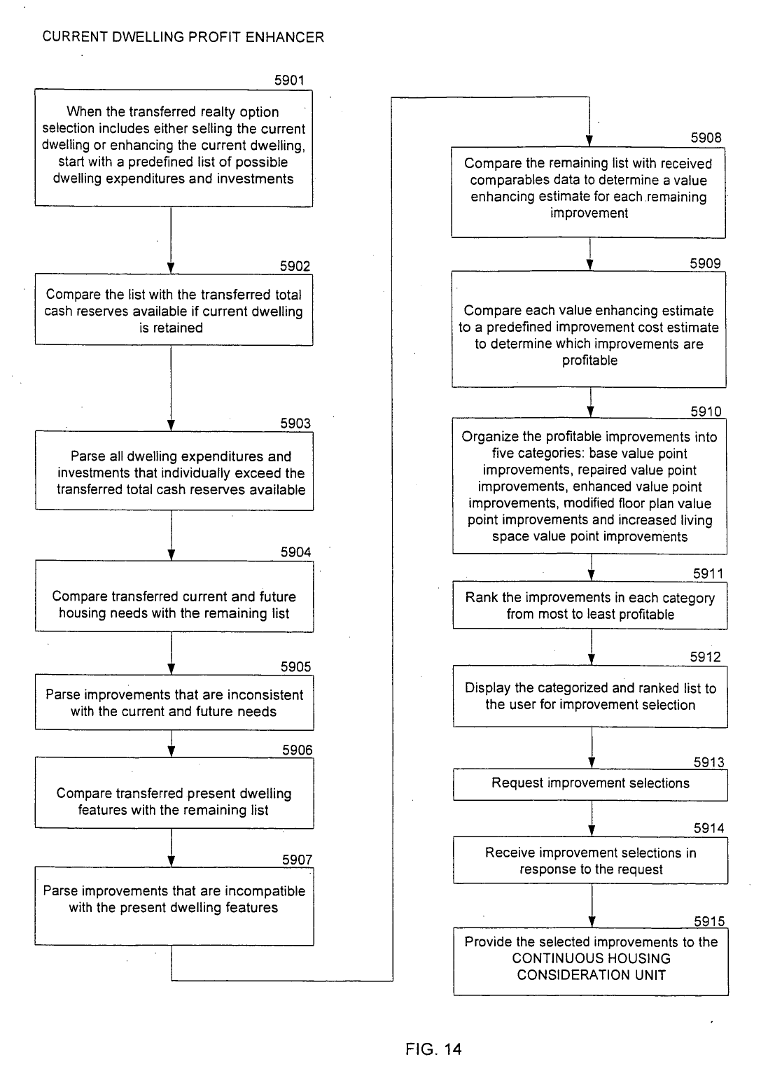

FIG. 14 shows a flowchart of the processes performed by the current dwelling profit enhancer 59.

When the transferred selected realty option includes either selling the current dwelling or enhancing the current dwelling, in block 5901 the profit enhancer 59 starts with a predefined list of all possible dwelling expenditures and investments. Examples of some of the improvements that may be included on the list are shown in at least FIGS. 22A45-22A49. Referring back to FIG. 14, in block 5902 the enhancer 59 compares the list to the transferred total cash reserves available when the current dwelling is retained. In block 5903 the enhancer 59 parses from the list all dwelling expenditures and investments that individually exceed the transferred total cash reserves value.

In block 5904 the enhancer 59 compares the transferred current and future housing needs to the remaining list. Next, the improvements that are inconsistent with the current and future needs are parsed in block 5905.

In block 5906 the enhancer 59 compares the transferred current dwelling features description to the remaining list. Next the improvements that are incompatible with the current dwelling features are parsed in block 5907. For example, an improvement to a basement is parsed when the current dwelling features do not include a basement.

In block 5908 the enhancer 59 compares the remaining list to received comparables data to determine a value-enhancing estimate for each remaining improvement. In block 5909 the enhancer 59 compares each value-enhancing estimate to a predefined improvement cost to determine which improvements are profitable improvements. In block 5910 the enhancer 59 organizes the profitable improvements into categories including: base value point improvements, repaired value point improvements, enhanced value point improvements, modified floor plan value point improvements and increased living space value point improvements. Next the enhancer 59 ranks the improvements within each category from most profitable to least profitable in block 5911. Alternatively, instead of ranking each improvement the enhancer 59 may determine a total improvement profitability for each category as shown in FIG. 22A54.

Referring back to FIG. 14, in block 5912 the organized and ranked list is displayed and in block 5913 the enhancer 59 requests improvement selections from the user. The organization of the list generally decreases the time needed for the user to make improvement selections. For example, the user may want to quickly rule out improvements that require extended work, such as modified floor plan value point improvements and increased living space value point improvements. Next, in block 5914 selected improvements are received in response to the request. The selected improvements are provided to the continuous housing consideration unit 71 in block 5915.

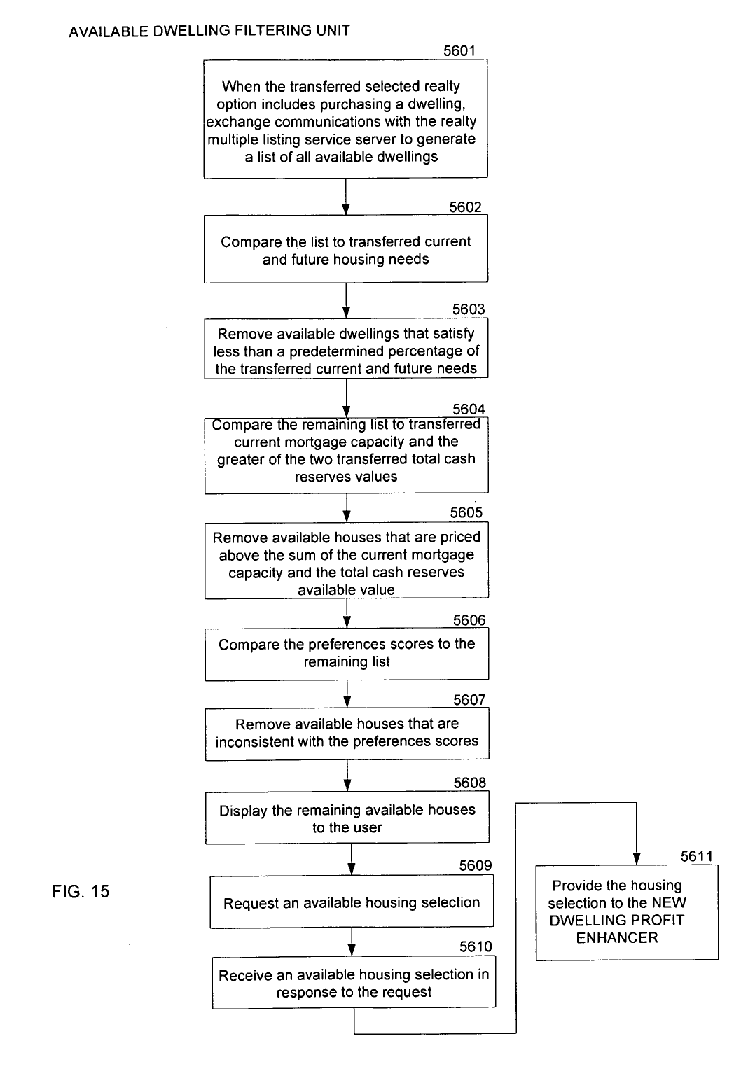

FIG. 15 shows a flowchart of the processes performed by the available dwelling-filtering unit 56.

When the transferred selected realty option includes purchasing a dwelling, in block 5601 the unit 56 generates a list of all available dwellings by exchanging communications with a realty multiple listing service server. In block 5602 the unit 56 compares the list to transferred current and future housing needs. Next, the unit 56 removes from the list available dwellings that satisfy less than a predetermined amount of the current and future housing needs in block 5603.

In block 5604 the unit 56 compares the remaining list to the transferred current mortgage capacity and one of the transferred total cash reserves values. When the transferred selected realty option includes retaining the current dwelling, the unit 56 uses the total cash reserves available when the current dwelling is sold. When the transferred selected realty option includes selling the current dwelling, the unit 56 uses the total cash reserves available when the current dwelling is retained. In block 5605 available houses that are priced above the sum of the current mortgage capacity and the relevant total cash reserves available value are removed from the list.

In block 5606 the unit 56 compares the transferred preferences scores to the remaining list. In block 5607 the unit 56 removes available houses that are inconsistent with the preferences scores. In other embodiments, only houses that are inconsistent with a predetermined ratio of the preferences scores are removed. In other embodiments, inconsistent houses are instead de-emphasized or ranked lower in score. Next, in block 5608 the remaining list is displayed to the user. In block 5609 the unit 56 requests an available housing selection and in block 5610 an available housing selection is received in response to the request. In block 5611 the housing selection is provided to the new dwelling profit enhancer 65.

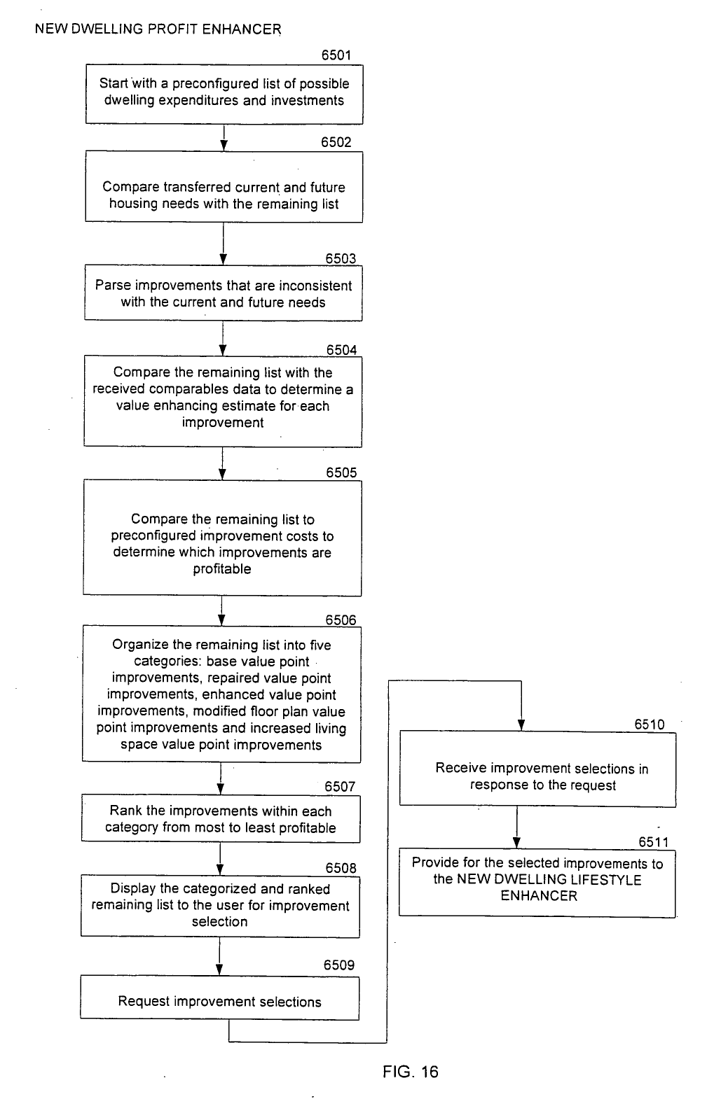

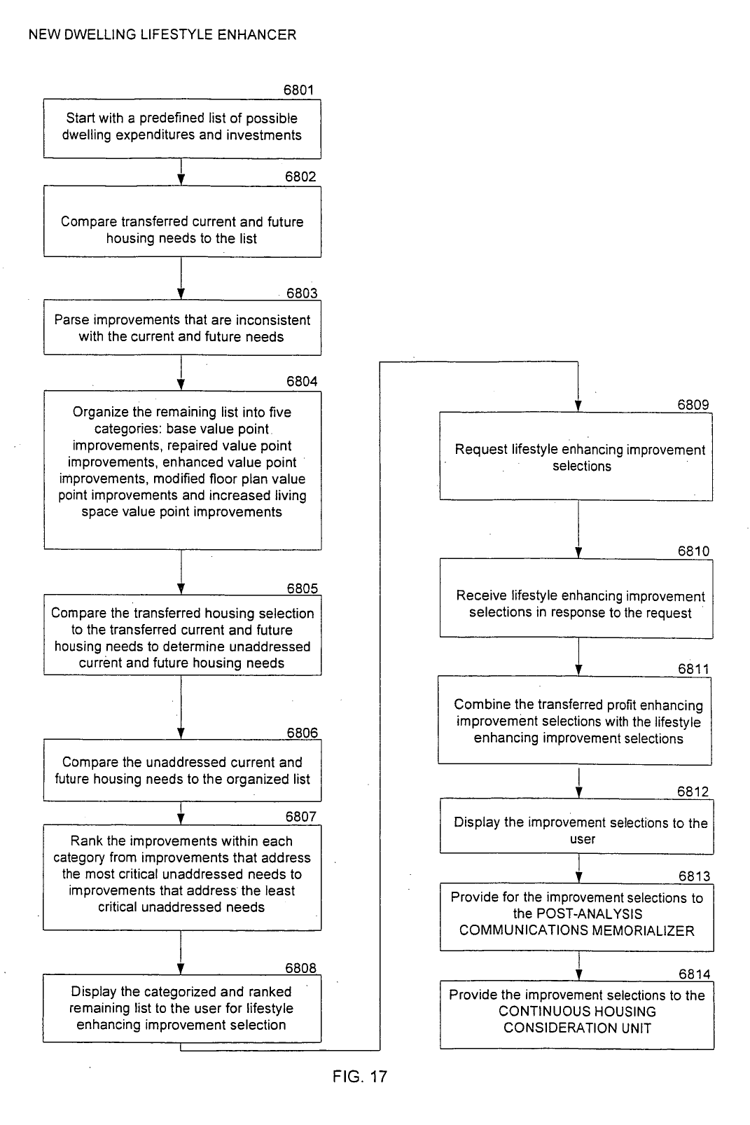

FIG. 16 shows a flowchart of the processes performed by the new dwelling profit enhancer 65.

In block 6501 the profit enhancer 65 starts with a predefined list of all possible dwelling expenditures and investments. Examples of some of the improvements that may be included on the list are shown in at least in FIGS. 22A45-22A49. Referring back to FIG. 16, in block 6502 the enhancer 65 compares the transferred current and future housing needs to the list. Next, the improvements that are inconsistent with the current and future needs are parsed in block 6503.

In block 6504 the enhancer 65 compares the remaining list with received comparables data to determine a value-enhancing estimate for each remaining improvement. In block 6505 the enhancer 65 compares each value-enhancing estimate to a predefined improvement cost to determine which improvements are profitable improvements. In block 6506 the enhancer 65 organizes the profitable improvements into categories including: base value point improvements, repaired value point improvements, enhanced value point improvements, modified floor plan value point improvements and increased living space value point.

Next the enhancer 65 ranks the improvements within each category from most profitable to least profitable in block 6507. Alternatively, instead of ranking each improvement the enhancer 65 may determine a total improvement profitability for each category as shown in FIG. 22A54.

Referring back to FIG. 16, in block 6508 the organized and ranked list is displayed and in block 6509 the enhancer 65 requests improvement selections from the user. The organization of the list generally decreases the time needed for the user to make improvement selections. For example, as previous discussed the user may want to quickly rule out improvements that require extended work. Next, in block 6510 selected improvements are received in response to the request. The selected improvements are provided to the new dwelling lifestyle enhancer 68 in block 6511.

FIG. 17 shows a flowchart of the processes performed by the new dwelling lifestyle enhancer 68.

The lifestyle enhancer 68 starts with a predefined list of all possible dwelling expenditures and investments in block 6801. In block 6802 the profit enhancer 68 compares the transferred current and future housing needs to the list. In block 6803 the improvements that are inconsistent with the current and future needs are parsed from the list. In block 6804 the remaining list is organized into categories including: base value point improvements, repaired value point improvements, enhanced value point improvements, modified floor plan value point improvements and increased living space value point improvements.

In block 6805 the enhancer 68 determines unaddressed current and future housing needs by comparing the transferred available housing section to the transferred current and future housing needs. In block 6806 the enhancer 68 compares the unaddressed current and future housing needs to the organized improvements list. Next, in block 6807 the improvements within each category are ranked from improvements associated with the most important unaddressed needs to improvements that are associated with the least important unaddressed needs. In one embodiment, the enhancer performs the importance rankings according to a predefined list of importance. In other embodiments, a separate process solicits user-input on the importance rankings. The categorized and ranked improvements list is displayed to the user in block 6808. In block 6809 improvements selection is requested, and in block 6810 selected lifestyle enhancing improvement are received in response to the request.

In block 6811 the enhancer 68 combines the transferred profit enhancing improvement selections with the lifestyle enhancing improvement selections. The improvement selections are then displayed in block 6812. In blocks 6813 and 6814 the selected improvements are transferred to the post-analysis communications memorializer 77 and the continuous housing consideration unit 71.

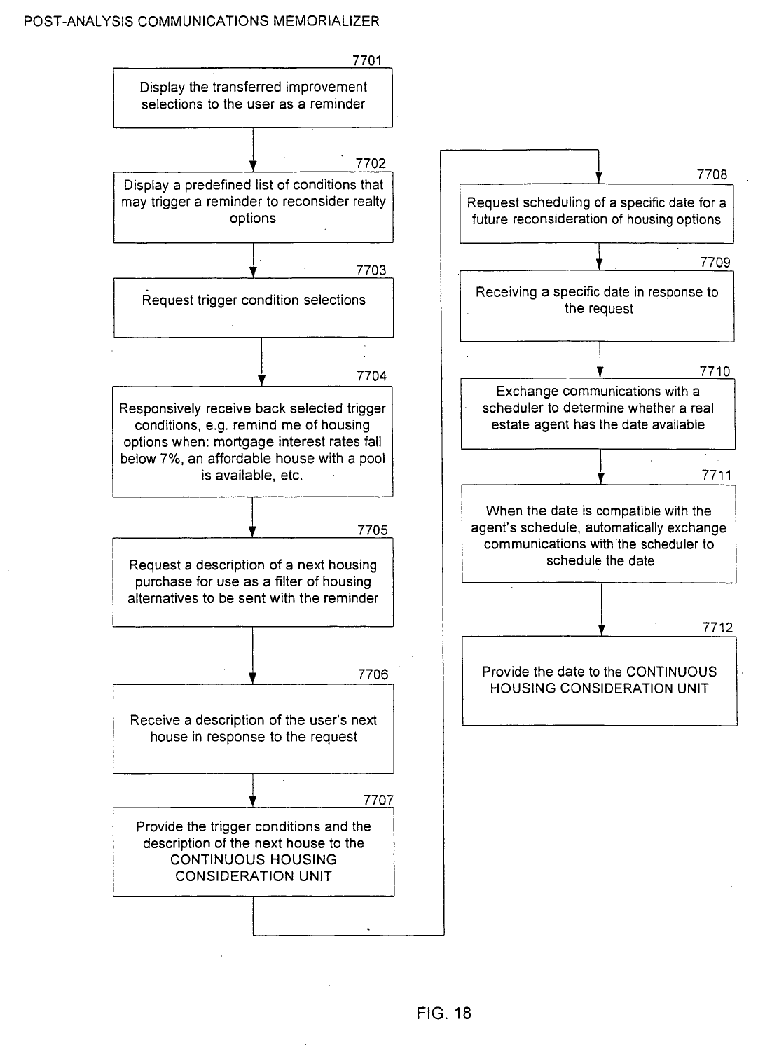

FIG. 18 shows a flowchart of the processes performed by the post analysis communications memorializer.

In block 7701 the memorializer 77 displays the transferred improvement selections to the user as a completion reminder. In block 7702 the memorializer 77 displays a predefined list of conditions that may be used to trigger a realty reconsideration reminder. The predefined list of conditions may include, for example, mortgage rates reaching a selectable threshold, an availability of an affordable dwelling including a pool, a user's salary reaching a selectable threshold, etc. In block 7703 trigger condition selection is requested and in block 7704 the memorializer 77 receives back selected trigger conditions in response to the request.

In block 7705 a description of a next housing purchase is requested. Advantageously, the next housing description may be optionally used to filter housing alternatives included with the reconsideration reminder. In block 7706 the next housing description is received in response to the request. In block 7707 both the trigger conditions and the next house description are provided to the continuous housing consideration unit 71.

In addition to setting the condition-based reminders, the memorializer 77 also sets non-conditional reminders. In block 7708 the memorializer 77 requests scheduling of a specific date for a future housing reconsideration. A specific date is received in response to the request in block 7709. Next, in block 7710 the memorializer 77 exchanges communications with a scheduler to determine whether a real estate agent has the date available. Preferably, the scheduler may include a calendaring software program, a personal organizer, an assistant or a phone or personal computer belonging to the real estate agent. When the date is compatible with the agent's schedule, in block 7711 the date may be automatically scheduled with the scheduler. In block 7712 the date is provided to the continuous housing consideration unit 71.

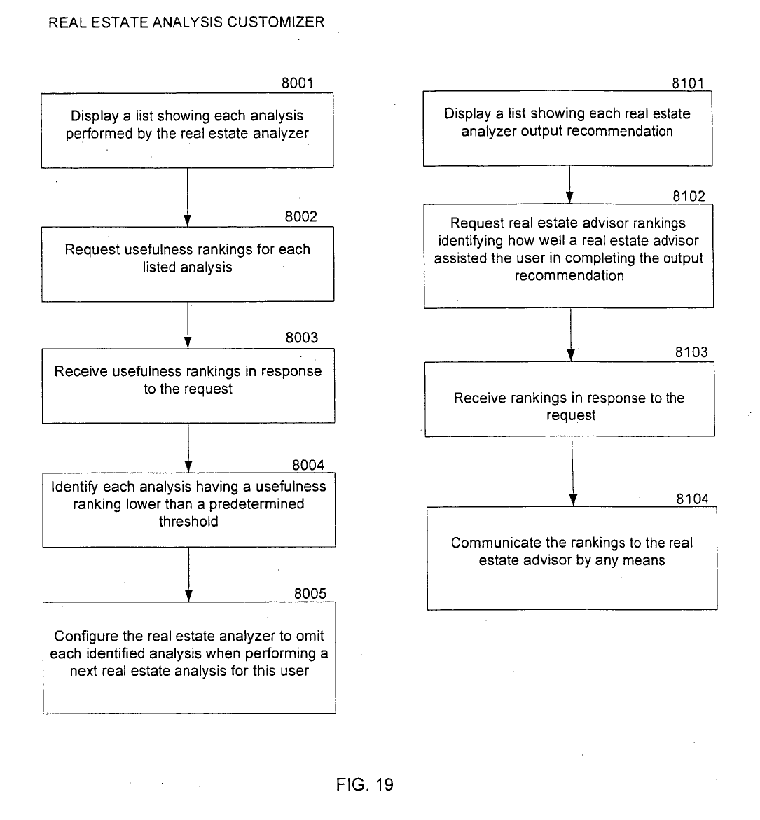

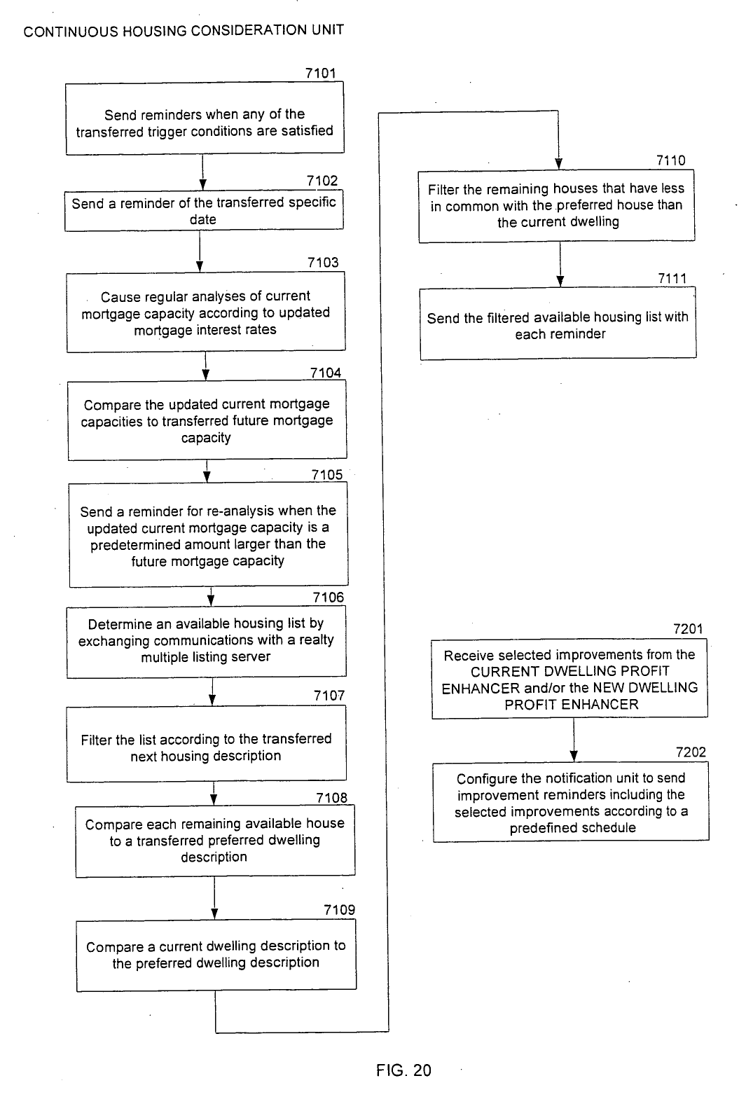

FIG. 19 shows a flowchart of the processes performed by the real estate analysis customizer 80.

In block 8001 the customizer 80 displays a list showing each analysis performed by the real estate analyzer 8. This list of analyses may include, for example, each of the flowcharts described in FIGS. 3-21. In block 8002 the customizer 80 requests rankings of the usefulness of each analysis performed. In block 8003 usefulness rankings are received in response to the request. In block 8004 the customizer 80 identifies each analysis having a usefulness ranking lower than a predetermined threshold. Finally in block 8005 the customizer 80 configures the real estate analyzer 8 to omit each identified analysis when performing a next real estate analysis for this user.

In block 8101 the customizer 80 displays a list showing each output recommendation that was provided by the real estate analyzer 8. Next, in block 8102 the customizer 80 requests real estate advisor rankings identifying how well the real estate advisor assisted the user in completing the output recommendation. In block 8103 real estate advisor rankings are received in response to the request. Finally in block 8104 the real estate advisor rankings are communicated to the real estate advisor by any system.

FIG. 20 shows a flowchart of the processes performed by the continuous housing consideration unit 71.

In block 7101 the unit 71 sends reminders when any of the transferred trigger conditions are satisfied. In block 7102 the unit 71 sends a reminder on the transferred schedule date.

In block 7103 the unit 71 causes regular analyses of current mortgage capacity according to updated mortgage interest rates. In block 7104 the unit 71 compares the updated current mortgage capacity to a transferred future mortgage capacity value. When the updated current mortgage capacity is a predetermined amount larger than the future mortgage capacity, the unit 71 sends out a reminder in block 7105.

In block 7106 the unit 71 determines an available housing list by exchanging communications with a realty multiple listing service server. In block 7107 the unit 71 filters the available housing list according to the transferred next house description. In block 7108 the unit 71 compares each remaining available house with a transferred preferred dwelling description. In block 7109 the unit 71 compares a current dwelling description to the preferred dwelling description. In block 7110 the unit 71 filters the remaining houses that have less in common with the preferred dwelling than the current dwelling. In block 7111 the unit 71 sends the filtered available housing list with each reminder.

In block 7201 the unit 71 receives the transferred selected improvements. In block 7202 the unit 71 regularly sends improvement reminders including the selected improvements according to a predefined schedule.

FIG. 21 shows a flowchart of the processes performed by the preferred dwelling search unit 83.

In block 8301 the unit 83 receives the transferred preferred dwelling description. In block 8302 the unit 83 regularly generates a list of available dwellings, for example, by exchanging communications with a realty multiple listing service server. In block 8303 the unit 83 filters the list of available dwellings by removing available dwellings that do not match the preferred dwelling description. In block 8304 the unit 83 filters the remaining list by removing dwellings priced above the sum of the transferred forecasted mortgage capacity plus the greater of the transferred total cash reserves available values. When a list remains, in block 8305 the unit 83 sends a notification of preferred dwelling availability including a description of each remaining preferred dwelling.

FIGS. 22A1-22A81 illustrate display images that may used by the real estate analyzer shown in FIG. 1.

Each of these figures shows a display image that may be employed by the real estate analyzer 8 when performing a structured analysis. The display images include example user entries, but would be presented by the analyzer 8 without the example user entries. Although the display images include the user entry fields, preferably they may advantageously be modified to include drop down boxes when predefined lists are display to the user.

The system described above can use dedicated processor systems, micro controllers, programmable logic devices, or microprocessors that perform some or all of the operations. Some of the operations described above may be implemented in software and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

Having described and illustrated the principles of the invention in a preferred example thereof, it should be apparent that the invention may be modified in arrangement and detail without departing from such principles. I claim all modifications and variation coming within the spirit and scope of the following claims.

What is claimed is:

1. A computer readable medium containing instructions that when executed cause a machine to:
provide a list of realty options based on received user needs and resources, the received user needs and resources including a user's present housing needs, the user's projected housing needs, a description of the user's preferred home and the user's available financial resources;
request a scoring of each realty option based on the user's personal preferences;
determine a highest scoring realty option based on received scores;
communicate a user selection request, the user selection request including a list of the scored realty options and a recommendation for the highest scoring option; and
receive a realty option selection in response to the user selection request.
